(19) United States
(12) Patent Application Publication
(10) Pub. No.: US 2010/0250370 A1
(43) Pub. Date: Sep. 30, 2010

(54) METHOD AND SYSTEM FOR IMPROVING TARGETING OF ADVERTISING

(75) Inventors: Scott A. Jones, Carmel, IN (US); Michael Burroughs, Indianapolis, IN (US); Andrew Doran, Westfield, IN (US); Mark Gamache, Zionsville, IN (US); Christopher Lenzo, Carmel, IN (US)

Correspondence Address: STAAS & HALSEY LLP, SUITE 700, 1201 NEW YORK AVENUE, N.W., WASHINGTON, DC, 20005, US

(73) Assignee: ChaCha Search Inc., Carmel, IN (US)

(21) Appl. No.: 12/731,718

(22) Filed: Mar. 25, 2010

Related U.S. Application Data
(60) Provisional application No. 61/163,623, filed on Mar. 26, 2009.
(60) Provisional application No. 61/167,043, filed on Apr. 6, 2009.
(60) Provisional application No. 61/167,425, filed on Apr. 7, 2009.

(51) Int. Cl. G06Q 30/00; G06F 17/30; G06N 5/02

(52) U.S. Cl. 705/14.66; 707/769; 705/14.49; 705/14.4; 706/50; 707/E17.014

(57) ABSTRACT

A method and system for improving targeting of advertisements allows guides to provide opinion information regarding advertisements responsive to targeting information associated with the advertisements. An advertiser selects a category, keyword and/or profile associated with an advertisement which may be used to select a guide who may express an opinion. Rating of an advertisement based on guide opinions are used to adjust a ranking of advertisements which may be used to determine if an advertisement will be provided to a user.

### CROSS-REFERENCE TO RELATED APPLICATIONS

This application is related to and claims the benefit of U.S. application Ser. No. 12/472,962, Attorney Docket No. 1918.1052, inventor Scott A. Jones, et. al., titled METHOD AND SYSTEM OF IMPROVING SELECTION OF SEARCH RESULTS, filed May 27, 2009; U.S. Provisional Application Ser. No. 61/163,623, Attorney Docket No. 1918.1063P, inventor Scott A. Jones, et. al., titled METHOD AND SYSTEM FOR PROVIDING AUXILIARY INFORMATION FROM A MOBILE DEVICE, filed Mar. 26, 2009; U.S. Provisional Application Ser. No. 61/167,043, Attorney Docket No. 1918.1065P, inventor Scott A. Jones, et. al., titled METHOD AND SYSTEM FOR IMPROVING TARGETING OF ADVERTISING, filed Apr. 6, 2009; U.S. Provisional Application Ser. No. 61/167,425, Attorney Docket No. 1918.1067P, inventor Mark Gamache, et. al., titled METHOD AND SYSTEM FOR INFERENCE OF USER CHARACTERISTICS, filed Apr. 7, 2009; U.S. patent application Ser. No. 12/250,267, Attorney Docket No. 1918.1030, inventor Scott A. Jones, et. al., titled METHOD AND SYSTEM FOR CREATION OF USER/GUIDE PROFILE IN A HUMAN-AIDED SEARCH SYSTEM, filed Oct. 13, 2008; and, U.S. patent application Ser. No. 12/251,876, Attorney Docket No. 1918.1031, inventor Scott A. Jones, et. al., titled METHOD AND SYSTEM OF MANAGING AND USING PROFILE INFORMATION, filed Oct. 15, 2008; and, U.S. patent application Ser. No. 11/835,016, Attorney Docket No. 1918.1014, inventor Scott A. Jones, et. al., titled ELECTRONIC PREVIOUS SEARCH RESULTS LOG, filed Aug. 7, 2007, the contents of which are incorporated herein by reference.

### DESCRIPTION OF THE RELATED ART

Targeting of advertising is an important element of success in media. This is true whether the media is unidirectional, such as television broadcasting, or bidirectional, such as web pages or interactive gaming. Poor targeting of advertising results in unneeded expenditure by the advertiser because the target customer may not be reached. Likewise, a customer who is not interested in an advertisement may either ignore or have an adverse reaction to the product or service which is supported by the advertising. Consequently, there may be a loss of customers for the ad supported service or product.

An example of an ad supported service or product is a search service. A service, such as Yahoo!® or Google®, may derive revenues from advertising which is targeted to the keywords of a user request. U.S. Published Application No. 20080242272, inventor Patel, et. al., describes a system for targeting advertisements based on user behavior which may indicate interests of the user.

A system that is directed to a more targeted ad approach is described in US Published Application No. 20090018913, inventor Sarukkai, et. al. Sarukkai describes a method for targeting a mobile device advertisement to a user based on content of a requested user alert, such as a sports score, or a stock price. Such a system is directed to delivery of a more targeted message when a user is receiving a message which is brief and has limited payload space for advertisements.

In some embodiments, a service such as Short Messaging Service (SMS) might be advertising supported. U.S. Published Application No. 20090017804, inventor Sarukkai, et. al., describes such a system for inserting targeted advertising messages into SMS messages of messaging service users. In other instances, advertisement targeting over the internet is desirable as well. U.S. Published Application No. 20080104026, inventor Koran, describes a system for targeting advertising messages to a user based on keywords which have been associated with the user.

Publishers have recognized the benefit of human review of advertising materials. Human review provides more specific targeting to the intended user groups. The need for and problems associated with human review of advertisements is described in U.S. Published Application No. 20070005418, inventor Nishar, et. al. A system for implementing a form of automated review of advertising performance is described in U.S. Published Application No. 20080215418, inventor Kolve, et. al. However, all known embodiments for targeting and reviewing of advertisements have inherent weakness.

Although keyword based targeting of advertising may produce some improvement, targeting to a specific keyword may produce a more narrow scope than intended, which may make it difficult to reach as large an audience as an advertiser intends. A broader targeting, such as a category-based targeting, may increase the expense associated with delivering the advertising message without sufficiently increasing the response rate of users. Lastly, as the cost of human review may be high, and the judgment of an individual may be biased, it is difficult to select a suitable advertisement based on an unknown group of evaluators.

In light of the above and other problems, there is a need for a system and method for utilizing human searchers to review advertisements.

### SUMMARY

A method and system of targeting advertisement(s) including using an opinion of guide(s) and presenting the advertisement(s) to a user. A method of selecting an advertisement including receiving an opinion regarding an advertisement from a human searcher and delivering the advertisement to a user when determining that information of the user meets a target indicator of the opinion.

According to an embodiment, a system includes a search system receiving information of an advertisement, selecting a searcher, and providing the advertisement to a user, a searcher device sending and receiving information from a searcher and an advertiser device sending and receiving information of advertisements.

A system embodiment, methods, data structures and interfaces for operating the embodiments are disclosed. Additional aspects and/or advantages will be set forth in part in the description which follows and, in part, will be apparent from the description, or may be learned by practice of the invention

### BRIEF DESCRIPTION OF THE DRAWINGS

Aspects and advantages of the invention will become apparent and more readily appreciated from the following description of the embodiments, taken in conjunction with the accompanying drawings, of which:

FIG. 1 is a block diagram of a system embodiment.

FIG. 2 illustrates a message flow diagram for a user request.

FIG. 3 illustrates a message flow diagram for an advertisement request.

FIG. 4 illustrates a database record for a user.

FIG. 5 illustrates a database record for a guide.

FIG. 6 illustrates a database record for an advertiser.

FIG. 7 illustrates a relationship between an advertising taxonomy and a guide taxonomy.

FIG. 8 illustrates a flowchart of a process of responding to a user request.

FIG. 9 illustrates a flowchart of a process of selecting an advertisement

FIG. 10 illustrates a flowchart of a process of reviewing an advertisement.

FIG. 11 illustrates a flowchart of a process for providing messages to a user.

FIG. 12 illustrates a flowchart of a process for providing messages and an activity to a user.

FIG. 13A illustrates a generalized relationship of the use of guide judgment to select an advertisement.

FIG. 13B illustrates an alternate selection system for utilizing guide judgment to select an advertisement.

FIG. 14 is a block diagram of an exemplary system embodiment.

FIG. 15 illustrates an example of constructing a statistical model.

FIG. 16 illustrates a database record for a user.

FIG. 17 illustrates a database record for a guide.

FIG. 18 illustrates a database record for a reference user.

FIG. 19 illustrates a database record for a search request.

FIG. 20 is a flowchart of a process of creating a prediction model.

FIG. 21 is a flowchart of a process of determining a user characteristic.

FIG. 22 is a block diagram of an exemplary system embodiment.

FIG. 23 illustrates a layer diagram of the system software architecture.

FIG. 24 illustrates a flow diagram of a process for initiating and participating in a service.

FIG. 25 illustrates an exemplary user device.

FIG. 26 illustrates a graphical user interface (GUI).

FIG. 27 illustrates a GUI.

FIG. 28 illustrates a GUI.

FIG. 29 illustrates an exemplary user device.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A method and system for improving review and targeting of advertisements including an advertiser system, which may be used to submit an advertisement for consideration and receive responses from a search system, a search system, which obtains advertisements from the advertiser system, distributes the advertisements to human searchers or guides, and records responses from the guides which are returned to the advertisers, and a guide system, which receives information of advertisements and provides information of the opinion of the guide to the search system. A database may be maintained which includes information of a guide, which may be used to determine a number of available guides, and demographic and/or other profile information, which may be used to review an advertisement and may be used to change targeting information associated with an advertisement. A resource may also be accessible to a guide, which may be operated by a human provider of information and/or may be an automated system which may provide results and/or other information.

A guide may be selected based on a target profile, which may be selected by the search system and/or an advertiser. An advertisement is provided to a guide, an opinion of the guide is recorded, and a rating of the advertisement is determined. Based on ratings and/or rankings of advertisements, an advertisement may be targeted to a user.

In one embodiment, multiple advertisements, which are targeted to a category, are reviewed by guide(s). If an advertisement has a high rating or ranking associated with a category, it may be more likely to be presented to a user when a request associated with the category is received. If a request is associated with a profile and/or a category, a rating of an advertisement associated with the profile and/or category may be used to determine an advertisement which will be provided to a user associated with the request. A profile may be used to provide information of the appeal or probability of acceptance and/or response to an advertisement by a user matching the profile based on opinions of a guide matching the profile.

A taxonomy or index may be maintained. The taxonomy may be exposed to an advertiser and used to provide an advertising bid system. In at least one embodiment, an advertising taxonomy may be related to a taxonomy associated with a guide. An advertising taxonomy may also be related to a taxonomy associated with items such as resources, search results, search requests, etc. The taxonomies associated with one or more of the items may be loosely coupled, and an advertisement may be targeted differently based on factors selected by a search system provider which may or may not be explicitly selected by an advertiser.

A method and system of utilizing human searchers to improve targeting of advertisements is described. Information of an advertisement is received by a search system, which may store information of the advertisement in association with an index or taxonomy, which may be used to select an advertisement and/or to allow an advertiser to select a category and/or other parameters which may be associated with the advertisement and which may be used to target the advertisement. For example, if a request is associated with a category which is indicated in the index, advertisements associated with the index may be ranked for the category, which may allow the ranking to be used to select an advertisement to be provided to a user and/or a guide associated with the request.

An advertiser may be provided with the ability to view a system taxonomy and/or other parameters which may be associated with a user that is the target of an advertisement. An advertiser may submit information of an advertisement, a category of the advertisement, and/or other parameters such as keywords, demographic information, geographic information, affiliations, etc. which may be used to determine a target user associated with the advertisement. An advertiser may be given the option of having a guide associated with a parameter identified by the advertiser perform a review of and provide an opinion regarding an advertisement. Information regarding an opinion of a guide may be provided to an advertiser.

A guide may evaluate an advertisement if an advertiser does not request that the advertisement be evaluated. If a search system or publisher has received a number of advertisements which may be targeted to a set of parameters, the search system may automatically provide information relating to the advertisements to a guide who may assist in a determination of targeting of the advertisement. Information provided by a guide may be used with pricing and/or inventory information of an advertisement to determine whether an advertisement is to be delivered responsive to a user request. Opinions of a guide may be weighted based on factors such as a confidence factor, a level of experience, a proficiency test a blind test, and/or other factors associated with the guide.

Guide opinions may be utilized in real time during processing of a query, and/or may be utilized as historical information for selecting an advertisement. A guide may be utilized to review and/or rate an advertisement submitted to a search system utilizing the assistance of human searchers or guides. A guide may provide varying levels of personal information personal information may include geographic, demographic, affiliation, personality, and/or other information regarding the guide which may be referred to as a profile. A guide may be associated with a category and/or keyword. An advertiser may associate an advertisement with a category which is related to a category and/or keywords associated with a guide. An advertiser may select a profile which may indicate a target audience for an advertisement, and/or other media and information.

A system embodiment, methods, data structures and interfaces for operating the embodiments are described below in detail.

A “user” may be any person or entity which may submit a request or search request to a search system. A request or search request or query is information which may be submitted using any communication service which may be able to access a search system as further described herein below. A user may also be referred to as an information seeker or requester.

A “guide” may be any person who may be compensated and/or may be a volunteer who may respond to and/or assist with a request. An “ambassador” or expediter is a guide who may perform processing, including clarification, classification, correction, construction, vetting, review, rating, selection, creation, formulation, interpretation, evaluation, etc. of a request and/or a search result. A “searcher” is a guide who may perform an information search responsive to a request. A guide may also be referred to as a “human searcher”. A “transcriber” who may also be a guide may convert a spoken portion of a request into text. Any guide may be a searcher, an ambassador, and/or a transcriber.

A “raw query” is a request submitted by a user, which may include any type of information provided by a user and/or associated with a user.

A “vetted query” includes a request which is associated with a category, a structured query, or otherwise qualified query.

A “structured query” is a question formulated according to a structured grammar. In at least one embodiment, a grammar construction required for a structured query is a question. A structured query may also be referred to as a “succinct query”.

An “identifier” or ID is a group of characters, numbers and/or other types of information which may be used to identify an item which is stored in a database. Items may include, but are not limited, to a guide, a user, a resource, an advertisement, a keyword, a category, a search result, a search request, a query, a rating, ranking, a message and/or a profile.

A “request”, “search request” or “query” is a request for information. A request may include various forms of information such as audio, video, images, text, URL's, and/or software. A request may be generated by a user, a guide, a resource, and/or automatically.

A “guided request” is a request which uses the assistance of one or more guides.

A “result” or “search result” is any information which may be provided responsive to a request. A search result includes but is not limited to any of an advertisement, a link to a web page, a message of any sort, image, audio, text, games, interactive media and/or software of any sort.

A “search resource” is any source of information, including a resource, which may be used to obtain a search result. A search resource includes automated and/or human-assisted systems, any repository of information and any type of media and/or systems which may provide information. A resource may be a provider or source of item and/or service. For example, a resource might provide an item such as a ringtone, a media file (e.g., audio, video, images, games, etc.), information such as news, lyrics, song titles, translations or any other type of information.

A “profile” is a group of one or more characteristics which may be associated with a person. Profile characteristics include but are not limited to demographic, geographic, personality, affiliations, areas of interest, historical actions, preferences, memberships, associations, etc., or other types of information which may be associated with a person.

An “advertisement” is any information which may be delivered to a user including to promote a provider, a person, a product, a service, etc. An advertisement or sponsored content may include text, audio, video, images, printed materials, web pages, computer software, interactive media such as a game, or other forms of media which may be provided to a user.

A “category”, “taxonomy branch” or “categorization” is a unique node within an index which may be associated with any number of items. If a query is associated with a category, items associated with the category may be more likely to be selected responsive to the query.

The terms “voice” and “speech” are used interchangeably herein. A user, a resource, and/or a guide may establish a communication session using a voice service, a messaging service such as Short Messaging Service (SMS), Enhanced Messaging Service (EMS), Multimedia Messaging Service (MMS), Instant Messaging (IM), email, an internet portal or web page, regular mail or any other type of communication. A connection may be established using any device which is capable of utilizing a communication service. For example, a wireless device such as a cell phone, PDA, smart phone, etc., might be used to establish a communication session using voice, SMS, IM, email or Internet browsing. A desktop, laptop or server system might be used to establish a communication session. A landline phone, a specialized communication terminal, or any other communication device might be used to establish a communication session.

Communication between a guide, a user, a resource and/or a search system may include conversion of text to speech and speech to text. Any type of media which can be sent or received using a communication system may be part of a communication session. A communication session may be conducted using any or all communication service associated with a user, a resource and/or a guide.

An advertisement may be transmitted, including during any or all communication sessions, between a user, a guide and/or a search system. A resource, a guide, and/or an advertisement may be rated. Rating information may be obtained from a user, a guide, and/or a search system. Rating information may be used to select a resource, a guide, an advertisement and/or any item based on information associated with an item indicated in a database. For example, a resource most utilized by guides to obtain a result may be ranked higher than a resource used less. A search service may be compensated by advertising revenue.

A guide may be required to register with the search system and provide information which is utilized to select a guide to respond to a request. A guide may be required to be associated with a minimum number of categories and/or keywords. A guide may be required to provide a description of expertise which the guide is able to provide relating to a request. A guide may be associated with an index based on any information which is associated with the guide. A guide may be allowed to create and/or remove an association with a node of the index.

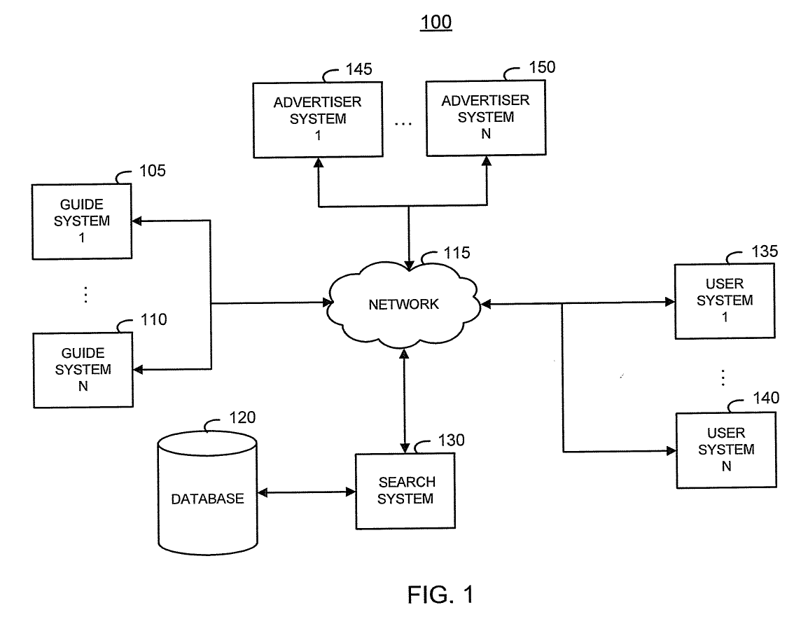

An exemplary system embodiment is illustrated in FIG. 1. A system 100 includes: guide systems 105, 110; a network 115; a search system 130; user systems 135, 140; a database 120, which may comprise various records; and advertiser systems 145, 150.

The guide systems 105, 110 can be operated by a guide to obtain search results responsive to a request. The user systems 135, 140 may be operated by a user to submit a request. The advertiser systems 145, 150 may be used to provide information of an advertisement which may be provided to a user, a guide, the search system 130 and/or an advertiser. While only a limited number of guide, advertiser and user systems are depicted in FIG. 1, it is within the scope of the disclosure for multiple guide, advertiser and user systems to be utilized.

The network 115 (FIG. 1) may be a global public network of networks (the Internet) and/or consist in whole or in part of one or more private networks and communicatively couples the guide computer systems 105, 110, the advertiser systems 145, 150, and the user systems 135, 140 with the other components of the system 100 such as the search system 130 and the database 120. The network 115 may, for example, include any or all of a wireless network such as a cellular phone network, a WiMax network, a WiFi network, etc., a network such as the Public Switched Telephone Network (PSTN), and/or any other type of communication network.

The search system 130 allows interaction to occur between the guide systems 105, 110, the advertiser systems 145, 150 and the user systems 135, 140. For example, a request can be transmitted from the user systems 135, 140 to the search system 130, where a request can be accessed by the guide systems 105, 110 and/or the advertiser systems 145, 150. Similarly, a search result produced using the guide systems 105, 110 in response to a request produced by the user systems 135, 140 may be transmitted to the search system 130, where it may be stored by the search system 130 and/or may be transmitted to the user systems 135, 140. Similarly the search system 130 may request an advertisement from the advertiser systems 145, 150 responsive to a user request from the user system 140. The advertiser systems 145, 150 may provide an advertisement to the search system 130 which may deliver the advertisement to the user system 140 at any time.

The user systems 135, 140 may include within the scope of the disclosure any device which an information seeker can use to submit a request to and/or receive information or a search result from the search system 130. In one embodiment, the user system 135 may be a device configured for connection to a network and may run web browser software. Thus, the user systems 135, 140 may be a portable or laptop computer, a personal data assistant (PDA), a desktop computer such as a PC or Mac®, a workstation or a terminal connected to a mainframe, a server, a specialized search apparatus, a set-top box or a smart phone, etc., within the scope of the disclosure. Any device which can communicate using Internet Protocol (IP) may be a user system, a searcher system, and/or an advertiser system within the scope of the disclosure.

The search system 130 may include a gateway for voice communication and a speech-to-text and/or text-to-speech system and/or other transcription device and/or personnel to facilitate access to the search system via voice communications such as through a land line phone, cellular phone, Voice over Internet Protocol (VoIP) and/or other telephonic device. Any device which may be used to communicate using voice (speech) may be a user system, a searcher system and/or an advertiser system.

The search system 130 may include hardware and/or software interface to a system which provides communication services such as Instant Messaging (IM), email, Short Messaging Service (SMS), Enhanced Messaging Service (EMS), Multimedia Messaging Service (MMS), and/or other forms of messaging services. Any device which may communicate using such services may be a user system, a searcher system, and/or an advertiser system within the scope of the disclosure herein. A request may be submitted to the search system 130 using any or all communication services which are able to communicate with the search system 130.

Although the search system 130 is illustrated as a single system, the search system 130 may include any number of hardware systems, which may function as servers and/or other elements. For example, a server functionality associated with any of the communication services identified herein above may be implemented to allow messages to be transmitted between the elements of the system 100.

The search system 130 is communicatively coupled with the database 120. As will be described herein in further detail below, the database 120 includes data that is processed during operation of the embodiments. Although FIG. 1 illustrates the database 120 as a separate component of the system 100, the database 120 may be integrated with the search system 130. Further, the records maintained in the database 120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. For example, elements of the database 120 may be stored in any storage media accessible to a user system, a searcher system, and/or an advertiser system.

After being presented with the disclosure herein, one of ordinary skill in the art will readily appreciate that the computer systems of the embodiments can be any type of viable systems known in the art.

In the disclosed system and method, guides may be required to register with the search system 130, and in certain embodiments undergo training prior to being permitted to provide responses to requests submitted by a user utilizing the search system 130. When a guide is registered with the search system 130, the guide may be required to be associated with a keyword, a subject matter of expertise and/or category. A keyword and/or category may be used to associate a guide with a user request. A guide may be further required to provide information associated with the guide. For example, a guide may be required to provide demographic, geographic, affiliation, or other information which are associated with the guide and may be used to select a guide for a task such as responding to a user request, providing an opinion regarding an item such as an advertisement, a search resource, a search result, etc.

Profile information of a guide may be obtained by testing of the guide, by processing of information indicated by the guide, by providing activities to a guide, based on historical information of requests and/or search results, etc. Methods such as those described in the related U.S. application Ser. No. 12/250,267 previously mentioned and incorporated herein by reference may be used.

A prospective guide may elect to be a searcher and/or an ambassador, and/or to perform other activities. A prospective guide may undergo training and/or testing which may be used to determine whether a guide is competent to perform a task. After completion of testing and/or training, a guide may be allowed to perform a task. A guide may act as an ambassador, and/or as a searcher based on completion of training and/or testing. An ambassador processes a user search request and/or a search result. A searcher may receive a processed request and may perform a search responsive to the processed request. Various criteria may be considered for determining whether a guide may act as an ambassador and/or a searcher including but not limited to time spent as a guide, level of knowledge in particular area, etc. In at least one embodiment, the role of ambassador and searcher may be mutually exclusive.

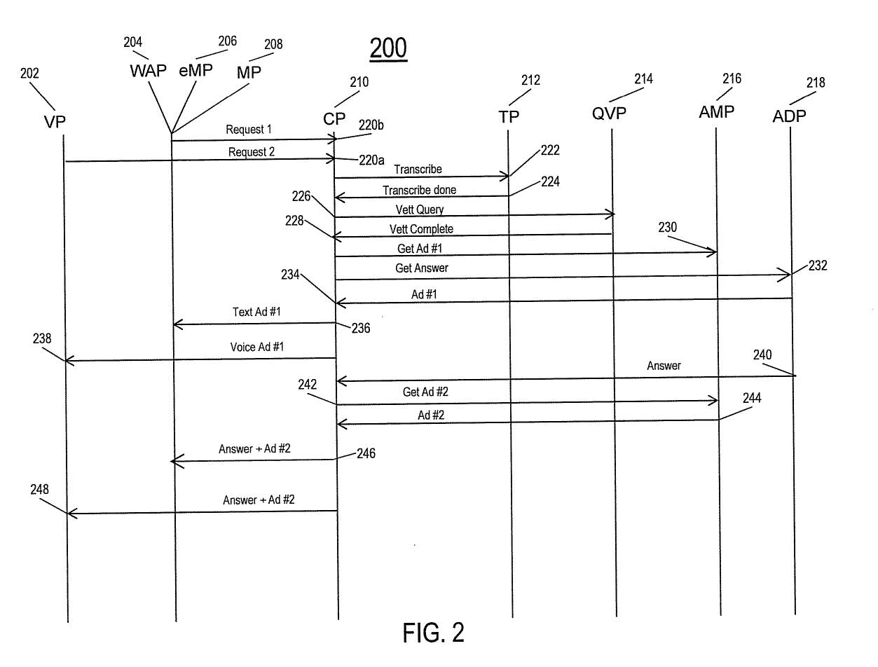

In FIG. 2, a message flow diagram 200 illustrating messages passed between processes in one embodiment is illustrated. The processes illustrated may, for example, be operative on one or more servers associated with the system 100 (FIG. 1).

A Voice Process (VP) 202 (FIG. 2) may receive a speech based request from a system which has produced an audio recording of a user request. A Wireless Access Process (WAP) 204 may receive a message from a browser running a Wireless Access Protocol browser. An eMail Process (eMP) 206 may receive a user request from a server which implements an email protocol such as SMTP. An Messaging Process (MP) 208 may receive a message from a server which implements SMS, MMS, EMS or other messaging services. The VP 202, the WAP 204, the eMP 206, and the MP 208 provide bi-directional communication to the respective communication services.

A ChaCha® Process (CP) 210 may be used to control communication and/or record information associated with activities associated with a user request. A Transcriber Process (TP) 212 may select a guide to perform a transcription, and/or may perform automated transcription of speech to text and/or text to speech. A Query Vetting Process (QVP) 214 may select a guide to categorize and/or structure a request and/or may perform automated processing to structure and/or categorize a request. An Advertising Management Process (AMP) 216 may deliver an advertisement responsive to a request. An Answer Delivery Process (ADP) 218 may select a guide to respond to a request and/or may provide a search result from a resource and/or based on stored information.

A user request may be initiated by the VP 202 using the request message ‘Request 2’ 220a. A ‘Transcribe’ message 222 may be transmitted by the CP 210 to the TP 212. Upon completion of the transcription task, a transcription result may be provided from the TP 212 to the CP 210 by a ‘Transcribe Complete’ message 224. If a request is received in a text format, via a process such as the MP 208, the MP 208 may transmit the request to the CP 210 using a ‘Request 1’ message 220b.

If a request has been converted to a text format, information of the request is transmitted from the CP 210 to the QVP 214 using a ‘Vett Query’ message 226. In at least one embodiment, an advertisement which may be presented to a user prior to a search result may be requested from the AMP 216 via a ‘Get Ad #1’ message 230. The AMP 216 may respond to the CP 210 with a ‘Ad #1’ message 234 which may provide information of an advertisement. The CP 210 may transmit information of an advertisement to the WAP 204, the eMP 206, or the MP 208 using a ‘Text Ad #1’ message 236 and/or the VP 202 using the ‘Voice Ad #1’ message 238 as determined by the CP 210. If the query vetting process is not completed, a first advertisement (i.e., Ad #1) may not be targeted. If an automated categorization is performed, information of an automatically selected category may be provided to the AMP 216 to improve targeting of an advertisement.

When the QVP 214 completes processing of the content of the ‘Vett Query’ message 226, a ‘Vett Complete’ message 228 may be sent to the CP 210, which may include information of a category, a keyword, a structured query, a modified query and/or other information determined by the QVP 214. In at least one embodiment, an ambassador or expediter guide may assist with any or all query vetting operations. Responsive to the ‘Vett Complete’ message 228 the CP 210 may transmit a ‘Get Answer’ message 232 to the ADP 218 and transmit a ‘Get Ad#2’ message 242 to the AMP 216. Targeting of the second advertisement (i.e., Ad #2) may be improved by information included in the ‘Vett Complete’ message 228. The ADP 218 may respond to the ‘Get Answer’ message 232 with a ‘Answer’ message 240. In at least one embodiment, the ‘Get Ad #2’ message 242 is not transmitted until the ‘Answer’ message 240 is received by the CP 210 from the ADP 218, in order that information included in the ‘Answer’ message 240 may be used to select an advertisement. Information included in a ‘Ad #2’ message 244 and the ‘Answer’ message 240 may be provided to any selected user device using a message such as a ‘Text Answer+Ad #2’ message 246 and/or a ‘Voice Answer+Ad #2’ message 248. While a limited number of interface processes such as the WAP 204, the VP 202, etc., have been illustrated in FIG. 2, no limitation is implied thereby. Any number and/or types of interface processes which may enable requests to be submitted and responses to be provided using any communication service as described herein above may be implemented.

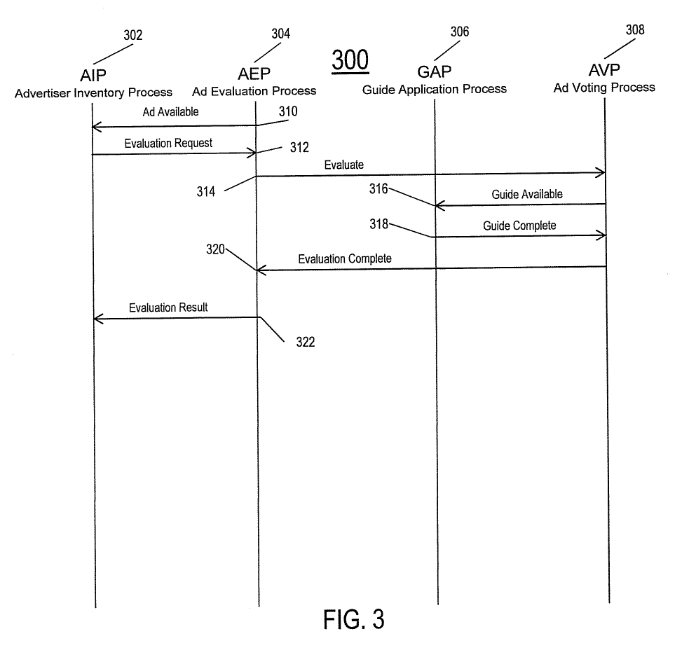

A message flow diagram 300 illustrating messages passed between processes in an embodiment is illustrated in FIG. 3. The processes illustrated may for example, be operative on one or more servers associated with the search system 130 (FIG. 1).

An Advertisement Inventory Process (AIP) 302 (FIG. 3) may receive advertisement information from an advertiser. An Advertisement Evaluation Process (AEP) 304 may manage evaluation of advertisements as required. In at least one embodiment the AIP 302 may determine whether an advertisement is to be evaluated. Alternately, the AEP 304 may determine whether a number of guides are available to review advertisements and may request an advertisement to be evaluated from the AIP 302. A Guide Application Process (GAP) 306 manages activities assigned to a guide. An Ad Voting Process (AVP) 308 manages the process of obtaining and recording opinions of guides related to advertisements.

In at least one embodiment, if the AEP 304 determines that an advertisement is to be reviewed, the AEP 304 may transmit a ‘Ad Available?’ message 310 to the AIP 302. Based on content of the ‘Ad Available?’ message 310, the AIP 302 may provide information of advertisements which are a suitable match. For example, the ‘Ad Available?’ message 310 may include information of an available guide such as a profile, category, keyword, etc. which may be used to select an advertisement. The AIP 302 may respond with a ‘Evaluation Request’ message 312, which may include information of an advertisement which is to be evaluated. For example, a pointer to a server which may provide an advertisement may be provided to the AEP 304. The AEP 304 may deliver a ‘Evaluate’ message 314 to the AVP 308. The AVP 308 may determine a profile of a guide and/or other parameters of a voting process based on content of the ‘Evaluate’ message 314. The AVP 308 may send a ‘Guide Available?’ message 316 to the GAP 306. Responsive to the ‘Guide Available’ message 316, the GAP 306 may assign a task to a guide. For example, a guide may be presented with information of an advertisement, and may express an opinion. For example, a guide might make a yes/no vote, select one advertisement from a group of advertisements, might provide a rating of an advertisement, etc. When a guide task is completed, the GAP 306 may send a ‘Guide Complete’ message 318 to the AVP 308. The AVP 308 may determine if a sufficient number of guide opinions have been obtained based at least in part on information indicated in the ‘Guide Complete’ message 318. For example, a number of guide votes, a total number of votes of a particular type of guide, a time limit, etc. might be used to determine whether a sufficient number of guide opinions have been obtained. If an evaluation is completed, the AVP 308 may notify the AEP 304 by sending a ‘Evaluation Complete’ message 320. The AEP 304 may process information obtained from the AVP 308 to determine a ranking, a category, a keyword, a profile and/or other information regarding an advertisement. The AEP 304 may send information regarding an evaluation result to the AIP 302 using a ‘Evaluation Result’ message 322.

In at least one embodiment, records associated with a user, a guide, an advertiser, and/or other items such as a request, an advertisement, a profile, a resource, etc., which may be processed and/or modified during operation of the embodiments are stored in the database 120 (FIG. 1). Records may be stored as magnetic, optical, semiconductor, mechanical recordings and/or other forms of persistent computer readable storage media.

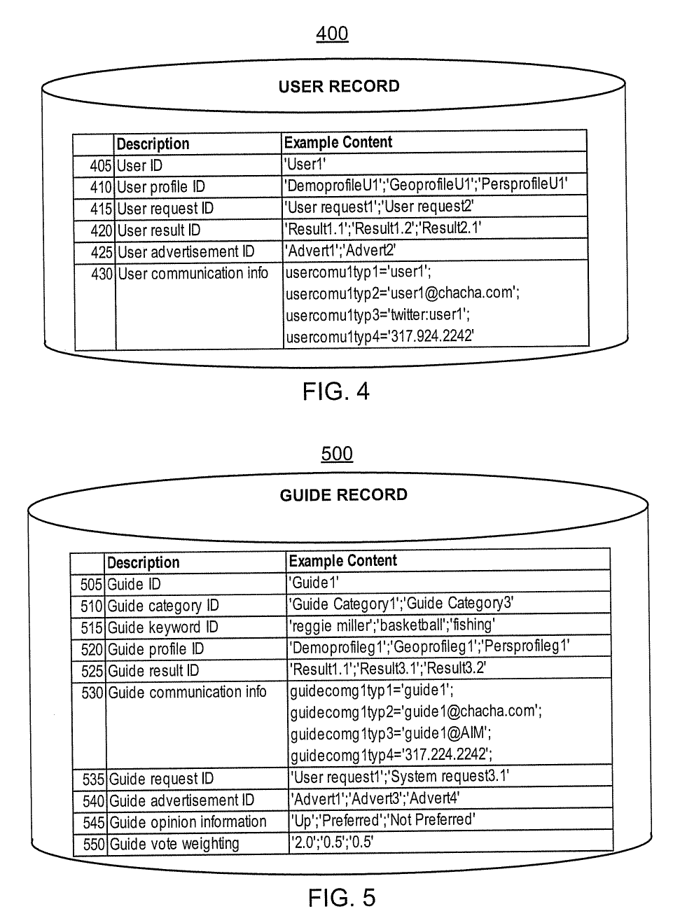

As illustrated in FIG. 4, an exemplary a user record 400 is provided, of which one or more may be associated with or resident in the database 120 (FIG. 1). The user record 400 (FIG. 4) may include a user ID field 405, a user profile ID field 410, a user request ID field 415, a user result ID field 420, a user advertisement ID field 425, and a user communication info field 430.

The user ID field 405 preferably contains a unique identifier of a user, which is preferably used consistently. For example, in at least one embodiment, the user ID field 405 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 4, ‘User1’ is the user ID associated with the user record 400.

The user profile ID field 410 may include information of a profile associated with a user. Content of the user profile ID field 410 may be modified based on actions of a user. A person may select a profile which is associated with a user. For example, a user may select a profile to be associated with the user during a registration process. A profile may be associated with a user based on testing of a user and/or information from users. For example, a user may be required to demonstrate knowledge relevant to a profile in order to be associated with the profile, or a user may take a test which is used to generate a profile, or a user may provide information such as demographic, geographic, personality or other information which may be indicated in a profile associated with the user. Information indicated in a user profile may be obtained from an external database. For example, an employer, a provider of goods and/or services, an organization, etc. may provide any or all profile information associated with a user. A profile associated with a user may be used to select and/or rank a user. For example, a user may be selected to participate in an activity at least in part based on profile information associated with the user. Using the example illustrated in FIG. 4, the profiles ‘DemoprofileU1’, ‘GeoprofileU1’ and ‘PersprofileU1’ are associated with the user ‘User1’. This may indicate that ‘User1’ has indicated and/or generated the profiles ‘DemoprofileU1’ which may be a demographic profile, ‘GeoprofileU1’ which may be a geographic profile and ‘PersprofileU1’ which might indicate personality and/or other information regarding the user ‘User1’. Profile information associated with a user may improve targeting of advertisements to the user. While specific examples of items pertaining to a user profile are described herein, the present invention is not limited to any particular type of profile. For example, a profile may be generated and associated with a user based on request(s) received from the user including subject matter thereof, a time of receipt, etc.

The user request ID field 415 may include information of a request associated with a user. Content of the user request ID field 415 may be modified based on actions of a user. If a user submits a search request to the search system 130 (FIG. 1) an identifier of the search request may be included in the user request ID field 415 (FIG. 4). Using the example illustrated in FIG. 4, the requests ‘User request1’ and ‘User request2’ are associated with the user ‘User1’. This may indicate that ‘User1’ has submitted the requests ‘User request1’ and ‘User request2’ to the search system 130 (FIG. 1).

The user result ID field 420 may include information of a result associated with a user. Content of the user result ID field 420 may be modified based on action of a user and/or a guide. If a user receives a search result responsive to a search request, an identifier of the search result may be included in the user result ID field 420. If a guide provides a search result responsive to a user request, an ID of the search result may be added to the user result ID field 420. A usage indicator associated with a search result provided to a user may affect a rating and/or ranking associated with a guide. For example, if a search result produced by a guide is provided and accepted responsive to multiple user requests, a rating and/or ranking of the guide may be higher. Using the example illustrated in FIG. 4, the results ‘Result1.1’, ‘Result1.2’ and ‘Result2.1’ are associated with the user ‘User1’. This may indicate that ‘User1’ has been presented with the results ‘Result1.1’, ‘Result1.2’, and ‘Result2.1’ responsive to a search request.

The user advertisement ID field 425 may include information of an advertisement associated with a user. Content of the user advertisement ID field 425 may be modified based on actions of a user. If a user receives an advertisement responsive to a search request, an identifier of the advertisement may be included in the user advertisement ID field 425. A usage indicator associated with an advertisement provided to a user may affect a rating and/or ranking associated with a guide, compensation for the search system 130 (FIG. 1), and/or rating and/or ranking of an advertisement. Likewise, if a user takes an action responsive to an advertisement, information of the action may be used to determine compensation for the search system 130, a guide, etc. Using the example illustrated in FIG. 4, the advertisements ‘Advert1’ and ‘Advert2’ are associated with the user ‘User1’. This may indicate that ‘User1’ has been presented with the advertisements ‘Advert1’, ‘Advert2’.

The user communication info field 430 may include information of a device and/or service associated with a user. Content of the user communication info field 430 may be modified based on actions of a user. If a user establishes communications with the search system 130 (FIG. 1) using a device and/or service, information regarding the device and/or service may be included in the user communication info field 430. Any type of communication service and/or system may be indicated in the user communication info field 430. For example, a username and/or password associated with a user may be indicated in the user communication info field 430. Communication services such as Instant Messaging (IM), e-mail, SMS, MMS, EMS, telephone, wireless or wired communication, etc., may be indicated in the user communication info field 430. A telephone number, an email address, an IM provider and login ID, a keyword associated with a service, etc., may be indicated in the user communication info field 430. Using the example illustrated in FIG. 4, the login ‘user1’, the email ‘user1@chacha.com’, the Twitter™ service account ‘twitter:user1’ and the phone number ‘317.924.2242’ are associated with the user ‘User1’. This may indicate that ‘User1’ may be contacted using the login ID ‘user1’, via email at ‘user1@chacha.com’, via Twitter as ‘user1’ and/or via voice, text, and/or other service associated with the phone number ‘317.924.2242’.

As illustrated in FIG. 5, an exemplary guide record 500 is provided, of which one or more may be associated with or resident in the database 120 (FIG. 1). The guide record 500 may include a guide ID field 505, a guide category ID field 510, a guide keyword ID field 515, a guide profile ID field 520, a guide result ID field 525, a guide communication info field 530, a guide request ID field 535, a guide advertisement ID field 540, a guide opinion information field 545, and a guide vote weighting field 550.

The guide ID field 505 preferably contains a unique identifier of a guide, which is preferably used consistently. For example, in at least one embodiment, the guide ID field 505 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 5, ‘Guide1’ is the guide ID associated with the guide record 500.

The guide category ID field 510 may include information of a category associated with a guide. Content of the guide category ID field 510 may be modified based on actions of a guide. A category may be associated with a guide based on various types of information processing. For example, the category ‘translate English to Spanish’, or ‘transcribe spoken queries’ might be associated with a guide to indicate a skill associated with the guide. Such an association may be used in part to rate or rank a guide and/or to select a guide. A person may select a category and/or keyword which is associated with a guide. A category may be associated with a guide based on testing of a guide. A category may be associated with a guide based on an affiliate group associated with the guide. For example, if a guide has chosen to be affiliated with affiliate groups associated with a type of music, a category associated with the type of music might be associated with the guide. A category associated with a guide may be used to select an item which is to be presented to a guide. A guide may be selected to review an item such as a search result, an advertisement or a search resource based on the association of a guide with a category. Using the example illustrated in FIG. 5, the categories ‘Guide Category1’ and ‘Guide Category3’ are associated with ‘Guide1’. A category associated with a guide may be linked to a category associated with an advertisement as further described herein.

The guide keyword ID field 515 may include information of a keyword associated with a guide. Content of the guide keyword ID field 515 may be modified based on actions of a guide. A person may select a keyword which is associated with a guide. For example, a guide may select a keyword to be associated with the guide during a registration process. A keyword may be associated with a guide based on testing of a guide. For example, a guide may be required to demonstrate knowledge of a category and/or keyword in order to be associated with the keyword. Content of the guide keyword ID field 515 may be compared to content of a search request in order to determine a ranking of a guide for responding to a search request. Using the example illustrated in FIG. 5, the keywords ‘reggie miller’, ‘basketball’ and ‘fishing’ are associated with the guide ‘Guide1’. This may indicate that ‘Guide1’ has indicated an interest in those keywords.

The guide profile ID field 520 may include information of a profile associated with a guide. Content of the guide profile ID field 520 may be modified based on action of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in a guide profile may be obtained from an external database. For example, profile information of a group of guides associated with an affiliate group such as a non-profit organization might be obtained from a database provided by the organization. Information indicated in content of the guide profile ID field 520 may be compared to information indicated in content of a profile associated with an advertisement in order to determine a ranking of a guide for responding to a request to evaluate the advertisement. Likewise, a profile associated with a guide may be used to select and/or rank a guide. Using the example illustrated in FIG. 5, the profiles ‘Demoprofileg1’, ‘Geoprofileg1’ and ‘Persprofileg1’ are associated with the guide ‘Guide1’. This may indicate that ‘Guide1’ has indicated and/or generated the profiles ‘Demoprofileg1’ which may be a demographic profile, ‘Geoprofileg1’ which may be a geographic profile and ‘Persprofileg1’ which might indicate personality and/or interest information regarding the guide ‘Guide1’. Any or all information indicated in a profile associated with a guide may be used to determine a rating and/or ranking of a guide.

The guide result ID field 525 may include information of a result associated with a guide. Content of the guide result ID field 525 may be modified based on actions of a guide. If a guide produces a search result responsive to a search request, an identifier of the search result may be included in the guide result ID field 525. A rating and/or ranking associated with a search result associated with a guide may affect compensation for a guide. Likewise a usage indicator associated with a search result provided by a guide may affect a rating or ranking associated with a guide. Using the example illustrated in FIG. 5, the results ‘Result1.1’, ‘Result3.1’ and ‘Result3.2’ are associated with the guide ‘Guide1’. This may indicate that ‘Guide1’ has provided and/or reviewed the results ‘Result1.1’, ‘Result3.1’, and ‘Result3.2’ responsive to a request.

The guide communication info field 530 may include information of a device and/or service associated with a guide. Content of the guide communication info field 530 may be modified based on action of a guide. If a guide establishes communications with the search system 130 (FIG. 1) using a device and/or service, information regarding the device and/or service may be included in the guide communication info field 530. Any type of communication service and/or system may be indicated in the guide communication info field 530. For example, a username and/or password associated with a guide may be indicated in the guide communication info field 530. Communication services such as Instant Messaging (IM), e-mail, SMS, MMS, EMS, telephone, wireless or wired communication, etc., may be indicated in the guide communication info field 530. A telephone number, an email address, an IM provider and login ID, a keyword associated with a service, etc., may be indicated in the guide communication info field 530. Using the example illustrated in FIG. 5, the login ‘guide1’, the email ‘guide1@chacha.com’, the IM credential ‘guide1@AIM’ and the phone number ‘317.224.2242’ are associated with the guide ‘Guide1’. This may indicate that ‘Guide1’ may be contacted using the login ID ‘guide1’, via email at ‘guide1@chacha.com’, via IM as ‘guide1@AIM’ and/or via voice, text, and/or other service associated with the phone number ‘317.224.2242’.

The guide request ID field 535 may include information of a request associated with a guide. Content of the guide request ID field 535 may be modified based on actions of a guide. If a guide produces a search result responsive to a search request, an identifier of the search request may be included in the guide request ID field 535. A rating and/or ranking associated with a search request associated with a guide may affect compensation for a guide. Likewise a usage indicator associated with a search request and a guide may affect a rating or ranking associated with the guide. A request may be associated with a guide based on a vote cast by a guide regarding items associated with the request. Using the example illustrated in FIG. 5, the requests ‘User request1’, and ‘System request3.1’ are associated with the guide ‘Guide1’. This may indicate that ‘Guide1’ has responded to, been selected to respond to, and/or has reviewed one or more items associated with the requests ‘User request1’ and ‘System request3.1’. For example, ‘Guide1’ may have provided the search result ‘Result1.1’ to the user ‘User1’ responsive to the request ‘User request 1’. Likewise, ‘Guide1’ may have reviewed the results ‘Result3.1’ and ‘Result3.2’ responsive to ‘System request3.1’. Any type of request may be provided to a guide. For example, a request may be associated with a user request, such as a search for information, a transcription, a translation, etc. and/or a request may be associated with a system activity such as evaluation of a search result, advertisement, categorization, or other item, or polling, testing, etc.

The guide advertisement ID field 540 may include information of an advertisement associated with a guide. Content of the guide advertisement ID field 540 may be modified based on actions of a guide. For example, if a guide accepts a review request associated with an advertisement, or if a guide selects an advertisement to be provided to a user responsive to a request, an identifier of the advertisement may be added to the guide advertisement ID field 540. Using the example illustrated in FIG. 5, the advertisements ‘Advert1’, ‘Advert3’, and ‘Advert4’ are associated with ‘Guide1’.

The guide opinion information field 545 may include information regarding an opinion of a guide regarding an item such as an advertisement. Actions of a guide responsive to an item may cause content of the guide opinion information field 545 to be modified. In at least one embodiment, the guide advertisement ID field 540 and the guide opinion information field 545 are linked by for example a pointer. Using the example illustrated in FIG. 5 ‘Guide1’ has indicated the opinions ‘Up’ regarding ‘Advert1’, ‘Preferred’ regarding ‘Advert3’ and ‘Not Preferred’ regarding ‘Advert4’. Any method of representing opinion information which is well known in the art may be utilized within the scope of the embodiments herein.

The guide vote weighting field 550 may include information of a vote weighting which may be applied to an opinion expressed by a guide. Content of the guide vote weighting field 550 may be determined based on various factors. In at least one embodiment, a peer rating associated with a category associated with a guide may be used to determine vote weighting. Alternately, alignment with a reference group of voters, quality assurance checking by system administrators, acceptance of ads by users, responses to training sessions and/or other rating methods may be used to determine a vote weighting associated with a guide. Using the example illustrated in FIG. 5, the weightings ‘2.0’, ‘0.5’, and ‘0.5’ are associated with the opinion of ‘Guide1’ regarding ‘Advert1’, ‘Advert3’, and ‘Advert4’.

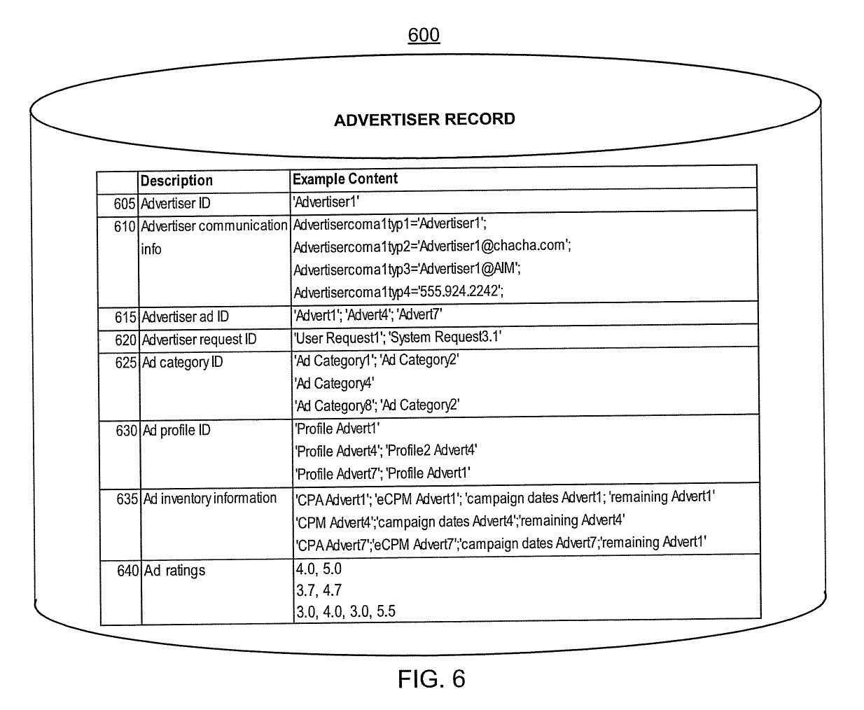

As illustrated in FIG. 6, an exemplary advertiser record 600 is provided, of which one or more may be associated with or resident in the database 120 (FIG. 1). The advertiser record 600 may include an advertiser ID field 605, an advertiser communication info field 610, an advertiser ad ID field 615, an advertiser request ID field 620, an ad category ID field 625, an ad profile ID field 630, an ad inventory information field 635, and an ad ratings field 640.

The advertiser ID field 605 preferably contains a unique identifier of an advertiser, which is preferably used consistently. For example, in at least one embodiment, the advertiser ID field 605 can include a randomly generated numerical code, and/or a text string indicating a name associated with an advertiser. An advertiser ID serves to distinguish the advertiser record associated with an advertiser from an advertiser record associated with other advertisers. Other unique identifiers of an advertiser may be utilized without departing from the spirit and scope of the embodiments. Using the example illustrated in FIG. 6, ‘Advertiser1’ is the advertiser ID associated with the advertiser record 600.

The advertiser communication info field 610 may include information of a device and/or service associated with an advertiser. Content of the advertiser communication info field 610 may be modified based on action of an advertiser. If an advertiser establishes communications with the search system 130 (FIG. 1) using a device and/or service, information regarding the device and/or service may be included in the advertiser communication info field 610 (FIG. 6). An advertiser may provide any or all information indicated in the advertiser communication info field 610. Any type of communication service and/or system may be indicated in the advertiser communication info field 610. For example, a username and/or password associated with an advertiser may be indicated in the advertiser communication info field 610. Communication services such as Instant Messaging (IM), e-mail, SMS, MMS, EMS, telephone, wireless or wired communication, etc., may be indicated in the advertiser communication info field 610. A telephone number, an email address, an IM provider and login ID, a keyword associated with a service, etc., may be indicated in the advertiser communication info field 610. Using the example illustrated in FIG. 6, the login ‘Advertiser1’, the email ‘Advertiser1@chacha.com’, the IM credential ‘Advertiser1@AIM’ and the phone number ‘555.924.2242’ are associated with the advertiser ‘Advertiser1’. This may indicate that ‘Advertiser1’ may be contacted using the login ID ‘Advertiser1’, via email at ‘Advertiser1@chacha.com’, via IM as ‘Advertiser1@AIM’ and/or via voice, text, and/or other service associated with the phone number ‘555.924.2242’.

The advertiser ad ID field 615 may include information of an advertisement associated with an advertiser. Content of the advertiser ad ID field 615 may be used to indicate access information and/or other information regarding an advertisement. For example a URL associated with a server associated with the advertiser system 150 (FIG. 1) might be indicated in the advertiser ad ID field 615 (FIG. 6). Any number of advertisements which include any type of media may be indicated in the advertiser ad ID field 615. Content of the advertiser ad ID field 615 may be modified in various ways. For example, an advertiser may submit information of an ad using a web page provided by a server associated with the search system 130 (FIG. 1). Using the example illustrated in FIG. 6, the advertiser ad ID ‘Advert1’, ‘Advert4’, and ‘Advert7’ are associated with ‘Advertiser1’.

The advertiser request ID field 620 may include information of a request associated with an advertiser. Content of the advertiser request ID field 620 may be modified in various ways. For example, if an advertisement is provided to a user responsive to a request, an identifier of the request may be added to the advertiser request ID field 620. Alternately, if an advertisement is delivered to a guide responsive to a request to evaluate the advertisement, an identifier of the request to evaluate the advertisement may be added to the advertiser request ID field 620. Using the example illustrated, the requests ‘User request1’ and ‘System request3.1’ are associated with ‘Advertiser1’. This may for example indicate that ‘Advert1’ was delivered responsive to ‘User request1’ and that ‘Advert4’ and ‘Advert7’ were provided responsive to ‘System request3.1’.

The ad category ID field 625 may include information of a category associated with an ad. Content of the ad category ID field 625 may be modified based on criteria such as an action of an advertiser. For example, an advertiser may select one or more categories and/or keywords which are to be associated with an ad. An association between an ad and a category may be used to select an ad responsive to a request associated with the category. A category associated with an ad may be used at least in part to select a guide to review the advertisement. A category may be associated with an advertisement based on testing of a guide. For example, if a guide is asked to select where an advertisement fits best, a selection made by the guide may be used to associate a category with the ad. Any advertisement may be associated with any number of categories. In at least one embodiment, the advertiser ad ID field 615 and the ad category ID field 625 may be linked by for example a pointer. Using the example in FIG. 6, the categories ‘Ad Category1’ and ‘Ad Category2’ are associated with ‘Advert1’, etc.

The ad profile ID field 630 may include information of a profile associated with an advertisement. Content of the ad profile ID field 630 may be modified based on action of an advertiser. A person may select a profile which is associated with an advertisement. For example, an advertiser may select a profile to be associated with an ad during an ad submission process. An advertiser may be provided with a list of available characteristics which may be used to target an ad, which may be used to determine information of a profile associated with an ad. For example, a geographic region, gender, political affiliation, job type, age, etc. might be available targeting parameters. In at least one embodiment, the advertiser ad ID field 615 and the ad profile ID field 630 may be linked by for example a pointer. Using the example in FIG. 6, the profiles ‘Profile Advert4’ and ‘Profile2 Advert4’ are associated with ‘Advert4’, etc.

The ad inventory information field 635 may include information of inventory parameters associated with an advertisement. Content of the ad inventory information field 635 may be used to modify a ranking and/or rating associated with an advertisement. For example, a cost per thousand (CPM) may be indicated, a cost per action (CPA), an effective CPM (eCPM), campaign start and end dates, remaining impressions, and/or other information regarding an advertisement may be indicated in the ad inventory information field 635.

The ad ratings field 640 may include information of a rating associated with an advertisement. A rating of an advertisement may be based on a rating provided by a guide associated with a category and a profile associated with the advertisement. Content of the ad rating field 640 may be used to determine if an advertisement is to be provided to a user responsive to a request.

In at least one embodiment, the advertiser ad ID field 615 and the ad category ID field 625, the ad profile ID field 630, the ad inventory information field 635, and the ad rating field 640 are linked by for example a pointer. Using the example in FIG. 6, ‘Advert1’ is associated with the categories ‘Ad Category1’ and ‘Ad Category2’, the profile ‘Profile Advert1’, the inventory information ‘CPA Advert1’;‘eCPM Advert1’;‘campaign dates Advert1;‘remaining Advert1’. Similarly ‘Advert4’ is associated with ‘Ad Category4’, ‘Profile Advert4’, ‘Profile2 Advert4’, ‘CPM Advert4’;‘campaign dates Advert4’;‘remaining Advert4’, and ‘Advert7’ is associated with ‘Ad Category8’, ‘Ad Category2’, ‘Profile Advert7’, ‘Profile Advert1’, ‘CPA Advert7’;‘eCPM Advert7’;‘campaign dates Advert7;‘remaining Advert1’.

Continuing with the example in FIG. 6, if no profile and ‘Ad Category2’ is associated with a query, ‘Advert1’ may be presented to a user. However a consideration such as eCPM might be used in determining whether ‘Advert1’, ‘Advert7’ and/or some other advertisement may be selected. Ad rating may be determined based on any suitable parameters which are well known in the relevant art.

For the purpose of targeting advertisements, it may be desirable to allow an advertiser to select from a broad set of categories and/or subcategories. For example, the category ‘Automotive’ might give broader coverage than the keyword ‘car’ or ‘auto’ or ‘new car’ or ‘Ford’. However, use of a taxonomy which is relevant relating to advertising materials may be contrary to selection of a guide, resource, etc., to respond to a query associated with the same taxonomy. It may be beneficial to have a taxonomy or index which is associated with advertisements, which is mapped to a taxonomy associated with a guide, a resource, a previous request, a search result, etc. Any or all classes or types of items may be associated with a taxonomy which may or may not be shared with other classes of items. For example, an index associated with advertisements may not be identical to an index associated with search resources and guides, which may be different from an index associated with search results and previous requests.

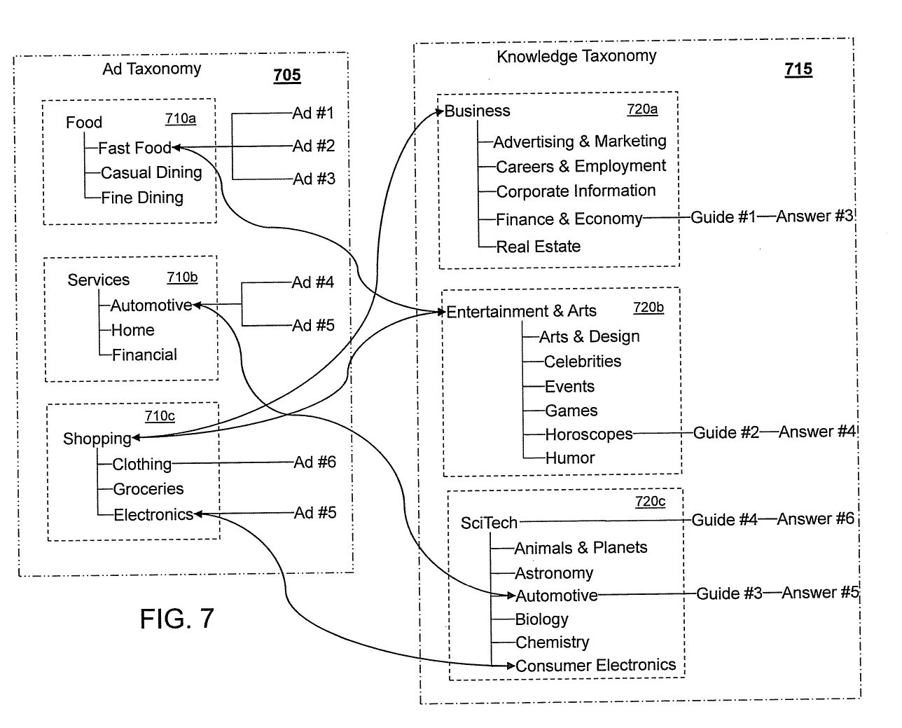

In order to relate one class or type or kind or sort of items or objects or articles to another, a mapping is required between the associated taxonomies. An exemplary mapping between an advertising index and a search information index is illustrated in FIG. 7. The knowledge taxonomy in the example is associated with guides and ‘answers’ or search results. While a limited number of categories, subcategories, ads, guides, answers, etc., are used for the purposes of illustration any number of categories, subcategories, ads, guides, and/or answers, etc., may be used within the scope of the disclosure herein. While a hierarchical index is used for the purposes of illustration, no limitation is implied thereby. Any type of index may be used without departing from the scope and spirit of the embodiments herein.

An ad taxonomy 705 may be comprised of a number of ad category hierarchies 710, which may have information of an advertisement associated with any node within the ad hierarchy 710. A knowledge taxonomy 715 may be composed of a number of knowledge category hierarchies 720 which may have information of a guide and/or a search result associated with any node within the knowledge hierarchy 720.

A top-level advertising category may be mapped to a top-level knowledge category. Using the example in FIG. 7, the category ‘Shopping’ in the ad hierarchy 710c is mapped to the category ‘Business’ in the knowledge hierarchy 720a, as indicated by the bi-directional arrows. If a query is received which is associated with the knowledge category ‘Business’ the ads ‘Ad #6’ and ‘Ad#5’ associated with the advertising category ‘Shopping’ may be ranked to be provided responsive to the query and ‘Guide #1’ and/or ‘Answer #3’ may be selected responsive to the query.

An advertising sub-category may be mapped to a knowledge sub-category. For example, the ‘Services>Automotive’ subcategory of the ad hierarchy 710b is mapped to the ‘SciTech>Automotive’ subcategory of the knowledge hierarchy 720c. If a query is received which is associated with the subcategory ‘SciTech>Automotive’, the ads ‘Ad #4’ and ‘Ad #5’ associated with the advertising sub-category ‘Services>Automotive’ may be ranked to be provided responsive to the query and ‘Guide #3’, ‘Guide #4’, ‘Answer #5’ and ‘Answer #6’ may be ranked or evaluated to be selected or provided responsive to the query. A ranking or rating or ordering or sorting or sequencing may be based on factors such as those described herein above.

Multiple advertising categories and/or subcategories may be mapped to the same knowledge category. For example the ad category ‘Shopping’ of the ad hierarchy 710c and the ad subcategory ‘Food>Fast Food’ of the ad hierarchy 710a are mapped to the category ‘Entertainment & Arts’ of the knowledge hierarchy 720b. If a query is received which is associated with subcategory ‘Entertainment & Arts’, the guide ‘Guide #2’ and the answer ‘Answer#4’ associated with the knowledge hierarchy 720b may be selected. The ads ‘Ad #1’, ‘Ad #2’, ‘Ad #3’, ‘Ad #5’ and ‘Ad #6’ may be ranked and/or selected responsive to the query.

As illustrated, any number of links may be established to map a first taxonomy, such as the ad taxonomy 705 to a second taxonomy such as the knowledge taxonomy 715. A rating of an advertisement which may be used at least in part to select an advertisement responsive to a query may be based on ratings by a guide as will be further described herein. Mapping or linking of one taxonomy to another taxonomy may be based on an input from a searcher(s) or based on a determination by the system 100 (FIG. 1). For example, any one of the ad category hierarchies having information of an advertisement associated may be mapped to any number of knowledge category hierarchies based on selection of one or more guides. Further, any mapping may be adjusted based on ranking changes applicable to the system 100 (FIG. 1).

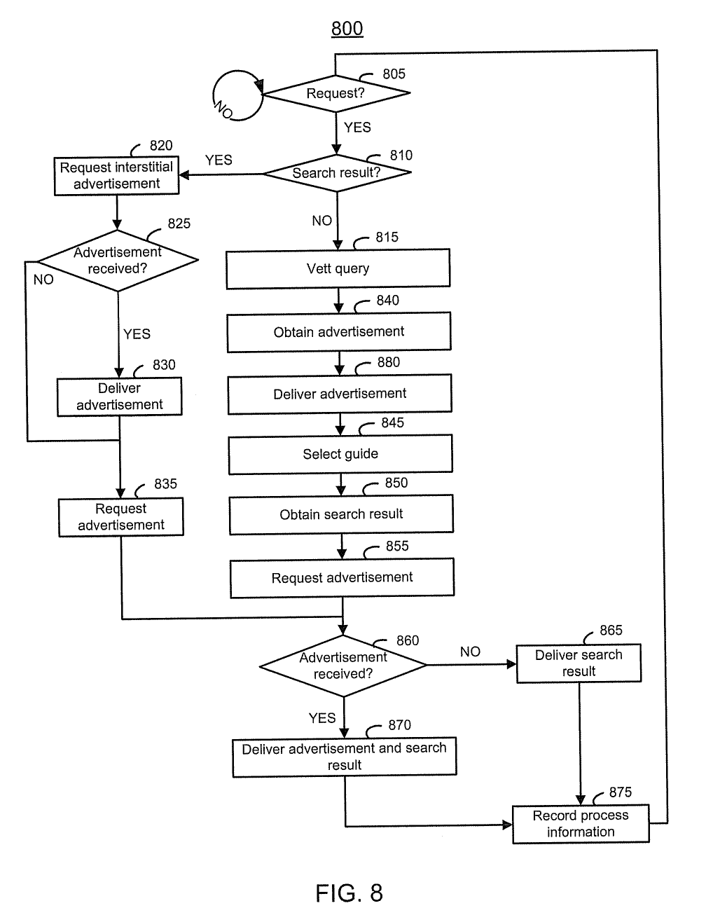

As illustrated in FIG. 8, a process 800 for processing a request is provided. The process 800 may be performed in whole or in part by any suitable element of the system 100 (FIG. 1). In at least one embodiment, the process 800 (FIG. 8) is operative on a server associated with the search system 130 (FIG. 1).

In operation 805 (FIG. 8), a determination is made as to whether a request is received. If it is determined in operation 805 that a request is not received, control remains at operation 805 and process 800 continues. If it is determined in operation 805 that a request is received, control is passed to operation 810 and process 800 continues.

The determination in operation 805 may be made using various criteria. In at least one embodiment, if a message is received at a server associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received.

In operation 810 (FIG. 8), a determination is made as to whether a search result is available. If in operation 810 it is determined that a search result is not available, control is passed to operation 815 and process 800 continues. If in operation 810 it is determined that a search result, or response, is available control is passed to operation 820 and process 800 continues.

The determination in operation 810 may be made using various criteria. In at least one embodiment, comparison to a database of previous queries, automated processing, processing by an external resource and/or any combination thereof may be applied to a query or question to determine if a search result is available.

In operation 815 a query is vetted. A vetting process may include various forms of processing which may be performed automatically and/or using the assistance of a person or entity. The vetting process results in the association of a structured query and/or a category with a request. Control is passed to operation 840 and process 800 continues.

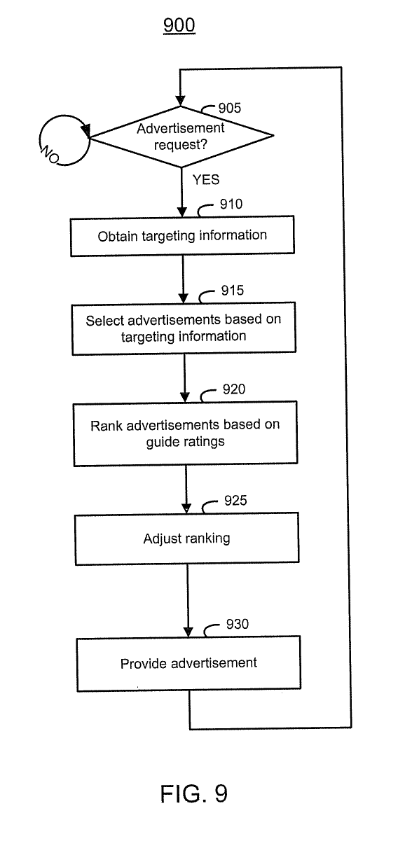

In operation 820 an interstitial ad is requested. An “interstitial advertisement” includes an advertisement which is presented prior to a search result. In at least one embodiment, an interstitial ad may be targeted based on content of a search result identified in operation 810. A process for providing an advertisement is further described herein below with respect to FIG. 9. Control is passed to operation 825 and process 800 continues.

In operation 825 a determination is made as to whether an advertisement is received. If in operation 825 it is determined that an advertisement is not received, control is passed to operation 835 and process 800 continues. If in operation 825 it is determined that an advertisement is received, control is passed to operation 830 and process 800 continues.

The determination in operation 825 may be made based on various criteria. In at least one embodiment, if an advertisement is not received at a server associated with the search system 130 (FIG. 1) from a server associated with an advertiser system (e.g. the advertiser system 150) within a pre-determined time interval following a request made in operation 825 (FIG. 8), it may be determined that an advertisement is not received. In at least one embodiment, if a user has a status indicator which indicates that interstitial ads are not to be served to the user it may be determined that an advertisement is not received. In at least one embodiment, if an advertisement received has been previously provided to a user, it may be determined that an advertisement is not received.

In operation 830, an advertisement received in operation 825 is delivered to a user. In at least one embodiment, more than one advertisement may be provided or delivered. Content of an advertisement may be modified based on a time interval, user history, etc. Any communication service associated with a user may be used to deliver an advertisement to a user. Control is passed to operation 835 and process 800 continues.

In operation 835, an ad is requested. A “contextual ad” includes an advertisement which is presented simultaneously with a search result. A contextual ad may, for example, be a text message which is appended to a response to a request to create a longer message, which is provided as an SMS message response to a user. In at least one embodiment, a contextual ad is requested. In at least one embodiment a programmatic delay may be executed, which may allow a user time to process information of an interstitial advertisement. A process for providing an advertisement is further described herein below with respect to FIG. 9. Control is passed to operation 860 and process 800 continues.

In operation 840 an advertisement is obtained. In at least one embodiment, the advertisement obtained is an interstitial advertisement may be targeted based on results of the query vetting process in operation 815. A process for providing an advertisement is further described herein below with respect to FIG. 9. Control is passed to operation 880 and process 800 continues.

In operation 880 an advertisement is delivered. In at least one embodiment, multiple advertisements are delivered or relayed or queued to a user during a time interval which is required to select a guide and/or obtain a search result. Control is passed to operation 845 and process 800 continues.

In operation 845, a guide is selected to respond to a request. A guide may be selected based on various criteria. For example, a first available guide, a highest ranking guide associated with a category associated with a request, a guide who most closely matches a profile associated with a user associated with a request, and/or a guide meeting combinations of such criteria may be selected to respond to a request. Multiple guides may respond to a request. Control is passed to operation 850 and process 800 continues.

In operation 850 a search result is obtained. A search result may be obtained based on any action of a guide. In at least one embodiment, a guide may obtain a text snippet and a reference URL from a web page as a search result. A search result may include any media such as audio, video, text, graphics, computer readable media, scripting language such as Java® or Flash®, etc., which may be indicated to a user. A guide may submit a query to a resource which may provide a response or search result to a user. Control is passed to operation 855 and method 800 continues.

In operation 855, an advertisement is requested. In at least one embodiment a contextual ad is requested. A request for an advertisement may include information regarding a result which may be used to select an advertisement. A category, a profile, a constraint and/or other information associated with a search result may be used to select an advertisement. For example, if a URL associated with a search result is associated with an advertiser, an advertisement from the advertiser may be ranked higher, or if a search result is obtained from a resource associated with an age group, an advertisement associated with the age group may be ranked higher. Control is passed to operation 860 and process 800 continues.

In operation 860, a determination is made as to whether an advertisement is received. If in operation 860 it is determined that an advertisement is not received, control is passed to operation 865 and process 800 continues. If in operation 860 it is determined that an advertisement is received, control is passed to operation 870 and process 800 continues.

The determination in operation 860 may be made based on various criteria. In at least one embodiment, if an advertisement is not received at a server associated with the search system 130 (FIG. 1) from a server associated with an advertiser system (e.g. the advertiser system 150) within a pre-determined time interval following a request made in operation 860 (FIG. 8), it may be determined that an advertisement is not received. In at least one embodiment, if a user has a status indicator which indicates that contextual ads are not to be served to the user it may be determined that an advertisement is not received. In at least one embodiment, if an advertisement received has been previously transmitted to a user, it may be determined that an advertisement is not received. While the operations 855 and 860 have been depicted as single instances, in at least one embodiment, multiple requests for an advertisement may be made.

In operation 865, a search result is delivered. A search result may be transmitted or published using any communication service and/or system associated with a user. Control is passed to operation 875 and process 800 continues.

In operation 870, a search result and an advertisement is transmitted to a user. In at least one embodiment, a contextual ad is provided to a user. A search result and/or a contextual ad may be provided using any service and/or device or facility associated with a user. Control is passed to operation 875 and process 800 continues.

In operation 875, information of the process is recorded. Information of a guide, a user, an advertisement, an index, a resource, and/or other item recorded. Information regarding usage of an advertisement, a selection by a guide and/or a selection by a user may be recorded. For example, information of advertisements delivered to a user, search resources used by a guide, etc., may be recorded in the database 120 (FIG. 1). Information of advertisements delivered and/or user actions associated with an advertisement may be archived or recorded. Control is passed to operation 805 (FIG. 8) and process 800 continues.

As illustrated in FIG. 9, a process 900 for processing a request for an advertisement is provided. The process 900 may be performed in whole or in part by any suitable element of the system 100 (FIG. 1). In at least one embodiment, the process 900 is operative on a server associated with the search system 130 (FIG. 1) and/or the advertiser system 145.

In operation 905 (FIG. 9), a determination is made as to whether a request for an advertisement is received. If, in operation 905, it is determined that a request for an advertisement is not received, control remains at operation 905 and process 900 continues. If, in operation 905, it is determined that a request for an advertisement is received, control is passed to operation 910 and process 900 continues.

The determination in operation 905 may be made based on various criteria. In at least one embodiment, receipt of a request at a server associated with the search system 130 (FIG. 1) may be used to determine if a request for an advertisement is received. Content of an email message delivered according to SMTP or other email protocol, an IM, an SMS, MMS, EMS, voice, web service request using a protocol such as the Simple Object Access Protocol (SOAP) or other message may be examined to determine if a request for an advertisement is received.

In operation 910 (FIG. 9), targeting information which may be used to select an advertisement is obtained. For example, a message received in operation 905 may be examined to determine targeting or intention information associated with the request. In at least one embodiment, a knowledge taxonomy category, a keyword and/or a profile associated with a request is obtained. The targeting information may be obtained from data of a source of the request. For example, any type of descriptive information contained in the request may serve as the targeting information. Control is passed to operation 915 and process 900 continues.

In operation 915, advertisements are selected based on targeting information obtained in operation 910. In at least one embodiment, advertisements linked or associated with an advertising taxonomy category which is linked to the knowledge taxonomy category, and/or keywords identified in operation 910 are selected. Control is passed to operation 920 and process 900 continues.

In operation 920, advertisements selected in operation 915 are ranked based on a rating obtained from a guide. In at least one embodiment, advertisements selected in operation 915 are ranked based on ratings obtained from a guide associated with the category, keyword and/or profile obtained in operation 910. A weighting factor may be applied to a rating in order to determine a ranking of an advertisement. Control is passed to operation 925 and process 900 continues.

In operation 925, ranking of an advertisement is adjusted. A ranking of advertisements may be adjusted based on inventory information indicated in a record such as the advertiser record 600 (FIG. 6). For example, if an advertisement has a high ranking from operation 920, but the revenue (e.g., CPM) associated with the advertisement is low, the advertisement ranking may be lowered, or if a number of advertisements have the same CPA, an advertisement which has a higher ranking from operation 920 may be ranked higher. Factors such as volume of advertisements delivered, start and end dates, etc. may be used to adjust a ranking of an advertisement. Any suitable relationship and any information associated with an advertisement may be used to adjust a ranking of an advertisement. Control is passed to operation 930 and process 900 continues.

In operation 930, an advertisement is provided responsive to a request. An advertisement may be provided using any suitable communication service associated with a request. In at least one embodiment, information of an advertisement may be provided as an http POST responsive to an http GET request received in operation 905. Any number of advertisements may be provided. For example, a highest ranked advertisement, or the three highest ranked and/or rated advertisements might be provided. Control is passed to operation 905 and process 900 continues.

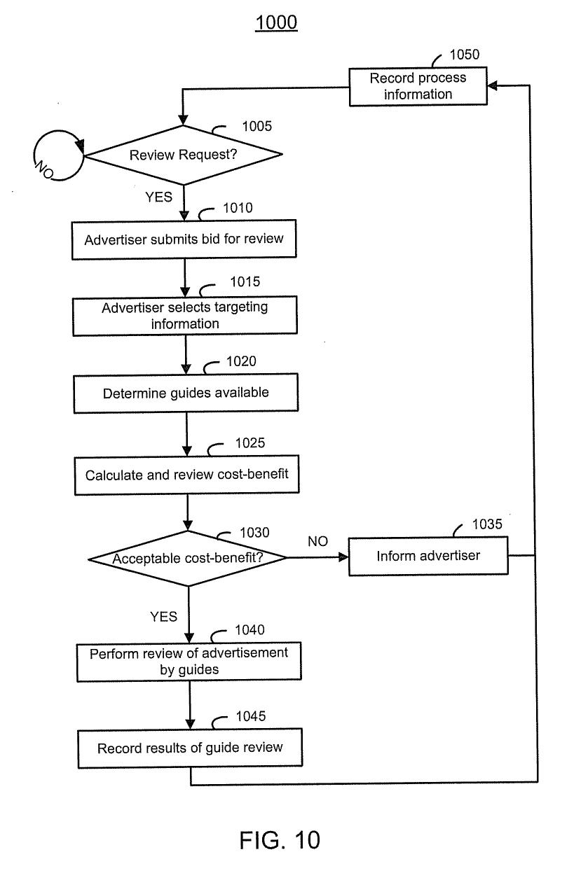

As illustrated in FIG. 10, a process 1000 for reviewing an advertisement is provided. The process 1000 may be performed in whole or in part by any suitable element of the system 100 (FIG. 1). In at least one embodiment, the process 1000 is operative on a server associated with the search system 130 (FIG. 1).

In operation 1005 (FIG. 10), a determination is made as to whether a request to review an advertisement is received. If in operation 1005 it is determined that a request to review an advertisement is not received, control remains at operation 1005 and process 1000 continues. If, in operation 1005, it is determined that a request to review an advertisement is received, control is passed to operation 1010 and process 1000 continues.

In operation 1010, an advertiser submits a bid for a review. A bid may be an implicit bid. In at least one embodiment, a bid price may be determined based on a calculation or business rule. For example, a percentage of total revenue from an advertisement may be determined, which may produce an implicit bid for review services. Likewise, if a campaign has an expected value greater than a predetermined amount it may be determined that an implicit bid for review has been made. In at least one embodiment an advertiser may submit an explicit bid using a web page provided by a server. Control is passed to operation 1015 and process 1000 continues.

In operation 1015, an advertiser selects targeting information for an advertisement. In at least one embodiment, an advertising taxonomy category, and profile information associated with a target or intended or desired user or recipient are provided by an advertiser. Any type of information such as time of day, type of device, etc., may be provided as targeting or destination information. Control is passed to operation 1020 and process 1000 continues.

In operation 1020 guides available to review an advertisement are determined. Any rules, formula, criteria, etc., for determining the available guides may be utilized. For example, if a review result is needed rapidly, only guides who are currently logged in to an account associated with the search system 130 (FIG. 1) may be considered when determining a number of available guides. Matching criteria between a target user and a selected guide may be modified and/or reduced and/or expanded to determine whether a suitably large pool of guides may be available. For example, if a review process is not time critical, a pool of guides who regularly login to the search system 130 may be considered to be available or eligible or suitable on a statistical basis. Control is passed to operation 1025 and process 1000 continues.

In operation 1025, a cost-benefit calculation is performed. Any suitable business rules may be applied in order to determine cost-benefit analysis parameters. For example, a total cost for a representative sample of guides in each metropolitan area identified in a profile provided in operation 1010 might be determined, or a predicted improvement in effective CPM (eCPM) for a CPA advertisement might be determined, etc. Any information regarding an advertisement and/or other item indicated in the database 120 (FIG. 1) might be used to determine cost and/or benefit opportunities. For example, a benefit of review of ads associated with less frequently selected or higher inventory nodes of the advertising taxonomy may be adjusted, or the cost of a guide associated with a category might be incorporated in business rules. Control is passed to operation 1030 and process 1000 continues.

In operation 1030 a determination is made as to whether a cost-benefit is acceptable. If in operation 1030 it is determined that a cost-benefit is not acceptable, control is passed to operation 1035 and process 1000 continues. If in operation 1030 it is determined that a cost-benefit is acceptable, control is passed to operation 1040 and process 1000 continues.

In operation 1035, an advertiser is informed that a review is not performed. In at least one embodiment, an advertiser may be informed indirectly. For example, if a bid for review is based on an implicit calculation of an offer or bid associated with an advertisement or advertising campaign, an advertiser may be informed that a bid is below the minimum offer price. In at least one embodiment, an advertiser may be informed of a minimum offer price for a review which has been requested. In at least one embodiment, an advertiser may not be made aware that a review has been declined. Control is passed to operation 1050 and process 1000 continues.

In operation 1040, a review of an advertisement is performed by a guide. Any number of guides may perform a review or assessment or check or critique of an advertisement. Review of an advertisement may be performed using various types of tasks or activities or games. For example, a guide may be presented with a graphical user interface (GUI) which might be used to select an advertisement to be sent to a user responsive to a query and an answer provided in the GUI and a selection by the guide might be recorded. Alternate types of comparison, preference and voting interfaces may be provided to allow a guide to express an opinion or impression or inclination. Control is passed to operation 1045 and process 1000 continues.

As a guide may also be a user, an advertisement may be provided to a guide without the guide being aware that the advertisement is being reviewed. For example, an advertisement which is associated with a broad subject matter, but targeted to a more narrow profile, such as a geographic, demographic, and/or affiliation (e.g. Indiana Pacers fans) attribute, may be provided to guides who are believed to match the intended profile in response to a query submitted by a guide and/or when a guide is responding to a user request associated with the category.

In operation 1045 guide review results are recorded. Results of a review may include any information which is obtained from a guide and/or a user responsive to information of an advertisement. In at least one embodiment, information of individual responses of each guide is recorded. Any information associated with guide review, such as advertisements used for a comparison, time associated with actions, values of ratings, etc., may be recorded. In at least one embodiment, information of a guide review is recorded in a record such as the guide record 500 (FIG. 5) which may be indicated in the database 120 (FIG. 1). Control is passed to operation 1050 (FIG. 10) and process 1000 continues.

In operation 1050 information of the process 1000 is recorded. Any process information of an advertisement based on a review process, payment requested from an advertiser, compensation of a guide, etc., may be recorded and/or modified. For example, cost-benefit calculations associated with an advertiser may be recorded, compensation for a guide associated with a review activity, comparison of actions of guides, etc. may be recorded, Control is passed to operation 1005 and process 1000 continues.

The process 1000 may be used in various scenarios or situations. For example, an advertiser may elect to test an advertising campaign with a sample group of guides to evaluate the advertisement prior to distributing to a general audience. In at least one embodiment, an advertiser may provide different advertisements to the same group of guides who may indicate a preference for a particular advertisement compared to others. In at least one embodiment, a ‘blind’ comparison in which different advertisements are provided to the same and/or different guides who may respond to the advertisements may be provided. As described above, an evaluation may be performed in real-time, and/or on a specified time interval. An advertiser may request evaluation, and/or the search system 130 (FIG. 1) may evaluate an advertisement in order to determine whether the bid price offered will produce a suitable return.

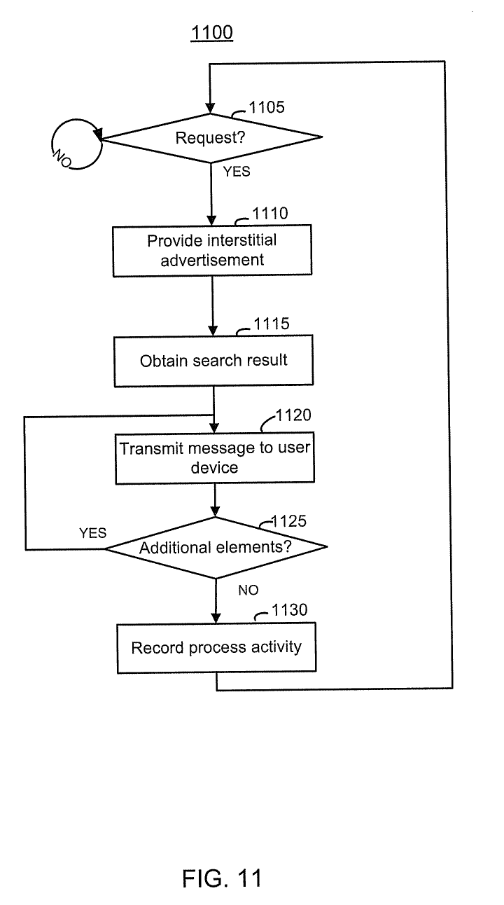

In at least one embodiment, a result or search result may include one or more messages which are to be provided to a user responsive to a request. As illustrated in FIG. 11, a flowchart for a process 1100 of providing a result or response which may include multiple messages is provided. The process 1100 may be operative on a server associated with the search system 130 (FIG. 1).

In operation 1105 (FIG. 11), a determination is made as to whether a request is received. If, in operation 1105, it is determined that a request is not received, control remains at operation 1105 and process 1100 continues. If in operation 1105 it is determined that a request is received, control is passed to operation 1110 and process 1100 continues.

In operation 1110 an interstitial advertisement is provided. An interstitial advertisement may be targeted. A process for providing an advertisement is further described herein with respect to FIG. 9. Control is passed to operation 1115 and process 1100 continues.

In operation 1115 a search result is obtained. A search result may be obtained using an automated system and/or using the assistance of a guide as described further herein. A search result may be separated into multiple messages. A result or answer may be separated for various reasons. For example, a constraint of a messaging service such as SMS may limit the total length of a message, but an answer such as a song lyric, a news item, a word definition, etc., may exceed the maximum number of characters allowed. In such an instance, a search result or result may be divided into multiple SMS messages. Similarly a result might include multiple images, which could be sent as multiple MMS messages, etc. A response might be parsed to allow insertion of advertising messages, to allow a user to review a previous message, to provide a suitable break point in delivery, etc. Control is passed to operation 1120 and process 1100 continues.

In operation 1120, a message is transmitted to a user device. A message may include a portion of a search result and may further include an advertisement. In at least one embodiment, text of a search result is included with text of an advertisement. A message may be a continuation of a previous message. Control is passed to operation 1125 and process 1100 continues.

In operation 1125, a determination is made as to whether a request to provide additional elements of a result is received. If, in operation 1125, it is determined that a request to provide additional elements of a result is not received, control is passed to operation 1130 and process 1100 continues. If in operation 1125 it is determined that a request to provide additional elements of a result is received, control is passed to operation 1120 and process 1100 continues.

The determination in operation 1125 may be made based on various criteria. For example, a user action and/or inaction such as a message containing a keyword, a key press, a spoken reply, a user interface action, an IP request, etc., may be used to determine if a request to provide additional elements of a result is received.

In operation 1130, process activity is recorded. For example, information of a search result provided to a user, a user response to a search result, an advertisement, a guide, etc., may be recorded. In at least one embodiment, process results are recorded or stored in the database 120 (FIG. 1). Control is passed to operation 1105 (FIG. 11) and process 1100 continues.

While the process 1100 has been described using the example of an SMS message, and text advertisements, no limitation is implied thereby. Any communication medium and/or service and/or combination thereof may be utilized to create a message associated with a request, a search result and an advertisement.

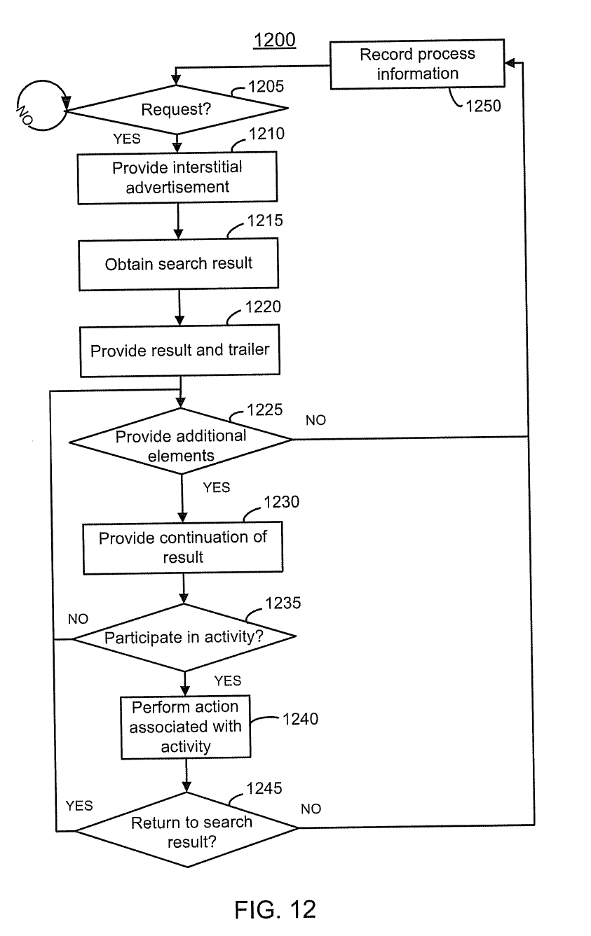

In at least one embodiment a user may be provided with a search result, which may include an optional action which action may interrupt a sequence of messages associated with a search result. For example, an advertisement which may provide an opportunity to purchase an item, or review an offer by responding in a particular way may be included in a message provided as a search result. In such an instance, it may be desirable to allow a user to return to a sequence of search results if an action has been completed. As illustrated in FIG. 12, a flowchart for a process 1200 of providing a result which may include multiple messages and may allow a user to return to a sequence of search result messages subsequent to an action is provided. The process 1200 may be operative on a server associated with the search system 130 (FIG. 1).

In operation 1205 (FIG. 12), a determination is made as to whether a request is received. If in operation 1205 it is determined that a request is not received, control remains at operation 1205 and process 1200 continues. If in operation 1205 it is determined that a request is received, control is passed to operation 1210 and process 1200 continues.

In operation 1210, an interstitial advertisement is provided. An interstitial ad may be targeted. A process for providing an advertisement is further described herein with respect to FIG. 9. An interstitial ad may include materials provided for entertainment purposes. Control is passed to operation 1215 and process 1200 continues.

In operation 1215 a search result is obtained. A search result may be obtained using an automated system and/or using the assistance of a guide as described further herein. A search result may be separated into multiple messages. The result may be separated for various reasons. A publisher, who may provide search services, an advertiser, a guide, etc., may define how a message is parsed for delivery. For example, the search system 130 (FIG. 1) may determine a number of messages, an order of delivery, delivery logic and/or other parameters used to deliver a result composed of multiple messages. Control is passed to operation 1220 and process 1200 continues.

In operation 1220, a result and trailer is provided (a message is transmitted to a user device). A message may include a portion of a search result and may further include an advertisement. In at least one embodiment, text of a search result is included with text of an advertisement. A message may be a continuation of a previous message. Control is passed to operation 1225 and process 1200 continues.

In operation 1225 a determination is made as to whether a request to provide additional elements of a result is received. If in operation 1225 it is determined that a request to provide additional elements of a result is not received, control is passed to operation 1250 and process 1200 continues. If in operation 1225 it is determined that a request to provide additional elements of a result is received, control is passed to operation 1230 and process 1200 continues.

The determination in operation 1225 may be made based on various criteria. For example, a user action and/or inaction such as a message containing a keyword, or a key press, or a spoken reply, etc., may be used to determine if a request to provide additional elements of a result is received. For example, if a user does not respond to a message provided, it may be determined that a request to provide additional elements of a result has been received.

In operation 1230, a continuation of a search result is provided to a user. A continuation may include an interstitial and/or a trailer advertisement which may invite a user to participate in an activity of any sort. A trailer is a sub-class of advertisements which is an ad that is appended to a search result. A trailer may also appear as a separate message after a result is provided to the user. Any type of information compatible with a user device may be provided as a continuation of a search result. In at least one embodiment, a text message is provided as a continuation of a search result. In at least one embodiment, a continuation may be provided to a different user device, and/or by a different service. Control is passed to operation 1235 and process 1200 continues.

In operation 1235, a determination is made as to whether a request to participate in an activity is received. If, in operation 1235, it is determined that a request to participate in an activity is not received, control is passed to operation 1225 and process 1200 continues. If, in operation 1235, it is determined that a request to participate in an activity is received, control is passed to operation 1240 and process 1200 continues.

The determination in operation 1235 may be made based on various criteria. For example, a user action and/or inaction such as a message containing a keyword, or a key press, or a spoken reply, etc., may be used to determine if a request to participate in an activity is received.

In operation 1240, actions associated with an activity are performed. Actions associated with an activity may include any types of actions which may be performed by a user and/or the system 100 (FIG. 1). For example, an activity may include purchasing an item, taking a poll, interacting with a guide, responding to a defined series of messages, etc. Any number of activities may be performed in any sequence. Control is passed to operation 1245 and process 1200 continues.

In operation 1245 a determination is made as to whether a request to return to a search result is received. If in operation 1245 it is determined that a request to return to a search result is not received, control is passed to operation 1250 and process 1200 continues. If in operation 1245 it is determined that a request to return to a search result is received, control is passed to operation 1225 and process 1200 continues.

The determination in operation 1245 may be made based on various criteria. For example, a user action and/or inaction such as a message containing a keyword, or a key press, or a spoken reply, etc., may be used to determine if a request to return to a search result is received.

In operation 1250, process information is recorded. For example, information of a search result provided to a user, a user response to a search result, an advertisement, a guide, etc., may be recorded. In at least one embodiment, process results are recorded or stored in the database 120 (FIG. 1). Control is passed to operation 1205 (FIG. 12) and process 1200 continues.

While a few examples of guide selection and opinion being used are described herein, guide opinions may be obtained and utilized or employed in various ways. For example, a guide may select an advertisement from among a group of advertisements which may be targeted to users similar to the guide, or a guide that has training and/or experience with selecting advertisements may select an advertisement to be targeted to a user based on profile information of the user.

Judgment or comprehension or perception of a guide may be used to determine various parameters of the advertising and messaging delivered using a process such as the process 1100 and the process 1200. For example, a guide may determine advertisements delivered with a particular category of query and/or answer. Similarly, a guide may influence an order in which an advertisement is provided in a sequence of messages associated with an answer. Likewise, a guide may affect which advertisements are presented responsive to an action of a user. Any parameters of an advertising or promotional sequence may be affected by judgment or intelligence of a number of guides.

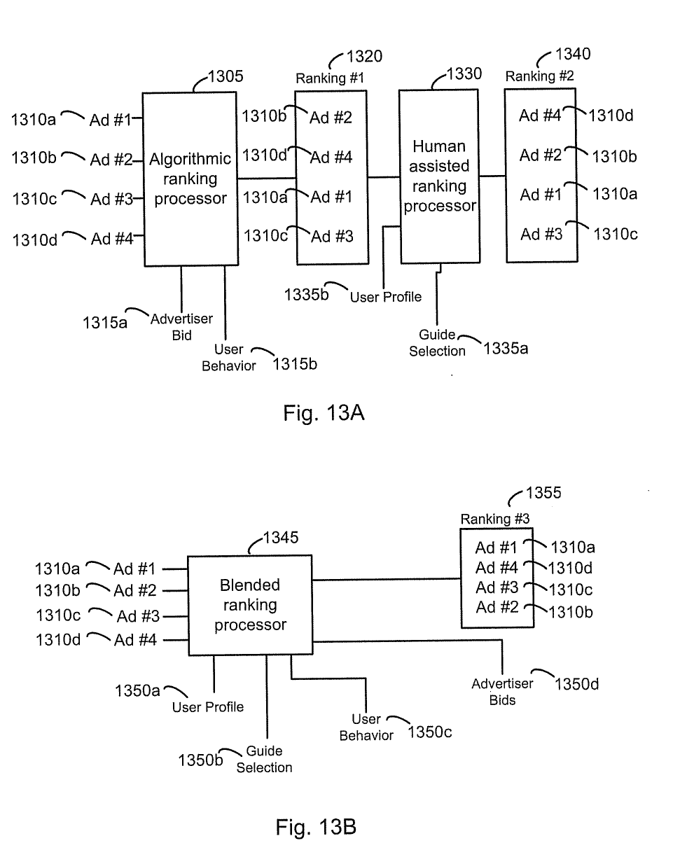

A generalized depiction of the use of guide judgment to select or choose or qualify an advertisement is depicted in FIG. 13A. A group of advertisements 1310 is provided. An algorithmic ranking processor 1305 evaluates input variables 1315 to rank advertisements 1310. For example the input advertiser bids 1315a and the input user behavior 1315b may be numeric data which is associated with the advertisements 1310. An algorithm is applied to the advertisements based on the input variables 1315 to produce “Ranking #1”, a ranked list of advertisements 1320. The ranked list of advertisements 1320 is used as an input to a human-assisted ranking processor 1330. The human-assisted ranking processor 1330 utilizes inputs 1335 to rank the advertisements 1310 of the ranked list of advertisements 1320. The guide selection input 1335a and the user profile input 1335b may be used to modify the ranking of the advertisements 1310 to produce “Ranking #2”, a final advertisement ranking list 1340. In such an embodiment a decision by a guide may be a direct determinant of an advertisement presented. In some embodiments, a guide may select an advertisement based on a target user device, or a type of media.

An alternate embodiment of a selection system utilizing guide judgment is illustrated in FIG. 13B. A blended ranking processor 1345 utilizes the advertisements 1310 as an input. Blended input variables 1350 are supplied to the processor 1345. For example, the user profile input 1350a, the guide selection input 1350b, the user behavior input 1350c, and the advertiser bids input 1350d are provided to the blended ranking processor 1345. An algorithm is applied which produces a blended ranking advertisement list 1355. The blended ranking list 1355 is ordered based on a combination of the blended input variables 1350. Thus the guide selection input may not override other input variables.

Having improved the ability to determine whether a particular advertisement is more likely to appeal to a type of person using intelligence of a number of guides, it is also desirable to determine characteristics of users who may receive advertisements. In many instances, a user may not want to directly provide such information for any reason. As a consequence it may be desirable to predict a number of characteristics of a user based on behavior associated with the user. This technique has been referred to as ‘behavioral marketing’. However, behavioral marketing must make various assumptions regarding user actions which are related to a particular characteristic of a user. The assumptions underlying a prediction model may be erroneous, which causes errors in the predictions. Generally, it is difficult to obtain a large database of actions by a well known group of users in order to make predictions regarding a user based on a small number of queries by the user. Thus a method and system for constructing a predictive model of user characteristics which does not require a large number of known users as a basis for the model would be greatly appreciated.

In order to be able to determine with reasonable certainty characteristics of a user without the need to intrusively request such information, analysis of user history may be performed in order to infer characteristics of the user. In general this is difficult in a keyword based system since a single keyword is unlikely to be well correlated to a group of users with a common demographic. A reliable reference group of users which is of statistically significant size must be obtained in order to create evidence factors so that a statistical inference engine has a broad enough vocabulary to detect a particular parameter. A “reference user” may be any member of a group of users which is used to create, modify, refine, adjust, test, and/or otherwise determine characteristics or parameters of an algorithm, model, system, formula and/or method for prediction or determination of characteristics of a user. A prediction model or inference model may employ any items and/or information associated with a user to deduce, derive, or ascertain a characteristic of a user and/or guide.

In an information search system which allows a user to enter a request and receive a response, the request or query and the response or result or answer may be recorded in association with the user. When a user is utilizing a device associated with a private network such as an intranet and/or a mobile phone network, an identifier of the device originating a request may be specific to the device and may be used to uniquely identify the user. Likewise, if a user creates a login ID for a web server, queries associated with the user may be available for analysis. In such an instance, it is possible to compare a user request, response and/or other information associated with the user to determine a characteristic of the user which may be used to target information responses for future queries. Analysis of a response to a request may include the human intelligence which was used by a human searcher to infer the meaning of a request. For example, a query with similar content which was reviewed by a searcher based on user history information may obtain a different response based on inference of a user characteristic by the searcher. Some systems have attempted to infer user characteristics based on statistical information of content of user queries. However, it is necessary to be able to normalize message data which is analyzed in order to increase the accuracy of predictions.

It is necessary to obtain a reliable reference group which can be used to infer which characteristics may be associated with any element of a query, a response and/or other user action. The cost of obtaining a sufficiently large sample size of queries and/or characterized persons submitting requests and receiving responses may be high. In order to overcome this problem, a two phase approach to creating a model for predicting a characteristic of an unknown user based on queries, responses and/or other information associated with the user is applied. A group of reference users is identified. The size of a reference group may be as small as 0.1% the size of a final group of users which is to be analyzed. The reliability of characteristic or ‘profile’ information associated with a reference group is verified with high confidence. Any number of requests and/or responses from a user in the reference group may be used. A larger sample of queries and/or responses, etc. associated with the reference group may produce a more reliable data set which may allow differentiation of more subtle and/or diversified characteristics or parameters.

In a search system employing human searchers, a searcher may register with the search system and may be required to provide information of any type. For example, as a part of and/or subsequent to a registration process demographic, psychographic, geographic, affiliation, interests, etc. associated with a guide may be obtained. As a guide may also be a user, a guide may be associated with a request, response and/or action. A number of guides associated with a statistically significant number of requests and/or responses may be much greater than a number of users in a reference group. In at least one embodiment, the guide group is at least ten to one hundred times larger than the reference user group, Profile information of a guide may be less reliable than the profile information associated with a member of a reference group. For example, it may be that age, education, or other parameters associated with a guide are not verified, or a device associated with a guide may be used by other persons than the guide.

A prediction model is constructed based on the characteristics of a group of guides. Queries, responses, categories, keywords and/or actions associated with a group of guides are used to create a predictive model. Predictions of characteristics of the members of the reference group made using the prediction model created from the guide information are compared to the known characteristics of the reference group. The prediction parameters of the guide-based model are adjusted based on error functions determined from the predictions of the model versus actual characteristics for the known group of reference users. Such a process may be repeated as modifications are made to the membership of a guide pool and/or a reference group. A revision of the model may be made based on criteria such as time, increase in user base, changes in guide population, changes in information associated with the reference group, etc. A size of a selected guide group may be a fraction of the size of the expected user population. A reference user group may be a fraction of the size of a selected guide population or group.

The larger size of the guide pool allows a substantial increase in the vocabulary of a prediction model compared to a model which would be created based on the reference group. The larger sample size of the guide group may increase a confidence factor associated with a prediction of characteristics of a user as the number of requests and/or responses which match more closely to a user request is increased. As a user request history is accumulated, predictions of user characteristics may be improved. Any user request, response, etc., may be compared to a prediction which is subsequently updated based on a model of requests, responses, and/or other actions associated with a characteristic.

As will be described further herein, a prediction of a user characteristic may be made based on requests, responses and/or actions associated with a user. By using a known group of users to create a characteristic prediction model, expanding the distribution basis or vocabulary of the model using information associated with a larger group of known human searchers who are also users, and analyzing a sample of user requests, responses and actions, a prediction of a user characteristic may be made. A predicted characteristic may be used to target information such as advertisements, interactive activities, and/or search resources to a user, and/or may be used to select a searcher to respond to a request.

A predictive model based on a population may be verified against a smaller population of reference users who have a known value for the target characteristic. For the reference users, a prediction of the user characteristics is made using query and/or other information associated with the reference users utilizing the predictive model. The predictive model is revised by changing the characteristics used to construct the predictive model. For example, the guide profile, the number of queries, the type of parameters selected, the form of a query, or other parameters which are considered in construction of the predictive model and/or evaluation of the efficacy of the model may be adjusted. A person may adjust the performance of the model and/or automatic feedback may be used.

Using a predictive model which has leveraged the guide pool and the reference user pool, it is possible to construct a predictive model which does not require a large pool of reference users. As the guide pool is typically two or more orders of magnitude larger than the reference user pool, the cost of obtaining a sufficiently accurate and diverse basis for the predictive model is reduced by a similar ratio. Further, since guides may be required to provide various forms of information, more characteristics may be determined as the size of the activity database associated with the guide group increases. Experimental data has shown that accuracy of prediction is reasonably good using a small sample group. For example, if a seventy-five percent confidence level is used, a prediction of gender for eighty-five percent of users may be made. While the accuracy is presumed to be seventy-five percent, this would indicate that the odds of correct targeting of an item has increased three fold from the natural probability (i.e. natural odds of targeting correct gender=1:1, adjusted odds=3:1). With a greater activity history, it would be reasonable to expect a higher confidence factor.

In such an instance, it is not necessary to obtain personally identifying information of a user such as name, address, email, etc., in order to improve targeting of information to the user. The cost of constructing a consistent, accurate, scalable model for prediction of user characteristics is reduced greatly. Guides, who are compensated to create a profile and/or other information associated with activities, may act as a test group in order to create a predictive model of user characteristics. A small group of users who may be composed as needed may be used to validate and tune a prediction model. Any parameters associated with a user activity may be selected to determine predictive correlation for a user characteristic.

The new method and system solve the problem of improving targeting and matching of guides, and other information with users without the need to gather specific information from users. Unlike current systems, characteristics of a user may be inferred from a known group without the need for gathering information from a large group which is of questionable reliability. Human searchers that have provided personal data for the purposes of obtaining and/or improving opportunities for compensation provide a large and reliable source of information. As guide history and/or user history is expanded, predictions of user characteristics may improve.

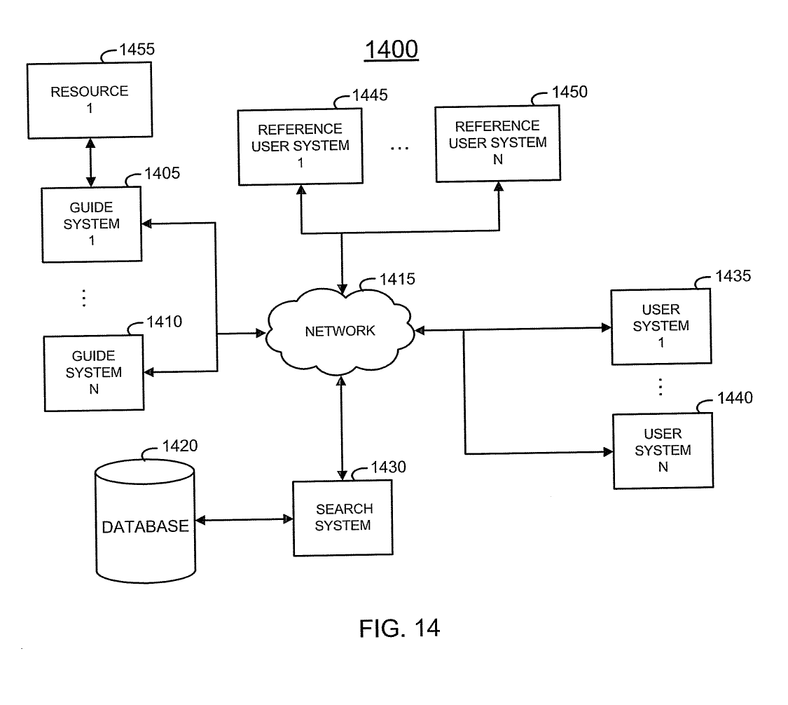

As illustrated in FIG. 14, a system 1400 includes guide systems 1405, 1410, a network 1415 such as the Internet, a search system 1430, user systems 1435, 1440, a database 1420, which may comprise various records, reference user systems 1445, 1450, and the resource 1455.

While only a limited number of systems associated with a guide, resource, user, reference user, and as a search system are depicted in FIG. 14, it is within the scope of the disclosure for multiple systems for guide, resource, user, reference user and search systems to be utilized.

Any user system (e.g., the user systems 1435, 1440) can be operated by an information seeker or user or requester, who may be a person or entity, to submit a search request to the search system 1430 and/or receive a result and/or other information. Any guide system (e.g., the guide systems 1405, 1410) can be operated by a guide to obtain a result for a user. Any reference user system (e.g., the reference user systems 1445, 1450) may be operated by a user who has provided verified information of characteristics or distinguishing traits. The resource 1455 may be operated by a human provider of information and/or may be an automated system which may provide a result and/or other information to a guide and/or a user, such as a search engine, a database, a local information source of a guide system such as an optical or magnetic disk, removable persistent storage, memory device, transient signal source, etc. A resource may not be accessible using the network 1415. For example, a resource such as the ‘Resource 1’ resource 1455 may be accessible to a guide operating a guide system such as the guide system 1405. A resource might include printed materials, images, video, and/or audio information, a software application, any information accessible to a guide, a database, and/or any combination thereof.

The network 1415 (FIG. 14) may be a global public network of networks (the Internet) and/or consist in whole or in part of one or more private networks and communicatively couples the guide systems, the resource systems, the reference user systems and the user systems with the other components of the system 1400 such as the search system 1430, and the database 1420. The network 1415 may allow communication using wired and/or wireless communication systems.

The search system 1430 allows interaction to occur among the guide systems 1405, 1410, the reference user systems 1445, 1450, the resource 1455 and the user systems 1435, 1440. For example, an information search query can be transmitted from the user system 1435 to the search system 1430, where a search query can be accessed by the guide system 1405. A guide operating the guide system 1405 might submit a request to the resource 1455 to obtain a search result. The search result might be provided to the search system 1430, where it may be stored in the database 1420 and provided to the user system 1435. Similarly, a search result produced from the resource system 1455 using the guide systems 1410 in response to a search query submitted by the reference user system 1445 may be transmitted to the search system 1430, where it may be stored by the search system 1430 and/or may be transmitted to the user system 1440.

The search system 1430 may include a gateway for voice communication and a speech-to-text system or other transcription device and/or personnel to facilitate access to the search system via voice communications such as through a land line phone, cellular phone, Voice over Internet Protocol (VoIP) and/or other telephonic device. Any device which may be used to communicate using voice (speech) may be a user system, a searcher or guide system and/or a reference user system.

The search system 1430 may include hardware and/or software interface to a system which provides communication services such as Instant Messaging (IM), email, Short Messaging Service (SMS), Enhanced Messaging Service (EMS), Multimedia Messaging Service (MMS), and/or other forms of messaging services. Any device which may communicate using such services may be a user system, a reference user system and/or a searcher system within the scope of the disclosure herein. A request may be submitted to the search system 1430 using any or all communication services which are able to communicate with the search system 1430.

Although the search system 1430 is illustrated as a single system, the search system 1430 may include any number of hardware systems, which may function as servers or other elements. For example, a server functionality associated with any of the communication services identified herein above may be implemented to allow messages to be transmitted between the elements of the system 1400. Any suitable computer hardware which is well known in the art may be used to implement the search system 1430. For example, server systems provided by Dell such as the Dell PowerEdge™ M805, or by IBM such as the x3500 server system may be used to implement any or all server functionalities of the system 1400. Operating systems well known in the art such as Microsoft Windows Vista®, Redhat Linux, etc., may be used to implement the search system 1430 and/or other elements of the system 1400.

The search system 1430 is communicatively coupled with the database 1420. As will be described herein in further detail below, the database 1420 includes persistent data or information storage that is processed in association with operation of the embodiments. Although FIG. 14 illustrates the database 1420 as a separate component of the system, the database 1420 may be integrated with the search system 1430. Further, the records maintained in the database 1420 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 1420 may reside in any suitable elements of the system 1400. Any type of memory device may be used to record information indicated in the database 1420. For example, magnetic data storage such as magnetic tape or disks, optical storage such as CD-ROM, DVD ROM, and/or semiconductor storage such as FLASH, SRAM, or DRAM devices may be used to record information of the database 1420.

The user systems 1435, 1440, the reference user systems 1445, 1450, the guide systems 1405, 1410, the search system 1430 and the resource 1455 may include equipment and/or personnel required to send and/or receive messages between a user system, a guide system, a reference user system, a resource system and/or the search system using the network 1415. The database 1420 includes information which may allow the search system 1430 to establish communication between the other elements of the system 1400.

A user system, a reference user system, a guide system, and/or a resource system may be a desktop or portable PC or Mac®, a mobile phone, a smart phone, a PDA, a server system, a landline phone, a specialized communication terminal, a terminal connected to a mainframe, or any other communication device. After being presented with the disclosure herein, one of ordinary skill in the relevant art will immediately realize that any viable computer system or communication device known in the art may be used as user systems, reference user systems, guide systems, resource systems, and/or to implement the search system 1430.

A guide may be required to register with the search system 1430. As part of a registration process, at least one communication method is associated with a guide. In at least one embodiment, a guide may register with the search system 1430 and establish a username and password which are associated with the guide. A guide may login to the search system 1430 using a web browser functionality of a guide system in order to communicate with the search system 1430. Multiple communication services may be associated with a guide and may allow a communication session to be established between a guide system such as the guide system 1405 and a user system, a resource system and/or the search system 1430. Multiple identifiers of a guide may be associated with each other. Information such as IM credential, an email address, a phone number, a URL, a username, etc., of a guide may be identified which may allow the search system 1430 to establish a communication session between a guide system and a user system, a resource system, and/or the search system 1430.

When a guide registers with the search system 1430, the guide may be associated with one or more keywords, categories, and/or other information. For example, a keyword or category may be selected by a guide, or may be associated with a guide based on a test administered to a guide and/or other information provided during and/or after a registration process. In at least one embodiment, a guide is required to provide information of age, gender, location, areas of interest, education, political affiliations, musical and cultural interests. Characteristics or parameters of a guide may be obtained before, during or after registration. Information associated with a guide may be stored in the database 1420 and may be used for purposes such as matching a guide to a user request, determining and/or providing compensation for a guide, communicating with a guide, etc., as will be described further herein below.

A user may be identified by the search system 1430. When a user system such as the user system 1435 establishes a communication session with the search system 1430, an identifier of a user system is determined. An identifier of a user system may be associated with other information regarding a user. A user system may be identified using an email address, a telephone number, an IM credential, a username, and/or other identifier which may be used to associate information with a user. Multiple identifiers of a user may be associated with each other. Using information of a communication service associated with a user, a communication session may be established between a user system such as the user system 1435 and a guide system, a resource system and/or the search system 1430. Information such as a keyword, a category, a user profile, a previous search request, a result, etc., may be associated with a user. Information of a user may be stored in the database 1420.

A reference user may be identified by the search system 1430. When a reference user system such as the reference user system 1445 establishes a communication session with the search system 1430, an identifier of a reference user system is determined. An identifier of a reference user system may be associated with other information regarding a user. A reference user system may be identified using an email address, a telephone number, an IM credential, a username, and/or other identifier which may be used to associate information with a user. Multiple identifiers of a reference user may be associated with each other. Using information of a communication service associated with a user, a communication session may be established between a reference user system, such as the reference user system 1445, and a guide system, a resource system and/or the search system 1430. Information such as a keyword, a category, a reference user profile, a previous search request, a result, etc., may be associated with a user. Information of a reference user may be stored in the database 1420. In at least one embodiment, a reference user may provide verified information of characteristics associated with the reference user.

A resource, which may be a person, an entity, a search engine, a database, a software application, a corpus of one or more types of media such as text or printed information, images, audio, video, etc., or a combination thereof, may be identified by the search system 1430. Information of at least one method of communication is associated with a resource system which allows a communication session to be established between the search system 1430, a user system 1435, 1440, a reference user system 1445, 1450, and/or a guide system 1405, 1410, and a resource system such as the resource 1455. An identifier of a resource system may be associated with other information regarding a resource. A resource system may be identified using an email address, a telephone number, an IM credential, a resource username, a URL or other persistent identifier, which may be used to associate information with a resource. Multiple identifiers of a resource may be associated with each other. Using the information of communication services associated with a resource, a communication session may be established between a resource system such as the resource 1455 and a user system, a guide system, and/or the search system 1430. Information such as a keyword, a category, a profile, or other information may be associated with a resource. Information of a resource may be stored in the database 1420.

A resource may be freely accessible to any user and/or guide and/or may be available on a restricted basis. A resource may not be accessible using the network 1415, but may be accessible to a guide. For example, a resource, such as the resource 1455, may be accessible to one or more guides operating a guide system such as the guide system 1405 using any type of communication. A guide may obtain information of an event to provide a result. Information in any form, such as printed media, audio and/or visual information, software, hardware, etc., which may be accessible to a guide, a user and/or an operator of a private database system may be a resource.

The search system 1430 may establish a communication session between any user system, guide system, or reference user system using information indicated in the database 1420. For example, the user system 1435 may establish a voice communication session with the search system 1430, the search system 1430 may establish a voice communication session between the user system 1435 and the guide system 1405, and the search system 1430 may establish a voice communication session between the user system 1435 and the resource 1455. While a voice communication session is used in this example, any type of communication session using one or more services such as SMS, EMS, MMS, email, IM, chat, web based communication, etc., may be established between any user system, guide system, and/or resource system and/or the search system 1430.

Information associated with a user, a guide and/or a resource may be obtained in various ways. For example, a registration process may be performed using a web form provided by the search system 1430, and/or information may be obtained from an external database, and/or information may be obtained based on analysis of information indicated by a user, a guide, and/or a resource.

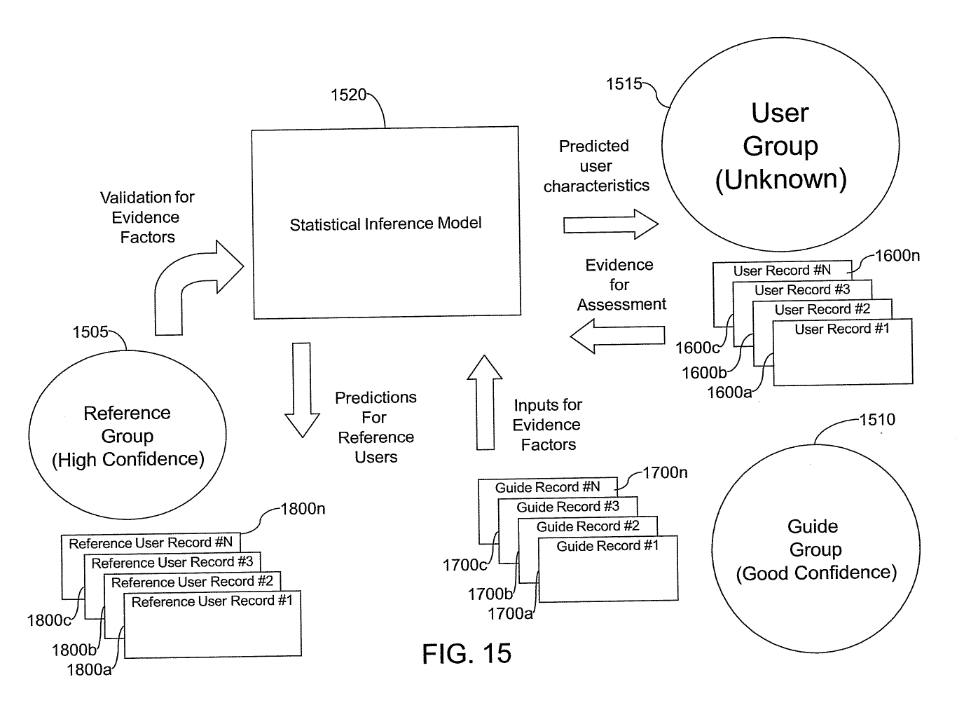

FIG. 15 illustrates construction of a prediction model based on a Bayesian analysis technique. A guide group 1510 is a group of human guides who have been selected to generate a prediction model for a characteristic. Members of the guide group 1510 are associated with a guide record such as the guide records 1700a, 1700b, 1700c, and 1700n. Any number of guides may be included in the guide group 1510. Content of an exemplary guide record is further illustrated herein with respect to FIG. 17. A guide record may include information of search-related activities and/or other items which may be associated with a guide. In at least one embodiment, records of search requests associated with a guide are indicated in the guide records 1700a-1700n. Query records of queries associated with a guide may be associated with one or more characteristics of the guide.

For example, if a guide is male, evidence associated with the guide may be utilized to determine a factor to be utilized in determining whether observing the same evidence associated with a user is an indicator that the user is male. Evidence such as keywords of queries, categorization of queries, responses to advertisements, messages, incentives, etc, responses to search results, content of search results, abbreviations used, sentence structure, etc., may be determined and utilized. History of a guide as a user may be analyzed in any suitable manner. In at least one embodiment, an identical analysis method is applied to the information of the guide records associated with the members of the guide group 1510 (FIG. 15). The information obtained from the guide records is formulated into a Bayesian factor which includes conditional and marginal probability. For example, if a particular keyword appeared only in queries asked by male guides, and the keyword appeared in 10% of total queries, it would be likely that a user who used that keyword would be male. A statistical inference model 1520 would typically contain hundreds or thousands of factors such as this, depending on the size of the guide pool 1510 and the type of characteristic or parameter to be determined. In at least one embodiment, a guide may be selected as a member of the guide group 1510 based on a number of requests associated with the guide.

A reference group 1505 is provided in order to validate the predictions of the statistical inference model 1520 which has been constructed based on factors associated with the guide group 1510. The members of the reference group 1505 are associated with reference user records 1800a, 1800b, 1800c, and 1800n. Any number of reference users may be included in the reference group 1505. In a preferred embodiment, the reference group 1505 is approximately one percent the size of the guide group 1510. To validate the statistical inference model 1520, the characteristic prediction model is applied to the processed information of the reference user records 1800. If the predictions are correct, it indicates a favorable rating of the inference model 1520, if not it may indicate an unfavorable rating. In such an instance, the statistical inference model 1520 may be modified, adapted, etc. by adding and/or removing guides from the guide group 1510 when generating a revised model. This may be done by a person, and/or algorithmically. For example, a number of guides may be removed from the guide group 1510, a new model may be constructed and compared to the expected results from the reference users, and a determination made as to whether the guides removed have adversely or positively impacted accuracy of the predictions made by the new model compared to the previous model.

A user group 1515 is an arbitrary size group of users. The users in the user group are associated with user records 1600a, 1600b, 1600c, and 1600n. Information in the user records 1600a, 1600b, 1600c, 1600n, is processed according to the algorithm determined by the statistical inference model 1520. A prediction of a user characteristic is determined and prediction values may be recorded in the user record associated with a user, which may be utilized for other purposes such as selection of an item to be associated with a user. While gender has been used as an illustrative characteristic herein above, any type of user characteristic may be predicted. In a practical example, the technique was applied using a reference group of thirty reference users, and eight hundred guides. With some fine-tuning, the system was able to predict the correct gender of a random sample of one hundred users correctly more than seventy-five percent of the time. This increases the correct targeting by almost fifty percent, and ensures consistent rather than random targeting.

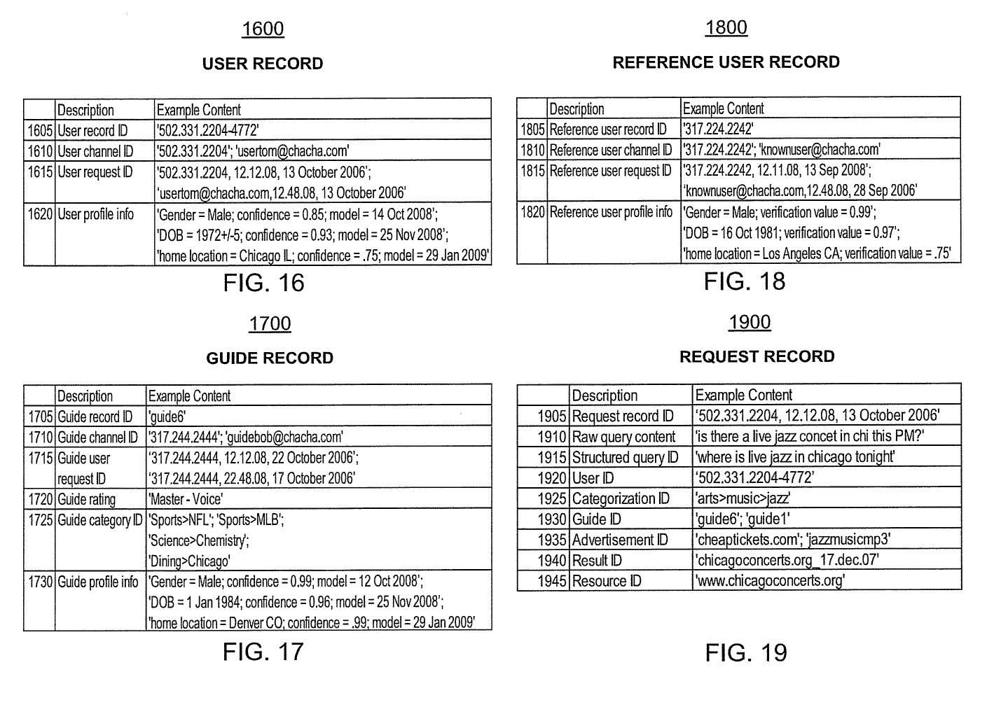

As illustrated in FIG. 16, an exemplary user record 1600 is provided, of which one or more may be associated with or resident in the database 1420 (FIG. 14). The user record 1600 may include a user record identifier (ID) field 1605, a user channel ID field 1610, a user request ID field 1615, and a user profile info field 1620.

The user record ID field 1605 may include an identifier of a user, which is preferably unique and preferably used consistently. For example, in at least one embodiment, the user record ID field 1605 can include a randomly generated numerical code, and/or a string indicating a user. A user record ID serves to distinguish a user record associated with a user from a user record associated with other user. Although particular examples of identifiers are described herein, other types of identifiers uniquely indicating a user may be utilized without departing from the spirit and scope of the embodiments. In at least one embodiment, a telephone number associated with a mobile phone service account may be included in the content of the user record ID field 1605. A user record ID may include a username, an IM credential, an email address, a URL, an IP address, etc. Using the example in FIG. 16, ‘502.331.2204-4772’ is the user record ID associated with the user record 1600.

The user channel ID field 1610 may include one or more identifiers associated with a user. The user channel ID field 1610 may include one or more identifiers of a user and/or other information which may be used to establish communication with a user system. For example, a telephone number, an email address, an IM credential, a username, a URL, a street address, and/or other information which may allow communication to be established with a user may be included in the user channel ID field 1610. Using the example in FIG. 16, the telephone number ‘502.331.2204’ and the email address ‘usertom@chacha.com’ have been associated with the user ‘502.331.2204-4772’. While only a few channel identifiers and types of identifiers have been illustrated in FIG. 16, any number and/or type of channel identifiers may be associated with a user.

The user request ID field 1615 may include information of one or more requests associated with a user ID. For example, the user request field 1615 may include a unique identifier associated with a request submitted using a user system associated with any channel identifier associated with a user. Using the example illustrated, the user request ‘502.331.2204, 12.12.08, 13 October 2006’, and the user request ‘usertom@chacha.com, 12.48.08, 13 October 2006’ have been associated with the user record 1600. While only a few request identifiers have been illustrated in FIG. 16, any number of requests may be associated with a user. A request ID may be used to obtain or access or look-up or index a request. An exemplary request record is illustrated in FIG. 19.

The user profile info field 1620 (FIG. 16) may include information of a characteristic of a user. For example, the user profile field 1620 may include demographic, geographic, psychometric, educational, purchase history, area of interest, and/or other characteristics of a user. Information of a user profile may be used for purposes such as selecting a guide, targeting of information of any sort, etc. Using the example in FIG. 16 the ‘Gender=Male’, ‘DOB=1972+/−5’, and ‘home location=Chicago IL’ are associated with the user ‘502.331.2204-4772’. A characteristic or quality may be associated with a confidence factor and/or a model identifier. For example, the confidence factor associated with ‘Gender=Male’ of ‘0.85’ based on the model ‘14 Oct 2008’ may indicate that the calculated probability that ‘502.331.2204-4772’ is male is ‘0.85’ based on the predictions associated with the model ‘14 Oct 2008’.

As illustrated in FIG. 17, an exemplary a guide record 1700 is provided, of which one or more may be associated with or resident in the search database 1420 (FIG. 14). The guide record 1700 (FIG. 17) may include a guide record ID field 1705, a guide channel ID field 1710, a guide user request ID field 1715, a guide rating field 1720, a guide category ID field 1725 and a guide profile information field 1730.

The guide record ID field 1705 contains an identifier of a guide, which is preferably unique and preferably used consistently. For example, in at least one embodiment, the guide record ID field 1705 can include a randomly generated numerical code, and/or a string indicating a guide. A guide record ID serves to distinguish a guide record associated with a guide from a guide record associated with other guides. Although particular examples of identifiers are described herein, other types of identifiers uniquely indicating a guide may be utilized without departing from the spirit and scope of the embodiments. In at least one embodiment, a guide record ID may include a first and last name of a guide. In at least one embodiment, a telephone number associated with a mobile phone service account may be included in the content of the guide record ID field 1705. A guide record ID may include a guide username, an IM credential, an email address, etc. Using the example in FIG. 17, ‘guide6’ is the guide record ID associated with the guide record 1700.

The guide channel ID field 1710 may include one or more identifiers associated with a guide. The guide channel ID field 1710 may include one or more identifiers of a guide and/or other information which may be used to establish communication with a guide. For example, a telephone number, an email address, an IM credential, a username, a password, access information, a URL, a street address, and/or other information which may allow communication to be established with a guide may be included in the guide channel ID field 1710. Using the example in FIG. 17, the telephone number ‘317.244.2444’ and the email address ‘guidebob@chacha.com’ are the guide channel identifiers which have been associated with the guide ‘guide6’. While only a few channel identifiers have been illustrated in FIG. 17, any number of channel identifiers may be associated with a guide.

The guide user request ID field 1715 may include information of one or more search requests submitted by a guide as a user of a search system which are associated with a guide ID. For example, the guide user request ID field 1715 may include a unique identifier associated with a request which has been submitted by a guide using a device or service associated with the guide. Using the example illustrated in FIG. 17, the request ‘317.244.2444, 12.12.08, 22 October 2006’, and the request ‘317.244.2444, 22.48.08, 17 October 2006’ have been associated with the guide ‘guide6’.

The guide rating field 1720 may include information of one or more ratings associated with a guide. Content of the guide rating field 1720 may include one or more ratings of a guide which may be used to select a guide to be assigned to a request. In at least one embodiment, a rating may be associated with a keyword, a category, or other information which has been associated with a request. Any information indicated in the database 1420 (FIG. 14) may be used to determine a rating of a guide. Using the example illustrated in FIG. 17, the rating ‘Master-Voice’ has been associated with the guide ‘guide6’. This may indicate that the guide ‘guide6’ may accept voice based requests and has the rating of ‘Master’ which may influence the probability that ‘guide6’ will be selected to respond to a request. While only one type of rating has been illustrated in FIG. 17, ratings of a guide may be associated with various types of information. For example a guide may have a rating associated with any number of keywords, categories, skills, profiles, users and/or other types of information which may be associated with a guide and/or a request. Any type of information which may indicate a rating such as a number, text, etc., may be included in the guide rating field 1720.

The guide category ID field 1725 may include information of one or more categories associated with a guide. For example, the guide category ID field 1725 may include a unique identifier associated with a category which has been associated with a guide. Using the example illustrated in FIG. 17, ‘Sports>NFL’, ‘Sports>MLB’, ‘Science>Chemistry’ and ‘Dining>Chicago’ have been associated with ‘guide6’. This may indicate that ‘guide6’ has registered to accept requests associated with the categories ‘Sports>NFL’, ‘Sports>MLB’, ‘Science>Chemistry’ and ‘Dining>Chicago’. Such information may be used to select a guide to respond to a request. Categories and/or keywords associated with a guide may be used as factors in a predictive model. For example, if a high percentage of male guides are associated with particular categories and/or keywords, a user who submits queries associated with those categories and/or keywords may be inferred to be more likely to be male.

The guide profile information field 1730 may include information of a characteristic of a guide. For example, the guide profile information field 1730 may include demographic, geographic, psychometric, educational, purchase history, area of interest, and/or other characteristics of a guide. Information of a guide profile may be used for purposes such as selecting a guide, targeting of information of any sort, selecting an item to be presented to the guide, etc. Using the example in FIG. 17 the ‘Gender=Male’, ‘DOB=1 Jan 1984’, and ‘home location=Denver CO’ are associated with ‘guide6’. A characteristic may be associated with a confidence factor and a model identifier. For example, the confidence factor associated with ‘Gender=Male’ of ‘0.99’ based on the model ‘12 Oct 2008’ may indicate that the calculated probability that ‘guide6’ is male is 99% based on a prediction associated with the model ‘12 Oct 2008’. For example, if the information of ‘guide6’ being ‘Male’ is applied to the model 12 October 2008 and the verification of reference users based on predictions associated with the information of ‘guide6’ is high, the confidence factor associated with the ‘Male’ characteristic of ‘guide6’ may increase. Likewise, if the verification associated with ‘guide6’ is low, the confidence factor may decrease. Using this technique, automated and/or human assisted adjustment of a guide pool employed by a predictive model or algorithm may be provided.

As illustrated in FIG. 18, an exemplary reference user record 1800 is provided, of which one or more may be associated with or resident in the database 1420 (FIG. 14). The reference user record 1800 may include a reference user record ID field 1805, a reference user channel ID field 1810, a reference user request ID field 1815, and a reference user profile field 1820.

The reference user record ID field 1805 may include an identifier of a reference user, which is preferably unique and preferably used consistently. For example, in at least one embodiment, the reference user record ID field 1805 can include a randomly generated numerical code, and/or a string indicating a reference user. A reference user record ID serves to distinguish a reference user record associated with a reference user from a reference user record associated with other reference users. Although particular examples of identifiers are described herein, other types of identifiers uniquely indicating a reference user may be utilized without departing from the spirit and scope of the embodiments. In at least one embodiment, a telephone number associated with a mobile phone service account may be included in the content of the reference user record ID field 1805. A reference user record ID may include a reference username, an IM credential, an email address, a URL, an IP address, etc. Using the example in FIG. 18, ‘317.224.2242’ is the reference user record ID associated with the reference user record 1800.

The reference user channel ID field 1810 may include one or more identifiers associated with a reference user. The reference user channel ID field 1810 may include one or more identifiers of a reference user and/or other information which may be used to establish communication with a reference user system. For example, a telephone number, an email address, an IM credential, a reference username, a URL, a street address, and/or other information which may allow communication to be established with a reference user may be included in the reference user channel identifier field 1810. Using the example in FIG. 18, the telephone number ‘317.224.2242’ and the email address ‘knownuser@chacha.com’ have been associated with the reference user ‘317.224.2242’. While only a few channel identifiers and types of identifiers have been illustrated in FIG. 18, any number and/or type of channel identifiers may be associated with a reference user.

The reference user request ID field 1815 may include information of one or more requests associated with a reference user identifier. For example, the reference user request ID field 1815 may include a unique identifier associated with a request submitted using a reference user system associated with any channel identifier associated with a reference user. Using the example illustrated, the request ID ‘317.224.2242, 12.11.08, 13 Sep 2008’, and the request ID ‘knownuser@chacha.com, 12.48.08, 28 Sep 2006’ have been associated with the reference user ‘317.224.2242’. While only a few request identifiers have been illustrated in FIG. 18, any number of requests may be associated with a reference user.

The reference user profile info field 1820 may include information of a characteristic of a reference user. For example, the reference user profile info field 1820 may include demographic, geographic, psychometric, educational, purchase history, area of interest, and/or other characteristics of a reference user. Information of a reference user profile may be used for purposes such as selecting a guide, targeting of information of any sort, verification of predicted characteristics, etc. Using the example in FIG. 18, the ‘Gender=Male’, ‘DOB=16 Oct 1981, and ‘home location=Los Angeles CA’ are associated with the reference user ‘317.224.2242’. A characteristic may be associated with a verification value. For example, the verification value associated with ‘Gender=Male’ of ‘0.99’ may indicate that a user characteristic is confirmed 99% of the time by an aggregate of prediction models. Such information may be utilized to modify information of a reference user which may be used for verification purposes. For example, if a particular query or a particular category of queries adversely affects verification of a confirmed characteristic of a user, the query or category of queries may be ignored during verification of a model. This may be used to determine how known information of a reference user may be employed in the construction and/or adaptation of a predictive model.

As illustrated in FIG. 19, an exemplary request record 1900 is provided, of which one or more may be associated with or resident in the search database 1420 (FIG. 14). The request record 1900 (FIG. 19) may include a request record ID field 1905, a raw query content field 1910, a structured query ID field 1915, a user ID field 1920, a categorization ID field 1925, a guide ID field 1930, an advertisement ID field 1935, a result ID field 1940, and a resource ID field 1945.

The request record ID field 1905 may include an ID of a request, which is unique and used consistently in at least one embodiment. In at least one embodiment, the request record ID field 1905 can include a randomly generated numerical code, and/or a string indicating a request. A request record ID serves to distinguish a request record associated with a request from a request record associated with other requests. Although particular examples of IDs are described herein, other types of IDs uniquely indicating a request may be utilized without departing from the spirit and scope of the embodiments herein. In at least one embodiment, the request record ID includes a text string indicating content of a request. A request record ID may include a username, an IM credential, an email address, etc. Using the example in FIG. 19, ‘502.331.2204, 12.12.08, 13 October 2006’ is the request record ID associated with the request record 1900.

The raw query content field 1910 may include information of a raw query associated with a request. For example, text provided by a user, an audio recording of a spoken query, an image, a video, and/or any other information indicated in a request submitted to the search system may be indicated in the raw query content field 1910. In at least one embodiment, text of a query submitted by a user is indicated in the raw query content field 1910. Using the example in FIG. 19 ‘is there a live jazz concert in chi this PM?’ is the content of the raw query associated with the request ‘502.331.2204, 12.12.08, 13 October 2006’.

The structured query ID field 1915 may include an ID of a number of structured queries associated with a request. A structured query may be constructed by a user and/or a guide. For example, a guide and/or an algorithm may select or determine a structured query based on a raw query. Using the example in FIG. 19, ‘where is live jazz in chicago tonight’ is the structured query ID associated with the request record 1900. This may indicate that ‘where is live jazz in chicago tonight’ is a structured query selected by a guide responsive to the request ‘502.331.2204, 12.12.08, 13 October 2006’.

The user ID field 1920 may include an ID of a user who submitted a request. Content of the user ID field 1920 may be used to obtain information of a user based on content of a user record such as the user record 1600 (FIG. 16). Using the example in FIG. 19, the user ID ‘−502.331.2204-4772’ is associated with the request ‘502.331.2204, 12.12.08, 13 October 2006’, which may indicate that the user ‘502.331.2204-4772’ submitted the request ‘502.331.2204, 12.12.08, 13 October 2006’, and may be presented with an item such as a result identified in the result ID field 1940 and/or an advertisement indicated in the advertisement ID field 1935.

The categorization ID field 1925 may include an ID of one or more categorizations, which are associated with a request. A categorization may be associated with a request by a user, a guide, and/or automatically. Using the example in FIG. 19, ‘arts>music>jazz’ is the categorization ID associated with the request ‘502.331.2204, 12.12.08, 13 October 2006’.

The guide ID field 1930 may include information of one or more guides associated with a request. Content of the guide ID field 630 may be used to obtain information of a guide based on content of a guide record such as the guide record 1700 (FIG. 17). Using the example illustrated in FIG. 19, the guides ‘guide6’, and ‘guide1’ have been associated with the request record 1900, which may indicate that ‘guide6’, and ‘guide1’ have been selected to respond to the request ‘502.331.2204, 12.12.08, 13 October 2006’.

The advertisement ID field 1935 may include information of one or more advertisements associated with a request. Content of the advertisement ID field 1935 may be used to present an advertisement to a user. Using the example illustrated in FIG. 19, the advertisements ‘cheaptickets.com’, and ‘jazzmusicmp3’ have been associated with the request record 1900, which may indicate that ‘cheaptickets.com’, and ‘jazzmusicmp3’ have been selected to be provided to a user responsive to the request ‘502.331.2204, 12.12.08, 13 October 2006’.

The result ID field 1940 may include information of one or more results associated with a request. Content of the result ID field 1940 may be used to indicate a result chosen, identified, or provided responsive to a request. For example a highest ranked result, or a result created or identified by a guide might be indicated in the result ID field 1940. Using the example illustrated in FIG. 19, the result ‘chicagoconcerts.org_17.dec.07’ has been associated with the request record 600. This may indicate that the result ‘chicagoconcerts.org_17.dec.07’ has been selected to be provided responsive to the request ‘502.331.2204, 12.12.08, 13 October 2006’.

The resource ID field 1945 may include information of one or more resources associated with a request. Content of the resource ID field 1945 may be used to indicate a resource associated with a request. Using the example illustrated in FIG. 19, the resource ‘www.chicagoconcerts.org’ has been associated with the request record 1900. This may indicate that the resource ‘chicagoconcerts.org’ has been selected to be provided responsive to the request ‘502.331.2204, 12.12.08, 13 October 2006’. A resource may be provided to a user and/or a guide. For example, a guide may be provided with access to ‘www.chicagoconcerts.org’ if the guide is selected to respond to the request ‘502.331.2204, 12.12.08, 13 October 2006’.

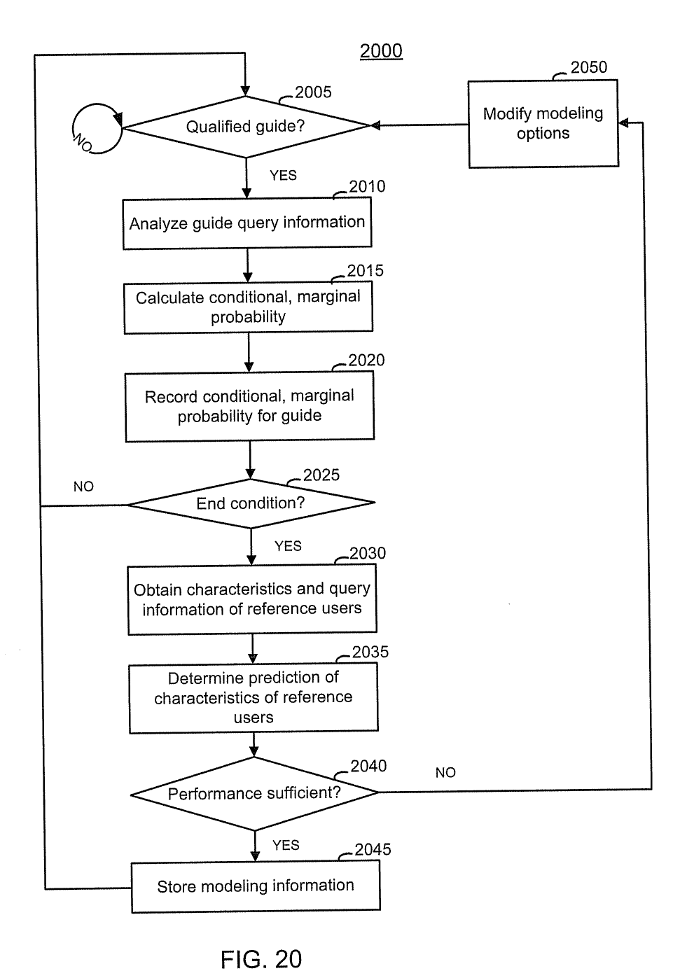

As illustrated in FIG. 20, a process 2000 for creating a prediction model is provided. The process 2000 may be operative on any suitable element of the system 1400 (FIG. 14). In at least one embodiment, the process is operative on the search system 1430, and the parameters of the model are stored in the database 1420.

In operation 2005 (FIG. 20), a determination is made as to whether a guide is qualified. If in operation 2005 it is determined that a guide is not qualified, control remains at operation 2005 and process 2000 continues to wait. If in operation 2005 it is determined that a guide is qualified, control is passed to operation 2010 and process 2000 continues.

The determination in operation 2005 may be made based on various criteria. For example, a number of queries associated with a guide may be examined to determine whether a guide is qualified. A guide may be qualified to be used in constructing a particular prediction model, but not qualified for constructing other prediction models. For example, a prediction of gender may be based at least in part on persons of a similar age group, or a prediction of dining preference might be based at least in part on persons requesting dining information at least two times per week, etc. Any suitable criteria for determining if a guide is qualified to be used in a prediction model may be utilized. Criteria for selection may be based on statistical sampling techniques which are well known in the relevant art.

In operation 2010, query information of a guide is analyzed. Analysis of queries or requests may be based on various criteria. For example, guide queries may be parsed to determine a keyword, key phrase, category, named entities, time of day, advertisement response, resource used, guide, device, and/or other information associated with a query of a guide. Control is passed to operation 2015 and process 2000 continues.

In operation 2015, conditional and marginal probability associated with information obtained from query analysis is calculated. Any number of evidence factors which may be identified for a particular prediction model may be determined. Evidence factors may be related to any of the analysis variables identified. For example, if a particular category is associated with a guide query, a conditional and marginal probability for that category associated with a number of characteristics associated with the guide may be calculated, adjusted, modified and/or updated. Accumulation of evidence from a pool of guides may modify conditional and marginal probabilities, and may modify the presumptions of orthogonality, independence, correlation, etc. of evidence vectors utilized in a model. Control is passed to operation 2020 and process 2000 continues.

In operation 2020, conditional and marginal probability information associated with a guide is recorded. For example, a record of change in prediction or probability functions caused by information associated with a guide may be recorded in a record such as the guide record 1700 (FIG. 17). Information of probability functions associated with a guide may be utilized for various purposes. In at least one embodiment, if a guide is an outlier compared to other guides, a modification of a predictor function based on information of the guide may be removed from the model. Control is passed to operation 2025 (FIG. 20) and process 2000 continues.

In operation 2025, a determination is made as to whether an end condition is detected. If in operation 2025, it is determined that an end condition is not detected, control is passed to operation 2005 and process 2000 continues. If in operation 2025 it is determined that an end condition is detected, control is passed to operation 2030 and process 2000 continues.

The determination in operation 2025 may be made based on various criteria. For example, if a last guide in a pool of available guides is evaluated, or if a number of guides evaluated exceeds a value, or if a confidence level associated with a change in marginal probability and/or conditional probability of a characteristic is met, it may be determined that an end condition is detected. The determination in operation 2025 may be made automatically and/or using the assistance of a person.

In operation 2030 characteristics and query information associated with reference users is obtained. For example, information of queries and characteristics of reference users indicated in a record such as the reference user record 1800 (FIG. 18) is obtained. Control is passed to operation 2035 (FIG. 20) and process 2000 continues.

In operation 2035, a predicted value of a characteristic is determined for a reference user. A reference user may be evaluated to determine whether a valid prediction may be made based on content of evidence information which is computed for query information of the reference user. A confidence value associated with a reference user may be evaluated. For example, if a reference user has an expanded and/or modified query history, this may affect a confidence factor associated with a characteristic of the reference user. Any suitable algorithm may be used to determine a predicted value of a characteristic for a reference user. Control is passed to operation 2040 and process 2000 continues.

In operation 2040, a determination is made as to whether performance of a prediction model is sufficient. If in operation 2040 it is determined that performance of a prediction model is sufficient, control is passed to operation 2045 and process 2000 continues. If in operation 2040 it is determined that performance of a prediction model is not sufficient, control is passed to operation 2050 and process 2000 continues.

The determination in operation 2040 may be made based on various criteria. For example, if a predicted value of a characteristic of a reference user matches the actual value of a characteristic of a reference user more than a target percentage of the time, it may be determined that performance of a prediction model is sufficient. Similarly, if a prediction model is able to make a sufficiently accurate prediction of a characteristic of a reference user based on a threshold number of related queries, it may be determined that the performance of the prediction model is sufficient. The determination in operation 2040 may be made automatically and/or using the assistance of a person.

In operation 2045, modeling information is stored. In at least one embodiment, evidence vectors which may include conditional and marginal probability are stored in the database 1420 (FIG. 14). Modeling information may be stored in any suitable form. A reference ID may be assigned to a prediction model, which may be associated with a prediction of a characteristic of a user as further described herein. Control is passed to operation 2005 and process 2000 continues.

In operation 2050, modeling options are modified. In at least one embodiment, prediction information determined employing information of reference users may be used to perform a modification of a model. For example, if information associated with a guide and a characteristic is an incorrect predictor of the characteristic a high percentage of the time, information associated with the guide and/or the characteristic may be removed from the modeling. Alternately, a threshold for prediction of a characteristic may be modified, or a confidence factor associated with a guide may be adjusted, or a demographic of a reference user group may be modified, or a number of queries, an age of queries, etc., of the guide group and/or the reference user group may be modified. A modeling option may be modified automatically and/or using the assistance of a person. Control is passed to operation 2005 and process 2000 continues.

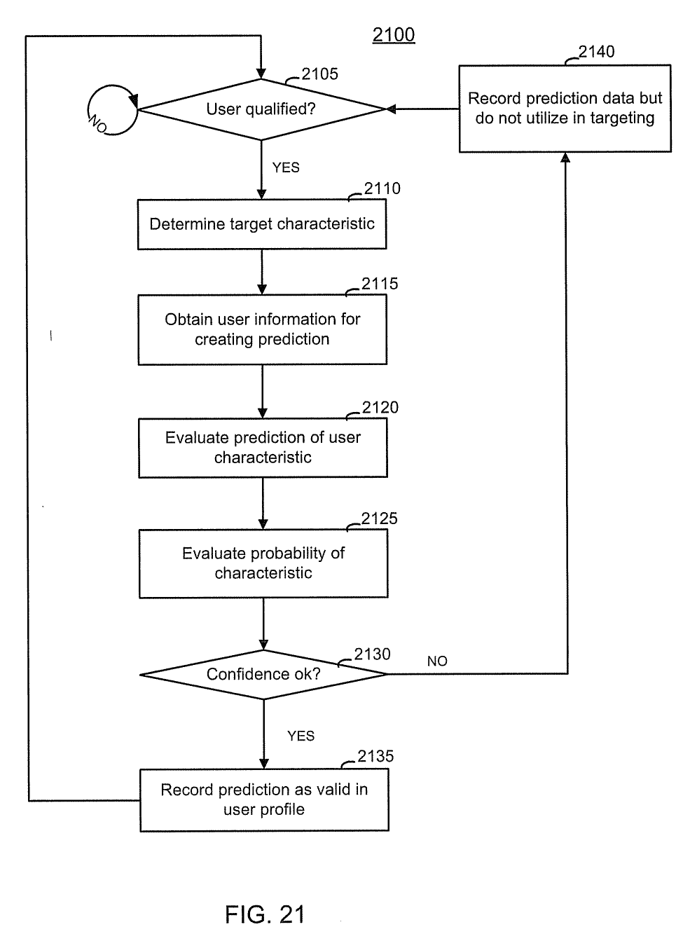

As illustrated in FIG. 21, a process 2100 for predicting a characteristic of a user associated with a prediction model is provided. The process 2100 may be operative on any suitable element of the system 1400 (FIG. 14). In at least one embodiment, the process is operative on the search system 1430, and the results are stored in the database 1420.

In operation 2105 (FIG. 21) a determination is made as to whether a user is qualified. If in operation 2105 it is determined that a user is not qualified, control remains at operation 2105 and process 2100 continues. If in operation 2105 it is determined that a user is qualified, control is passed to operation 2110 and process 2100 continues.

The determination in operation 2105 may be made based on various criteria. For example, a number of queries associated with a user may be examined to determine whether a user is qualified. A user characteristic may be qualified to be predicted with a particular prediction model, but not qualified for other prediction models. For example, a prediction of gender may be based at least in part on a model associated with guides of a particular age, or a prediction of music preference might be constrained to users who have purchased a ring-tone, etc. In at least one embodiment, the presence of characteristics which are verified and/or provided by a user may affect whether a user is qualified. For example, if a user has provided gender information, it may be determined that age information regarding the user may be inferred using a prediction model. Any suitable criteria for determining if a user is qualified to be evaluated using a prediction model may be utilized. Criteria for selection may be based on statistical sampling techniques which are well known in the relevant art.

In operation 2110, a target characteristic is determined. For example, a characteristic which is associated with a qualification of a user may be selected. A characteristic may be determined based on information of prediction models available. For example, if age and gender of a user have been predicted, a parameter such as marital status might be selected. Control is passed to operation 2115 and process 2100 continues.

In operation 2115, information of a user is analyzed to create a prediction. Analysis of queries, etc. of a user may be based on various criteria. For example, user queries may be parsed to determine a keyword, key phrase, category, named entities, time of day, advertisement response, resource used, user, device, an/or other information associated with a query of a user. A characteristic provided from any source may affect a prediction. Previous predictions of user characteristics may be utilized. For example, a prediction of a characteristic associated with a previous prediction model may be stored in association with a user, and may be obtained. Further, reaction or lack thereof of a user relative to data presented to the user may be used to obtain information for creating prediction. For example, information that a user interacted with an advertisement relating to a particular sport may be obtained to create prediction. Control is passed to operation 2120 and process 2100 continues.

In operation 2120, a predicted value of a user characteristic is evaluated. For example, any prediction elements which are aligned with prediction elements associated with a user may be utilized to determine a predicted value of a user characteristic. Similarly, a stored value of a predicted characteristic of a user may be utilized to determine a modified prediction of a characteristic of a user. For example, if a previous value of a prediction has been determined, evidence related to additional queries which have not been evaluated may be used to determine a new prediction of a characteristic. Control is passed to operation 2125 and process 2100 continues.

In operation 2125, a probability value of a user characteristic is evaluated. For example, a probability that a user age falls within a range, or is male, or speaks Spanish, or prefers beer to wine may be evaluated. A probability value may be a ‘fuzzy’ value. For example, a probability that a user is between twenty and fifty years old may be high, while a probability that the user is between thirty and thirty-five years old may be lower. In at least one embodiment, discrete characteristics such as gender may be assigned. Evaluation of a probability function may be performed on the basis of various statistical and/or mathematical techniques which are well known in the relevant art. Control is passed to operation 2130 and process 2100 continues.

In operation 2130, a determination is made as to whether confidence in a characteristic evaluation is acceptable. If in operation 2130 it is determined that confidence in a characteristic evaluation is not acceptable, control is passed to operation 2140 and process 2100 continues. If in operation 2130 it is determined that confidence in a characteristic evaluation is acceptable, control is passed to operation 2135 and process 2100 continues.

The determination in operation 2130 may be made based on various criteria. For example, if a threshold used to evaluate a probability of a characteristic is above a target value, it may be determined that a confidence level in a predicted characteristic is acceptable. Similarly, if a number of evidence values used to evaluate a predicted user characteristic is above a target value, it may be determined that a confidence level in a predicted characteristic is acceptable. Likewise, if a number of evidence values which are misaligned with the final predicted characteristic value exceed a target value, it may be determined that a confidence level in a predicted characteristic is not acceptable. The determination in operation 2130 may be made automatically and/or using the assistance of a person.

In operation 2135 prediction information regarding a user characteristic is stored and is identified as valid for use. In at least one embodiment, prediction information which may include posterior probability, evaluation model, evaluation parameters, and/or other probability information are stored in the database 1420 (FIG. 14). Prediction information may be stored in any suitable form. A reference ID may be assigned to a prediction model which may be associated with a prediction of a characteristic of a user as further described herein. Control is passed to operation 2105 (FIG. 21) and process 2100 continues.

In operation 2140, prediction information regarding a user characteristic is stored. Prediction information of a user characteristic may be identified as being questionable. Questionable information may not be utilized in targeting In at least one embodiment, prediction information which may include posterior probability, evaluation model, evaluation parameters, and/or other probability information are stored in the database 1420 (FIG. 14). Prediction information may be stored in any suitable form. A reference ID may be assigned to a prediction model which may be associated with a prediction of a characteristic of a user as further described herein. Control is passed to operation 2105 (FIG. 21) and process 2100 continues.

Using the process 2100, a predictive model of user characteristics is constructed based on characteristics of a number of guides selected based on various factors. In at least one embodiment, guides are selected based on the presence of a number of queries associated with an identifier of the guides. For example, if a cellular phone associated with a guide login is associated directly and/or indirectly with a number of queries, a guide may be determined to be a suitable member of a group of guides utilized to create a predictive model. Characteristics associated with the pool of guides are used to create a predictive model of characteristics associated with other users. For example, if a particular keyword, category, purchase, time of day, etc., are associated with a characteristic of the guide pool, it may be inferred that that characteristic will also be associated with users that have activities associated with the same keywords, categories, purchases, time factors, etc. Guides used to construct a predictive model may be stratified and/or de-stratified. For example, if a group of guides is sufficiently large and heterogeneous, a model which makes a prediction of user gender based on a limited age group of guides may be constructed. This might make a more accurate prediction than a model based on a homogeneous group of guides.

In mobile applications it is desirable that information such as the location of a device, device status, device capabilities, etc. be made available to services which may utilize the information to initiate, facilitate and/or enhance services provided to a user of a device. However, it is often difficult to have such information readily accessible to services which are not directly controlled by a service provider operating the network associated with a device. In particular, service providers of wireless communication services often require a service wishing to access information such as location, or device features, capabilities, etc. to subscribe to a proprietary service and/or enter into contractual terms with the service provider. These requirements may increase the cost, and reduce the availability and features of a service which may be offered to a user of a mobile device.

In light of this, it is desirable to have a method and system for providing auxiliary information from a mobile device utilizing a service that can be provided over a network or networks without utilizing a network service. In the new system, an application which initiates and implements a service on a mobile device may be downloaded to and/or activated on the mobile device. Once the application is resident in the storage of the mobile device, a user may activate the service. The service may send to and/or receive information independent of the network operator.

In the system, software code which may be available to a user on a Web page, through a communication session, via a message, or which may be otherwise made available or provided to a user may be downloaded to and/or activated on a mobile device and/or other user device or system. Once the software code is resident in the storage of a user device, the software code may be executed to initiate user participation with a service. A service may be activated by a one-time command from a user. The service may initiate the provision of auxiliary information from the user device to the service or other available services. Auxiliary information may include location based information, use based information, information associated with a user, user preferences and/or actions, device information or any other information that may be derived from any hardware, software, communication signals and/or in association with any services operative on the user device including, for example, from hardware such as a GPS receiver resident on the user device, an application running on a user device, etc. Information that may be provided by a user device to a service or derived from the user device by the service may include device specifications, installed applications, operating system, browser type, system capabilities, user preferences, user activities, etc.

In at least one embodiment, the service delivers location based information based on various activities. For example, a voice call, and/or a message such as an instant message, an email, an SMS, MMS, EMS message, etc. from a user device recognized by a service may initiate an action(s) by the service which may deliver information to a service system, a system server, a device, etc. For example, a service may send a Web-based communication via the Internet through Wireless Application Protocol (WAP), GPRS, EDGE, UMTS, etc. to a URL associated with the service, or the service may send an SMS, MMS, EMS or other message to a server or database which may include information regarding the user device or in association with user activities and/or preferences. In this way, a user may be able to receive location-based and/or preference-based services without the requirement of utilizing an ‘in network’ service. Considerations of cost and usage may be applied, such that the use of SMS and/or MMS to transmit and/or receive information may be preferred in the case where a user is able to use unlimited messaging, but is charged for bandwidth used.

A user device may obtain an installer, or other computer-readable information which may be used to implement a service on the user device. For example, the installer may be downloaded from a server of an ‘application store’, or other provider of applications and software which are compatible with a user device. If the user elects to install the service, the software code associated with the service will be operative in the background while applications or other services are active. Because the service is implemented according to a client-server architecture, services running on disparate devices and/or operating systems may be able to provide location information in a standardized format using a common transport protocol.

A user device may provide location information to a server associated with the service which is operative on the user device. Location information may be provided in various ways. For example, if a user device includes a web browser functionality, a TCP/IP formatted message might be transmitted according to the SOAP protocol to a web server. In at least one embodiment, location information may be transmitted as an SMS message. Any service which may be accessible to a user device may be used to transmit location information.

A server may receive messages from a service installed on a user device. A receiving server may be associated with and/or provide information to systems providing information, media, etc. to a user. For example, a server associated with a search service may receive messages transmitted by a service resident on a user device, which may be used to target information, improve performance, enhance user experience, etc.

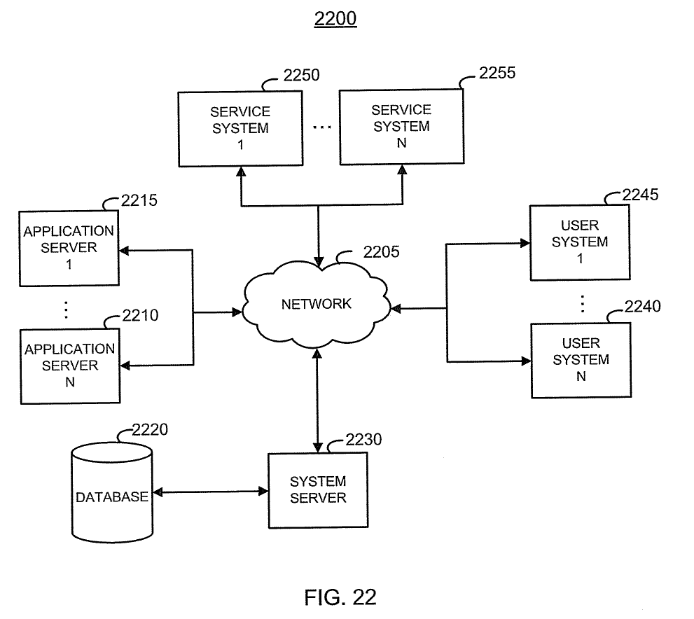

As illustrated in FIG. 22, system 2200 includes a network 2205 such as the Internet, application servers 2210, 2215, a database 2220, a system server 2230, user systems 2240, 2245, and service systems 2250, 2255.

A user system, a service system, an application server and/or a system server may establish a communication session and/or send or receive information using a voice service, a messaging service such as Short Messaging Service (SMS), Enhanced Messaging Service (EMS), Multimedia Messaging Service (MMS), Instant Messaging (IM), email, an Internet portal or Web page, Internet through Wireless Application Protocol (WAP), GPS, 2G, 3G and/or 4G wireless communication standards such as GSM, UMTS, etc., and/or any other type of wired and/or wireless communication. A connection may be established using any device which is capable of utilizing a communication service. For example, a wireless device such as a cell phone, PDA, smart phone, etc., might be used to establish a communication session using voice, SMS, IM, email or Internet browsing. A desktop, laptop or server system might be used to establish a communication session. A specialized communication terminal such as any consumer electronics device or any other communication device might be used to establish a communication session.

The network 2205 may be a global public network of networks (i.e., the Internet) and/or consist in whole or in part of one or more private networks and communicatively couples the service systems, the application servers and the user systems with the other components of the system 2200 such as the system server 2230 and the database 2220. The network 2205 may consist of any wired and/or wireless communication technologies currently available.

A system database 2220 is provided which may include records and/or other data which indicate a user system or device associated with a service, an application or installer, and/or any information associated with a user and/or a user device or system. The system server 2230 allows interaction to occur among the user systems 2240, 2245, the application servers 2210, 2215, and the service systems 2250, 2255. For example, a location message may be transmitted from the user systems 2240, 2245, to the system server 2230, where it may be accessed by the service systems 2250, 2255. Similarly, an application, data, media, and/or any other information from the service systems 2250, 2255, may be transmitted to the system server 2230, where it may be stored by the system server 2230, in the database 2220, and/or may be transmitted to the user systems 2240, 2245.

The system server 2230 is communicatively coupled with the database 2220. The database 2220 includes data that is processed in association with operation of the embodiments. Although FIG. 22 illustrates the database 2220 as a separate component of the system 2200, the database 2220 may be integrated with the server system 2230. Further, the records maintained in the database 2220 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 2220 may reside in any suitable elements of the system 2200.

Any user system (e.g., the user systems 2240, 22245) can be operated by a user, who may be a person, to subscribe to a service, download an application and/or allow information to be sent and/or received through the system server 2230. Any service system (e.g., the service systems 2250, 2255) can be operated by a person, or may alternatively be an automated system, such as a Web service, capable of sending and/or receiving auxiliary information and providing and/or obtaining any data utilizing a user system (e.g., the user systems 2240, 2245). Any application systems (e.g., the application servers 2210, 2215) may be provided and/or maintained by a human provider of an application and/or may be an automated application provider, such as a Web-based application download site, which may provide information or other data to a service system and/or a user system. An application server may provide application data which might include software code, a program, a signal and/or any information accessible to a user, a service, a database, and/or any combination thereof. For example, the application server 2210 might receive information of an installer for a service from the service system 2250, which might subsequently be provided to the user system 2240 based on a user request, which information might be provided to the system server 2230 for future communication with the user system 2240 by the system server 2230.

A user system, a service system, and/or an application server may be a desktop or portable computer, a mobile phone, a smart phone, a personal digital assistant (PDA), a server system, a specialized communication terminal, a work station or a terminal connected to a mainframe, or any other communication device through which data can be sent and/or received. The system server 2230 may include one or more servers, computers, etc. Any suitable computer hardware which is well known in the art may be used to implement the server system 2230. For example, server systems provided by Dell such as the Dell PowerEdge™ M805, or by IBM such as the X3500 server system may be used to implement any or all server functionalities of the system 2200. Operating systems well known in the art, such as Microsoft Windows Vista®, Redhat Linux, etc., may be used to implement the system server 2230 and/or other elements of the system 2200. After being presented with the disclosure herein, one of ordinary skill in the relevant art will immediately realize that any viable computer system or communication device known in the art may be used as user systems, service systems, and application servers to implement the system 2200.

Any number of services may be associated with the service systems 2250, 2255. For example, a communication method may utilize a network, such as the network 2205, which may be a global public network of networks (the Internet) and/or consist in whole or in part of one or more private networks that communicatively couples a user system (e.g., user systems 2240, 2245) with a service system, such as service systems 2250, 2255. A service system may implement a Web service which may provide various functionalities as described in the W3C protocols for Web services. A service system may be accessed by a user system, by a service which is implemented on a user system, by the system server 2230, by an application server, etc. A service system may provide any type of programmatic functions. While the W3C protocol applies to Internet protocols (e.g., HTTP), hardware, software and/or personnel may be provided which allow communication with the service systems 2250, 2255, using communication services such as SMS, MMS, EMS, voice, IM, email and other messaging services as is well known in the art. A service system may publish information of a service associated with the Web service using services such as Universal Description or Discovery and Integration (UDDI). The system server 2230 may act as a service system. A service present on a user device may be able to discover and utilize any services provided by a service system, and may be able to determine information which is to be provided regarding a user device to the services.

A user may access the system server 2230 using a Web browser functionality of the user systems 2240, 2245, or any other network communication method or service in order to communicate with the system server 2230. Multiple communication services may be associated with a user and/or a user device or system and may allow a communication session to be established between a user system such as the user systems 2240, 2245, and a service system, an application server and/or the system server 2230. Multiple identifiers of a user may be associated with each other. Information such as a phone number, a URL, physical location, user device capabilities, etc., associated with a user may be identified which may allow the service systems 2250, 2255 to establish a communication session between a service system and a user system, an application server, and/or the system server 2230.

Information associated with a service may be stored in the database 2220 and may be used for purposes such as communicating with a user system, a service system, an application server, etc., as will be described further herein below.

A user may be identified by or within the system server 2230. If a user system, such as the user system 2240, establishes a communication session with the system server 2230, an identifier of a user system may be determined. An identifier of a user system may be associated with other information associated with a user. A user system may be identified using an email address, a telephone number, user preferences, a username, or other identifier which may be used to associate information with a user and/or a user system or device. Multiple identifiers of a user may be associated with each other. Using information of communication services associated with a user, a communication session may be established between a user system such as the user system 2240 and a service system, an application server and/or the system server 2230. Information of a user may be stored in the database 2220.

The system server 2230 may be able to establish a communication session among any user system, application server and service system using information indicated in the database 2220. For example, the user system 2245 may establish a connection with the system server 2230, and subsequently the system server 2230 may establish a connection between the user system 2245 and a service system such as service system 2255, and/or the service system 2255 may establish a direct connection to the user system 2245. Any type of communication session using one or more communication services such as SMS, EMS, MMS, email, WAP, WiFi, WIMAX, Web-based communication, etc. may be established among any user system, application server, service system and/or the system server 2230.

Information associated with a user, a service and/or an application may be obtained in various ways. For example, a registration or initiation process may be facilitated using a Web form provided by the system server 2230, and/or information may be obtained from an external database, and/or information may be obtained based on analysis of information indicated by a user, a service, and/or an application. Alternatively, any event facilitated by a user system, such as an SMS, EMS, or MMS message, a change in physical location that is relayed as a signal, etc., may be information associated with a user, a user system, a service, and/or an application.

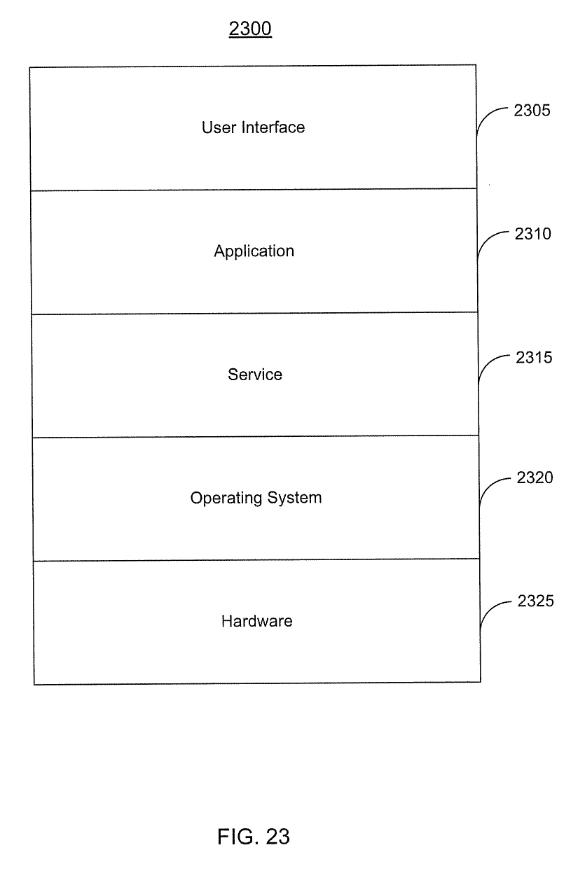

As illustrated in FIG. 23, a diagram of system software architecture 2300 which may be implemented on a user device is provided. The system architecture 2300 provides a user interface layer 2305, an application layer 2310, a service layer 2315, an operating system layer 2320 and a hardware layer 2325. In the user interface layer 2305, a user controllable and/or viewable interface may be provided. A user interface may be provided to a user on a user device that may, for example, be a mobile device without Web-based connectivity and/or text messaging capabilities. In such an example, the user interface layer may or may not provide a visible interface to a user. For example, a mobile communication device without Web-based connectivity may have an application and/or service performing or executing on the device in the registry or internal memory of the device, and might not provide a user interface that is visible to a user. Alternatively, a user device with wireless communication connectivity and/or messaging capabilities may output or receive input of a communication session using a Web-based interface, an SMS, EMS, MMS message, etc., and the Web-based interface and/or the text messaging interface may be used as a tool for receiving input and/or providing additional information and/or data to and from the user device. The user interface layer 2305 may include a messaging or other communicative interface that may be facilitated by any wired and/or wireless communication such as Bluetooth, infrared, and/or any other connectivity available on a user device.

The application layer 2310 may include any application that may be associated with the system server 2230 (FIG. 22), any service system and/or any user system. Multiple applications may be active within the application layer 2310 as permitted by an operating system. An application may be sent or received as an executable file, software code, program, data packet, or any other form of data from a service system, application server, system server, or otherwise to a user device. An application may alternatively be resident on a user system or device or memory storage associated with the user system. An application provided by a service system may include any application capable of initializing, maintaining, facilitating and/or completing a particular service. In at least one embodiment, an application provided as software code may include a one time invitation or authorization condition that may be provided to initiate participation with a service. If a one time initiation executes an application provided by a service system, the service may continue to be associated with and/or active on a user device until the application is removed from a user system and/or discontinued from use. Alternatively, an application may be downloaded to a user device directly through a Web page, by synchronization with another system, etc.

The service layer 2315 (FIG. 23) provides an environment for execution of services which may share information between services and/or applications and the operating system. Software executing in the service layer may not be visible to a user. For example, an SMS message from a user device may be sent to a service system, or a user device may be used to access a secure Web page, send or receive a wireless communication signal, and/or transmit any wired or wireless signal, etc. Software operative in the service layer 2315 may be initialized by execution of any application associated with the application layer 2310. A user device and/or a service system may be associated with a ‘triggering’ application. For example, a service resident on a user device may send an SMS message to a destination designated by the service if a call is placed utilizing the user device. The service may be resident on the user device and may be executed and installed to the memory storage of the user device before participation in a triggering-based service if possible.

In the operating system layer 2320, a user device may run operating system software such as Palm OS, Windows Mobile OS, Symbian, J2ME, etc., or any other available operating system. The operating system that is resident on a user device may determine the type, number, and/or conditions of applications that may be available to a user. The ability of a user device to download and/or install software code, programs, and/or any developed applications via a particular operating system may determine the type, number and/or conditions of services that may be available to a user. For example, a service may run on a particular operating system, a service may require the execution of an application that is compatible with a particular operating system or a service may require an application that utilizes or facilitates a service in connection with a particular operating system that is resident on a user device. An operating system associated with a user device may be active and continually running on any device that is powered and capable of running the operating system. An operating system may be utilized to execute and/or manage any service and/or application associated with participation in a service on a user device. A user device or system with minimal hardware or user interface capabilities may use an operating system to manage an application or service which utilizes an API, plug-in, or other data structure associated with the operating system to facilitate services associated with the user device.

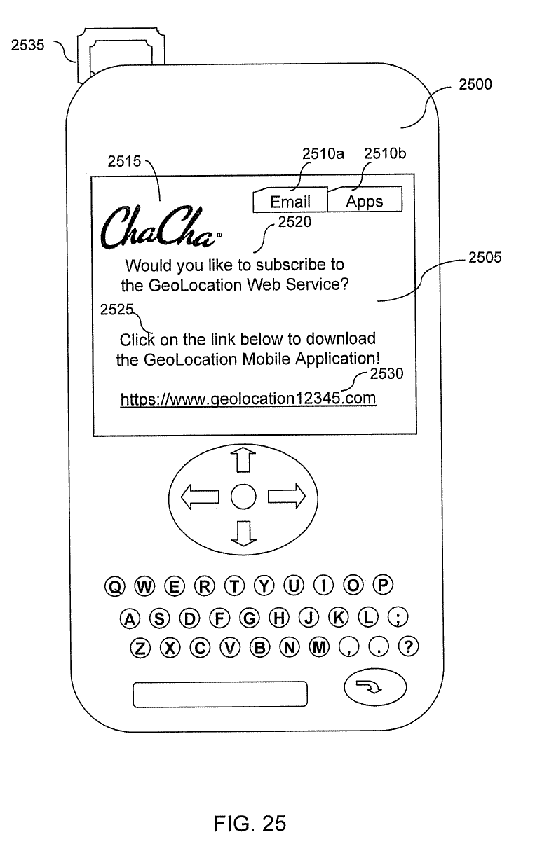

In the hardware layer 2325, a user device or system and associated components are provided. A user device may include a mobile device and any external memory storage systems such as the device and memory storage illustrated in FIG. 25. The hardware layer 2325 may include low-level drivers associated with various devices which may be accessed by the other layers of the software system 2300. A user device may communicate with a service system via any communication carrier or network available to the user device and/or according to any hardware accessories associated with the user device. A network may be the Internet available over WAP, or other mobile communication standards such as GSM, UMTS and/or any other type of mobile communication network standard currently available and/or standards that may be developed. The carrier and/or network that may be utilized in providing a service to a user may be determined by the capabilities of a user device.

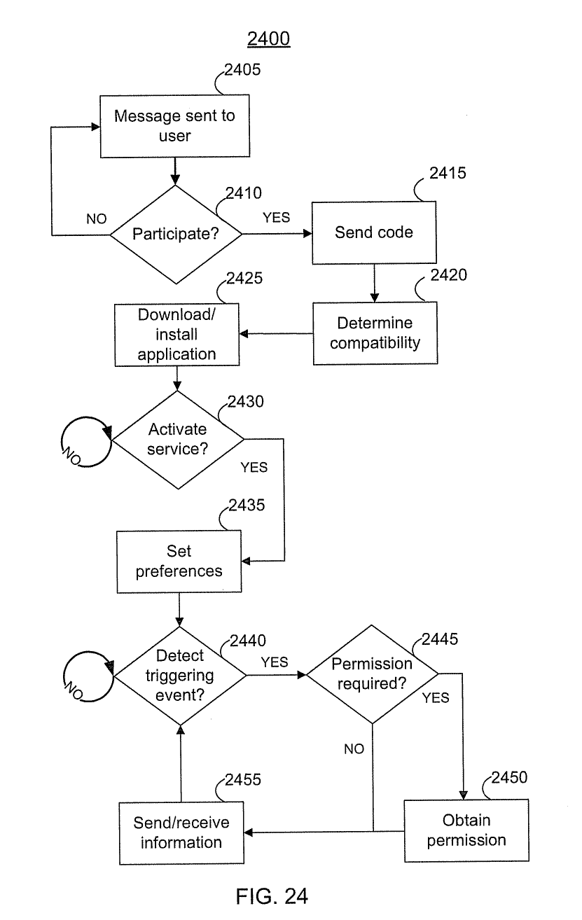

As illustrated in FIG. 24, a process 2400 for initiating and participating in a service is provided. In operation 2405, a message or other communication is sent to a user. In at least one embodiment, a user may receive an SMS message on his or her user device that invites the user to participate in a service. A message such as that illustrated in FIG. 25 and discussed further herein may be sent to a user device. A message may include a hyperlink or other information that a user may utilize to initiate subscription and/or registration with a service, and/or activate and/or accept an application to facilitate a service. A user may receive a message that may allow a user to continue to another message, accept download of an application or execute a file, and/or allow a user to browse to a Web page or external site that provides for the download of an application which can be used in implementing a service associated with a user device. A Web server associated with a web page may detect device specifications and provide an application download that is compatible with the user device hardware, operating system and/or wireless communication network and/or cellular service carrier. If a service does not require software to be downloaded on a user device, a message sent to a user may alternatively provide a way for a user to register for a service, by for example, browsing to a Web form where a user can enter information to sign-up for or initiate the service. A service may also be a continuation or enhancement of a service to which a user currently subscribes. For example, if a user is registered for a service, an invitation message may simply request a user to indicate an affirmative or negative answer in response to an invitation to participate in a service within the service. A user may have the option to send an SMS message directly to the service or system associated with the service to indicate subscription with the service. Control is passed to operation 2410 and process 2400 continues.

In operation 2410, a determination is made as to whether a user has chosen to participate in a service. If in operation 2410 it is determined that a user has chosen to participate in a service, control is passed to operation 2415 and process 2400 continues. If in operation 2410 it is determined that a user has not chosen to participate in a service, control is passed to operation 2405 and process 2400 continues.

The determination of operation 2410 may be based on various factors. For example, a user may send an SMS message in response to an invitation, select a hyperlink included in a message sent to a user device, browse to a Web page based on information or any instructions or directions included in a first communication to a user, etc.

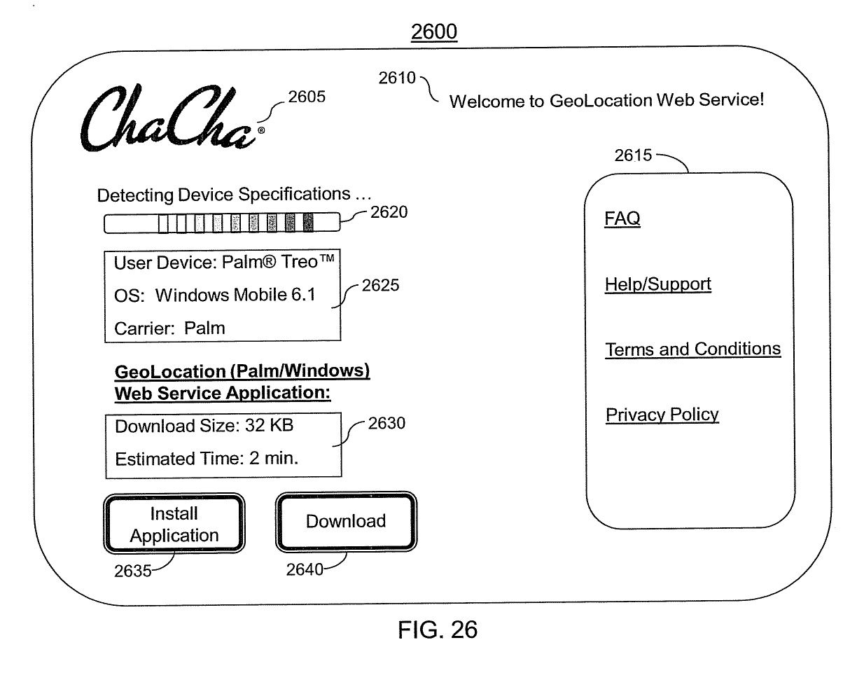

In operation 2415 software is provided to a user device. A data packet, file, software code, or any other program, application or data may be sent or revealed to a user device. For example, if in operation 2410, a user indicates participation in a service, an application, software code, or other data already resident on a user device may be activated. Alternatively, acceptance of participation in a service in operation 2410 may result in a user device or system being provided an application, software code, or other program for download, or being redirected to navigate to where an application, software code, or other program may be downloaded. In at least one embodiment, a browser opened on a user device with Internet access may be directed to a secure Web page and/or may open a GUI such as the GUI 2600 illustrated in FIG. 26. An application or other data packet may be directly downloaded to a user device which may implement a service on the user device, and/or an application or other software code may be downloaded to a user device or system that can store the application until it can be transferred, by for example, syncing a computer system with the user device that will participate in the service. Control is passed to operation 2420 (FIG. 24) and process 2400 continues.

In operation 2420, compatibility of a user device is determined. For example, a service system may identify a user system's device specifications and any other capabilities. If an application sent to a user device is not compatible with the user device, the application may detect device specifications in. An active control may be utilized to access information including any device specifications associated with a user device. Information may include the type of user device, the operation system running on the device, any wireless communication hardware associated with the device and/or the network cellular carrier associated with the user device. The information collected may be used to provide and/or execute an application that may be compatible with the participating user device. Control is passed to operation 2425 and process 2400 continues.

In operation 2425, an application initiating a service is activated. For example, if device capabilities and/or specifications are detected, a user may be given an option to download or indicate acceptance for download of an installation application directly to a user device. In such an example, a user may be sent an MMS message by a source such as a service system, an application server, the system server 2230 (FIG. 22), etc. An application may then implement a service on a user system. Alternatively, a message or other communication, such as an MMS message, may be sent to an intermediate user device or system that may be capable of storing an application download in memory storage of the system until a user is able to transfer, sync, and/or copy the download file to the desired user device. Control is passed to operation 2430 (FIG. 24) and process 2400 continues.

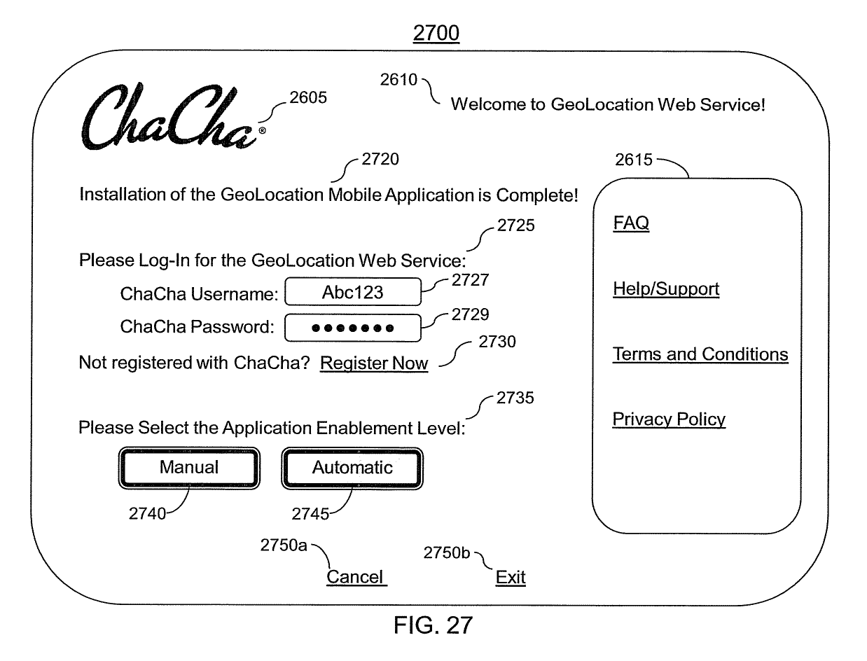

In operation 2430, a determination is made as to whether a user has activated the service. If a user does not activate the service, control remains at operation 2430 and process 2400 continues. If a user activates the service, control is passed to operation 2435 and process 2400 continues. The determination in operation 2430 may be based on various factors. For example, if the installation or activation of an application or execution of a data, software code, or other program is completed in operation 2425, a user may be presented with an option to continue through a service registration process. In at least one embodiment a user may indicate a one-time opt-in to participate in the service by, for example, registering with the service and/or logging-in to a user account already maintained by a service system or the system server 2230 (FIG. 22). Activation of a service may be presented to a user through a Web-based registration form such as the GUI 2700 illustrated in FIG. 27. Alternatively, activation of a service may occur automatically through installation or activation of an application during operation 2425 (FIG. 24). Control is passed to operation 2435 and process 2400 continues.

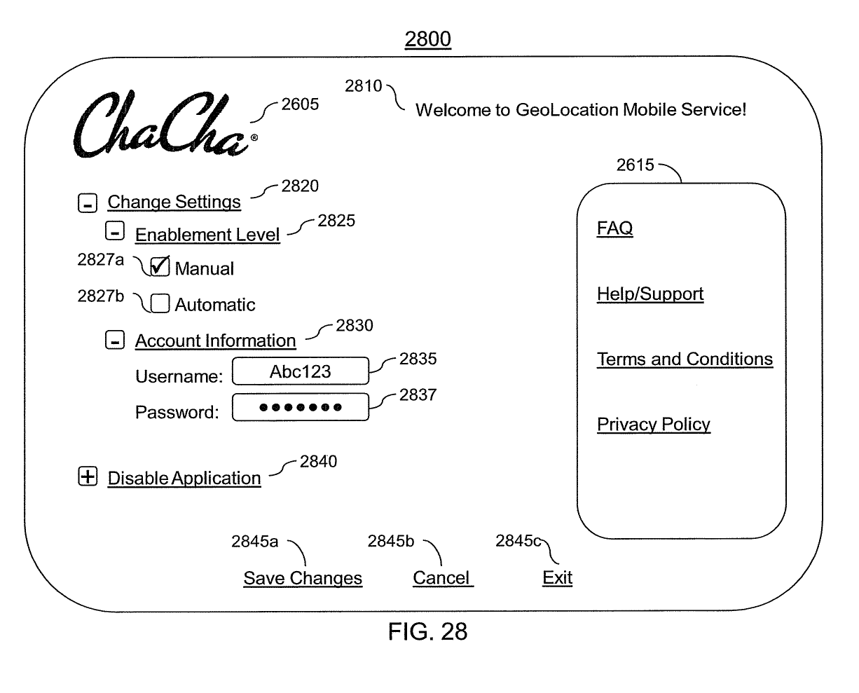

In operation 2435, preferences of a user and/or user device associated with a service are set. In operation 2435, a user may register or sign-in to a service and be presented with user preference options. For example, a user that may have a preexisting account associated with a service may log into the service with the service account identifier, such as a username and/or password. If the registration or log-in is successful, a user may be presented with the ability to indicate and/or change user preferences associated with the user's account with the service. For example, a user may be presented with preferences such as those illustrated in FIG. 28. User preferences may include the ability to change a username and/or password, select an enablement mode of the service to determine what information and/or when information may be transmitted from the user device to the service and from the service to the user device, what events may trigger or result in information being sent to and/or from a service, etc. Control is passed to operation 2440 and process 2400 continues.

In operation 2440, a determination is made as to whether an information triggering event is detected. If an information triggering event is not detected, control remains at operation 2440 and process 2400 continues. If an information triggering event is detected, control is passed to operation 2445 and process 2400 continues. The determination in operation 2440 may be based on various factors. For example, a service may be designed to detect any SMS or other text or multimedia messaging event originating from a user device and may contact the service in response to such an event. Alternatively, a phone call outgoing and/or incoming to and/or from a user device may serve as a triggering event. For example, a phone call to a specific telephone number may be a triggering event associated with a service. As an alternative to a message and/or phone call placed to and/or from a user device, a triggering event may include a physical location change of a user device that may be detected by cell tower triangulation, GPS, or otherwise, which if detected, may be relayed to an associated service. Any event involving a user device and any events associated with a user's use of the device may be detected and relayed to the associated service as is programmed by the service and any application resident on the user device.

In operation 2445, a determination is made as to whether permission and/or any active acknowledgement is required or requested for a service to send and/or receive auxiliary information from a user device. If permission or consent or active acknowledgement is required or requested, control is passed to operation 2450 and process 2400 continues. If permission or active acknowledgement is not required or requested, control is passed to operation 2455 and process 2400 continues. The determination of operation 2445 may be based on various factors. For example, if a user selected preferences, or other preferences are associated with a user or a user device indicating a manual or other singular event-based sending and/or receiving of information by a service is desired, the service software resident on the user device may request a user to provide permission to the service to obtain and/or provide information after a information triggering event associated with the service, the user and/or the user device.

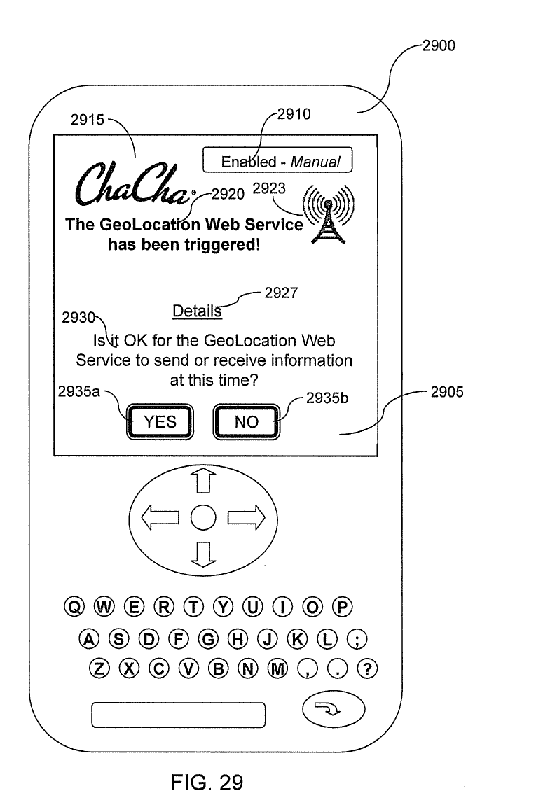

In operation 2450, permission is obtained. Any acknowledgement of the sending and/or receiving of information by a service is received. A permission event may include a message or other indication provided to a user employing a user device requesting a message to be sent to the service indicating permission to obtain information. For example, a GUI or other interface may be provided and displayed on a SMS capable or Web-enabled mobile phone such as the display 2905 illustrated in FIG. 29. Control is passed to operation 2455 (FIG. 24) and process 2400 continues.

In operation 2455, auxiliary information is sent and/or received by a user device via a service system. Information may include a geographic location of a user device, user preferences as indicated by activities performed utilizing the user device, etc. Control is passed to operation 2440 and process 2400 continues.

FIG. 25 illustrates an exemplary user device 2500. A user device may be any system capable of initiating, receiving and/or maintaining communication with a service. For example, a device with SMS capabilities, a smart phone with a wireless Internet capabilities, any device with GPS receiver, etc., may be used. If an application must be downloaded to a user device for utilization of a service, a user device may be any device that is capable of accepting installation of software code. The user device 2500 contains a display screen 2505, screen tabs 2510, a service identifier 2515, an invitation message 2520, a service participation instruction 2525, an application download hyperlink 2530, and memory expansion 2535.

The display screen 2505 is capable of displaying a browser window, a text message, a multimedia message or a user interface provided as part of the user system software architecture. A browser window of any browser such as FireFox®, Chrome®, or Opera® may function on any number of available operating systems, networks, and/or wireless communication carriers and/or systems. The display screen 2505 of the user device 2500 may contain additional user controls such as tabs, controls or other indicators such as the screen tabs 510. For example, selection of the ‘Email’ tab 2510a may maximize a display screen containing a user's email program, application, etc., and selection of the ‘Apps’ tab 2510b may maximize a display screen showing applications that are resident on the user device 2500. The tabs 2510 are exemplary user controls that may be available on a user device, any number of additional controls or indicators may be available based on the type of user device being used. User controls may be a keypad, track-ball, touch screen, etc.

The service identifier 2515 indicates the identity of the service that is inviting the user to participate using the invitation message 2520. The invitation message 2520 indicates that the ‘GeoLocation Web Service’ has invited the user of user device 2500 to participate in the service. The invitation message 2520 may be paired with any number of additional messages, instructions and other information. For example, an instruction indicating that a user must download an application to initiate participation in the service may be included. The service participation instruction 2525 indicates that the service requires an application download and indicates a Web link which may be selected to cause the user device 2500 to navigate to a Web page that may contain a downloadable file and/or other instructions or directions. The application download hyperlink 2530 indicates the URL where an application downloadable file may be obtained. If a user has a wireless connection, the user may ‘click’ on or otherwise select the hyperlink to be directed to a secure Web page such as the Web-based GUI 2600 illustrated in FIG. 26. The memory expansion 2535 (FIG. 25) may be any internal or external memory storage device associated with a user device. As illustrated in FIG. 25, the memory expansion 2535 is shown as an external memory storage card, such as a removable flash memory card, for example, microSD, miniSD, etc. The memory expansion 2535 may be utilized for storage of any application, software code, program or other data associated with facilitation of implementing, managing, and/or maintaining a service on a user device, such as the user device 2500.

As illustrated in FIG. 26, a GUI 2600 may be displayed to a user upon selection of an Internet hyperlink or other indication by a user to participate in a service. For example, the GUI 2600 may be displayed on a user device upon selection of a hyperlink that directs the user device to a secure website. The GUI 2600 contains a service identifier 2605, a greeting message 2610, a service information window 2615, a progress bar 2620, a user device specification window 2625, a download information window 2630, an install application control 2635 and a download control 2640.

The service identifier 2605 may contain the name, logo and/or other information associated with the provider of the service. The greeting message 2610 may indicate the name of the service. For example, the greeting message 2610 indicates that the service is the ‘GeoLocation Web Service’. The service information window 2615 may contain information associated with the service. Information indicated in the service information window 2615 may be accessed by selecting any number of available hyperlinks and/or drop-down menus, etc. As illustrated in FIG. 26, information on the service may include a Frequently Asked Questions (FAQ) section, a Help/Support section, a ‘Terms and Conditions’ section, a Privacy Policy section, etc. The service information window 2615 may be presented to a user as a window of the GUI 2600, or alternatively as a pop-up window, etc. The service information window 2615 may be presented as a pop-up window upon the selection of user controls, such as the user controls 2635, 2640. For example, to ensure that a user has read and agreed to any terms and conditions associated with a service, downloadable software license terms, a privacy policy associated with the service, etc., any information indicated in the service information window 2615 may require affirmative indication by a user before proceeding to an application download, installation, activation, etc.

The progress bar 2620 may indicate the progress in determining specifications of a user device. Alternatively, specifications and capabilities of a user device may be known to or detected by a service upon a first communication with a user device prior to any affirmation and/or active or passive denial of service participation is received. The progress bar 2620 may be pictorial, or alternatively may indicate progress of device detection by displaying a percentage, etc. If device specifications can be detected by the service, specifications may be displayed in the user device specification window 2625. The user device specification window 2625 may indicate a type of user device, the operating system running on a user device, the network provider and/or wireless carrier associated with a user device, etc. The specifications displayed are exemplary detections; any number of specifications or characteristics associated with a user device may be displayed. The user device specifications may determine the downloadable file that may be provided to a user device from for example the application server 2215 (FIG. 22). It may be necessary for an application to be compatible with certain operating systems. For example, if a user device running Windows Mobile 6.1 OS, is detected, an executable file for download that is compatible with the Windows Mobile platform is obtained and provided to the user device.

The download information window 2630 may contain information associated with the downloadable file. For example, information on the download size may be presented to a user in order for a user to decide if the user device has available memory for the download. In addition, information such as the estimated time of the download may be indicated. The indication of download time may be determined by the detection of the connection speed of the user device.

The install application control 2635 may be a button or other control that a user may click or otherwise select to initiate or activate installation of an application on the user device. The install application control 2635 may download the application file and automatically install the service on the user device. Alternatively, the download control 2640 may allow a user to download the application file to a user system which may be a computer system or other host system that can store the file until a user device can be connected to the host system via any available connection that provides for a syncing function and/or other transfer of the application file from the host system to the user device implementing the service.

FIG. 27 illustrates a GUI 2700 that may be presented on a user device if installation of an application which implements a service association with a user device is complete. The GUI 2700 may contain an installation message 2720, a log-in message 2725, a username text box 2727, a password text box 2729, a registration link 2730, an enablement message 2735, a manual enablement control 2740, an automatic enablement control 2745, and user controls 2750.

The installation message 2720 may indicate success or otherwise of the application installation. The log-in message 2725 may invite a user to log-in to the service to allow a service to associate a user account or login ID with the user device. The log-in message 2725 may indicate that a user must be registered with the service or a service that controls the service before proceeding with participation in the service. If a user is already registered with the service, a user may indicate account log-in information in the username text box 2727 and the password text box 2729. If a user is not registered with a service, and registration is required before implementation of the service on the user device, a link, control or other information such as the registration link 2730 may be presented in the GUI 2700. The registration link 2730 may be selected by a user to initiate registration with the service by, for example, browsing to a secure Web page or Web form or other location where a user may register or sign-up for an account associated with the service. For example, a registration web page might be provided by the system server 2230 and/or the service systems 2250, 2255 (FIG. 22).

The enablement message 2735 may be presented to a user. In at least one embodiment, an initial service enablement user preference must be selected. For example, in the GeoLocation Web Service, the enablement preferences presented to a user may include ‘Manual’ and ‘Automatic’. The exemplary GeoLocation Web Service provides for the tracking of a user's mobile device through various methods. For example, a location may be transmitted by GPS, cellular tower tracking, etc. In addition to a method of tracking, the GeoLocation Web Service provides for various situations that may trigger the location tracking to occur, and such situations or instances that trigger location information to be transmitted to the Web Service may be controlled by the enablement preference a user selects in the GUI 2700. For example, if a user sends an SMS message to a particular short-code, the location of the user device may be immediately detected and transmitted to the GeoLocation Web Service. Alternatively, if a user makes a phone call to a particular phone number, the location may be tracked. In addition, periodic location tracking may be transmitted to the service by a GPS receiver resident on a user device. Location information obtained in this manner may be transmitted if movement of the user device crosses a certain threshold distance, for example, if a device is moved two miles away from a previously transmitted location, a new location may be determined and such information may be sent and updated to the GeoLocation Web Service. Location triggering by time may also be available. For example, a service may update location information of a user device by a default time, such as for example, every fifteen minutes.

The information that may be transmitted to a service, and the triggering event that initiate such transmission, is not limited by the exemplary GeoLocation Web Service. Transmitted information may also include user preferences obtained directly from a user device or anticipated by a service. For example, activities performed by a user device may be tracked such as Web browsing, application downloads, messaging, etc., and the service on a user device may provide information to a service. A service may then use the information obtained to provide additional services related to user preferences or associated with a user's device, or activities.

In at least one embodiment, the user preferences of the enablement mode include the ‘Manual’ and the ‘Automatic’ preferences. In the GeoLocation Web Service exemplary service, the automatic enablement mode allows location information to be sent automatically to the Web Service at any time as determined by the code resident on the user device. The user of the user device implementing the service is not notified if location information is transmitted. Alternatively, in the manual enablement mode of the GeoLocation Web Service, a user is notified by a message, pop-up window, or otherwise, that a triggering event has occurred that will cause information to be sent to the service. In at least one embodiment, the notification in the manual enablement mode allows a user to confirm or disallow the transmission of information to the Web service as illustrated in FIG. 29. As illustrated in FIG. 27, the manual enablement control 2740 allows a user to indicate preference to subscribe to the Web service under the manual mode aforementioned, whereas the automatic enablement control 2745 allows a user to indicated preference to the automatic mode. The enablement modes, preferences, controls, etc., provided in the GUI 2700 are exemplary, any number of controls, preferences, modes, etc., may be presented to a user as determined by the type of service to which a user is subscribing.

The user controls 2750 may include the ‘Cancel’ control 2750a and the ‘Exit’ control 2750b. If selected, the ‘Cancel’ 2750a may cancel the log-in of a user to the service and/or clear any selections indicated in the GUI 2700, and the ‘Exit’ control 2750b may allow a user to close the GUI 2700.

FIG. 28 illustrates a GUI 2800 that may be presented to a user at anytime upon selection of a menu control or otherwise of settings or preferences associated with a service. As illustrated in FIG. 28, the GUI 2800 includes a greeting message 2810, a settings change control 2820, an enablement control 2825, enablement selection controls 2827, account settings control 2830, username text box 2835, password text box 2837, disablement control 2840, and user controls 2845.

The GUI 2800 may be presented as a drop-down menu of settings associated with a service. The greeting message 2810 indicates the identity of the service. The change settings control 2820 may be a top level control that, if selected, allows a user to display the settings associated with a service that may be modified. For example, the GeoLocation Service allows a user to change the enablement level 2825 through selection of either the ‘Manual’ enablement selection control 2827a or the ‘Automatic’ enablement selection control 2827b, and/or change the information associated with the user's account through the account settings control 2830. The account settings control which may be an expandable menu and/or drop down menu that may include controls and/or input fields associated with a user account such as the username text box 2835 and the password text box 2837. The disable application control 2840 may allow a user to disable the service and/or uninstall the resident process on the user device. In at least one embodiment, selection of the disablement control 2840 prompts a user to uninstall the service process in order to disable the associated service. The ‘Save Changes’ user control 2845a, allows a user to save any user preferences changed in the GUI 2800 The ‘Cancel’ user control 2845b, allows a user to clear any selections made in the GUI 2800. The ‘Exit’ user control 2845c, allows a user to close the GUI 2800.

FIG. 29 illustrates an exemplary message that may be presented to a user on a user device if an event on a user device has triggered transmission of information to a service. For example, if a subscriber of the exemplary GeoLocation Web Service has indicated the preference of the manual enablement mode, a message may be sent to a user before any transmission of information is initiated. The exemplary user device 2900 of FIG. 29 includes a user advice GUI 2905, an enablement preference indicator 2910, a service identifier 2915, a trigger message 2920, a transmission icon 2923, an additional information link 2927, a confirmation message 2930, and user confirmation controls 2935.

The user advice GUI 2905 may be presented to a user if information is to be transmitted to a service by the user device. A service which will receive the transmitted information may be identified by the service identifier 2915. The current transmission option selected may be indicated by the preference indicator 2910. The trigger message 2920 may indicate the event that triggered the transmission initiation, the service that desires the information to be received, etc. The transmission icon 2923 may indicate the method of transmission, for example the ‘radio’ icon on the user device 2900 indicates that a wireless communication through a Wi-Fi network may be used to transmit any information to the service. Networks such as GSM, Wi-Max, etc. may be indicated by the transmission icon 2923. The additional information link 2927 may be presented as a hyperlink or otherwise and may provide additional information regarding the parameters of the information that has been requested to be transmitted to the service when activated. For example, the type of information, the details of a triggering event, etc. may be provided. The confirmation message 2930 may prompt a user to indicate allowance or disallowance of transmission of information via selection of the confirmation controls 2935. The ‘Yes’ confirmation control 2935a indicates an allowance of transmission of information to the service and the ‘No’ confirmation control 2935b would cancel any attempt at transmission of information to the service.

Using the methods and systems described herein, a subscriber to a wireless network service may provide information to providers of services. The user may control the type of information and which services may receive information regarding the user. Information from a user device is obtained by a resident server process or ‘service’ which is operative on a user device. The service may access information available through the software environment of the user device, and may transmit the available information to a service designated by the user. A provider of services is able to obtain added information from the user without needing to obtain the information from a wireless carrier.

A service provider may make an installation application available to a user which is compatible with the operating system and other features of the user device. A user may download the installer, and activate the background process. A user may designate when and how information is transmitted to various service providers. A message may be sent using any communication services accessible to the user device. For example, SMS, EMS, MMS, WiFi, GSM, etc. may be used to deliver messages. Information from a user device may be sent automatically and/or with explicit user consent. A user is able to select which information is provided to which services. A service provider may access user information which might otherwise not be available, and/or cost-effective.

Using the methods and system described herein, a guide may be utilized to review and rate an advertisement submitted to a search system utilizing the assistance of human searchers or guides. A guide may provide varying levels of personal information as requested by the search system. A guide may be associated with a category and/or keyword. An advertiser may associate an advertisement with a category which is related to the category and/or keywords associated with a guide. An advertiser may select a profile which may indicate a target audience for an advertisement, or other media, which may be used to select a guide to review the media.

If an advertiser submits an advertisement to a search system, the search system may determine an expected cost associated with a human assisted review of the advertisement, which may cause a human-assisted review to be performed. A review may be performed by a number of guides selected by a search system. A result of a review by a guide may be used to modify a rating and/or ranking of an advertisement. Information of a guide-assisted review may be provided to an advertiser, and/or may be used by a search system or publishing system to improve targeting and optimize revenue and profits for the search system. An advertiser may be allowed to test an advertising campaign prior to large expenditure of time and cost. A sample of guides may be used to provide evaluation of the efficacy of advertising. Guides may provide opinions in a voting style, in a blind evaluation, and/or other forms of opinion gathering.

By utilizing the known reference group of guides which is predictably available and well characterized in terms of relevant targeting information, the need to deliver tens or hundreds of thousands of CPA or CPM advertisements to an unknown audience is eliminated. A representative group of people who may express an opinion is provided ‘on demand’ to advertisers. The opportunity to perform additional task-based activities by a guide affords greater earning opportunities which may be based on interests of the guide. By improving targeting, an advertiser may identify appropriate content of a message without resorting to expensive focus groups or long-term analysis of actions by an undifferentiated user base. Further the ability to target specific profiles such as location, age, income, education may allow a broader advertising taxonomy to target more effectively than keywords alone.

Using selected groups of guides to evaluate advertisements may allow a publisher of advertisements to optimize usage of inventory. For example, a publisher may determine a target user profile which is most likely to respond to a CPA type advertisement, which may increase a number of responses per impression of the CPA advertisement. Similarly if an inventory of CPM advertisements is available, a CPA advertisement which is less likely to produce a response from a user with a given profile may not be presented. While guide opinion data may be shared with advertisers, it may also be shared with others who are creating content which is to be published. For example, a content creator might present a user profile associated with the content, and a publisher or aggregator of advertisement inventory might provide advertisements which have been shown to be effective for the profile. Sharing of profile information might improve targeting and traffic, and might allow an aggregator to increase revenues and/or share of revenue obtained.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a computer-readable storage medium such as a CD-ROM, etc., or using one or more specialized terminals, devices or systems that is enabled to execute operation(s) described herein. The storage or recording medium used in an embodiment can be selected from among various persistent computer-readable media including, a disk, a DVD, an internal storage device (memory such as RAM or ROM) in a computer, etc.

As mentioned above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and, thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of selecting an advertisement, comprising:
receiving an opinion regarding an advertisement from a human searcher; and
delivering the advertisement to a user when determining that information of the user meets a target indicator of the opinion.

2. The method of claim 1, wherein the user is selected based on a determination of characteristics of the user using the human searcher.

3. The method of claim 1, comprising:
receiving information of the advertisement;
selecting the human searcher based on a characteristic relative to the information of the advertisement;
providing the advertisement to the human searcher for the opinion; and
determining whether to provide the advertisement to the user who is associated with the characteristic based on the opinion of the human searcher.

4. The method of claim 3, wherein the characteristic is demographic information,
said selecting of the human searcher includes determining a number of human searchers available to provide the opinion, and
calculating a cost associated with the opinion.

5. The method of claim 3, comprising:
receiving a keyword associated with the advertisement;
associating the human searcher with a category; and
establishing the characteristic from an association of the keyword and the category.

6. The method of claim 3, comprising:
assigning a node of a first index to the advertisement;
assigning a node of a second index to the human searcher;
associating a query of the user with the human searcher; and
providing the advertisement to the user based on a mapping of the first index to the second index.

7. The method of claim 3, comprising:
receiving a bid associated with the advertisement;
ranking the advertisement based on the bid; and
determining whether to obtain the opinion based on the ranking.

8. The method of claim 3, wherein the advertisement is partitioned into a plurality of elements, and
an operation is executed including:
synthesizing a plurality of sequences of the elements; and
delivering a sequence of the elements to the human searcher.

9. The method of claim 3, comprising:
receiving a query;
associating the query with a first index which is used to select the human searcher;
associating the query with a second index which is used to select the advertisement;
selecting by the searcher the advertisement from among a plurality of advertisements automatically provided to the searcher; and
recording the opinion of the searcher based on the selecting.

10. The method of claim 3, comprising:
assigning a keyword to the advertisement; and
selecting the characteristic disjoined from the keyword.

11. The method of claim 3, comprising;
receiving the opinion of the human searcher in a blind test.

12. A system, comprising:
a search system receiving information of an advertisement, selecting a searcher, and providing the advertisement to a user;
a searcher device sending and receiving information from the searcher; and
an advertiser device sending and receiving information of the advertisement.

13. The system of claim 12, comprising:
a user device submitting a request and receiving a search result; and
a database including recorded information of the searcher device and the advertiser device.

14. A persistent computer readable medium storing therein a program for causing a computer to execute an operation including selection of an advertisement, comprising:
choosing a guide;
selecting an advertisement;
receiving an evaluation of the advertisement by the guide; and
calculating an expected value of the advertisement including the evaluation.

15. The computer readable medium of claim 14, comprising:
ranking the advertisement based on the expected value.

16. The computer readable medium of claim 14, comprising:
determining whether the guide is available based on a monetary value associated with the advertisement.

17. The computer readable medium of claim 13, comprising:
associating a profile with the advertisement; and
choosing the guide based on the profile.

18. The computer readable medium of claim 17, comprising:
associating geographic information with the profile;
associating an affiliation with the profile;
associating a keyword with the advertisement; and
choosing the guide based on the affiliation.

19. The computer readable medium of claim 14, comprising:
providing the advertisement to the guide in a training exercise.

20. The computer readable medium of claim 14, comprising:
ranking the advertisement based on the expected value;
determining whether the guide is available based on a monetary value associated with the advertisement;
associating a profile with the advertisement;
choosing the guide based on the profile;
associating geographic information with the profile;
associating an affiliation with the profile;
associating a keyword with the advertisement;
choosing the guide based on the affiliation;
receiving a query from a user;
associating a category associated with the guide with the query;
determining that the keyword is associated with the category; and
delivering the advertisement to the user responsive to the query based on the category and the ranking.

21. A persistent computer readable medium storing therein a program for causing a computer to execute an operation including determination of profile information for targeting, comprising:
receiving a characteristic of a reference user;
associating the characteristic with a plurality of human guides;
analyzing query information associated with plurality of human guides;
predicting the characteristic of the reference user from query information of the reference user based on said analyzing; and
adjusting the analysis based on the prediction.
